(19) United States
(12) Patent Application Publication
(10) Pub. No.: US 2015/0294431 A1
(43) Pub. Date: Oct. 15, 2015

(54) APPARATUS AND METHODS FOR PROVIDING CITY SERVICES

(71) Applicants: Jean-Louis Fiorucci, Nice (FR); Richard E. Rowe, Las Vegas, NV (US)

(72) Inventors: Jean-Louis Fiorucci, Nice (FR); Richard E. Rowe, Las Vegas, NV (US)

(21) Appl. No.: 14/437,811

(22) PCT Filed: Oct. 22, 2013
(86) PCT No.: PCT/US2013/066245

§ 371 Date: Apr. 22, 2015

Related U.S. Application Data
(60) Provisional application No. 61/717,017, filed on Oct. 22, 2012.

(51) Int. Cl. G06Q 50/26; G06Q 30/02; G07B 15/02

(52) U.S. Cl. CPC G06Q 50/26; G07B 15/02; G06Q 30/0241

(57) ABSTRACT

Methods and apparatus for improving resource utilization in an urban environment are described. In a particular embodiment, an outdoor sensor network is provided. The outdoor sensor network can include sensors for monitoring parking spots, traffic, ground moisture, waste receptacle levels, lighting levels, sound levels and pollution. The outdoor sensor network can be linked to a plurality of outdoor kiosks. Each kiosk can be configured to receive sensor data from a portion of the sensors in the outdoor sensor network and communicate the information to a city message bus. The city message bus can be configured using a data distribution service, such as openDDS. The kiosks can be configured to provide many different services which utilize information gathered from the sensors.

### CROSS-REFERENCE TO RELATED APPLICATIONS

This application is a U.S. national application under 35 U.S.C. 371 of PCT Application Number PCT/US13/66245, entitled “APPARATUS AND METHODS FOR PROVIDING CITY SERVICES”, filed 22 Oct. 2013 by Fiorucci et al., which claims priority under 35 U.S.C. §119(e) to U.S. Provisional Patent Application Ser. No. 61/717,017, filed Oct. 22, 2012, titled “APPARATUS AND METHODS FOR PROVIDING CITY SERVICES,” by Fiorucci and Rowe, which is incorporated by reference in its entirety and for all purposes.

### FIELD OF THE INVENTION

This invention generally relates to managing and improving city living conditions, and more particularly to managing and allocating resources using a sensor network to reduce congestion, reduce pollution, more efficiently utilize the resources and promote business activities within the city.

### BACKGROUND

The percentage of people living in urban environments is increasing. The increase in the number of people in cities increases demands on shared and limited city resources. The increased resource demands can cause problems, such as traffic and pollution, which result in a decrease in a quality of living standards of the city residents. In view of the above, new apparatus and methods are needed which to help more efficiently utilize resources in urban environments.

### SUMMARY

Methods and apparatus for improving resource utilization in an urban environment are described. In a particular embodiment, an outdoor sensor network is provided. The outdoor sensor network can include sensors for monitoring parking spots, traffic, ground moisture, waste receptacle levels, lighting levels, sound levels, electric car charging, bicycle sharing and pollution. The outdoor sensor network can include a plurality of outdoor kiosks. Each kiosk can be configured to receive sensor data from a portion of the sensors in the outdoor sensor network and communicate the information to a city message bus.

The city message bus can be configured using a data distribution service (DDS) architecture, such as openDDS. The DDS architecture enables topics, such as sensor data, to be published to many different subscribers. The applications which subscribe to a topic, can receive instances of the topics in real-time. The applications can use the topic information to provide various services which can be made available to users of the system. For example, a first application can be used to provide a parking service which helps users find and purchase parking within the city. As another example, a second application can be used to provide information, such as identifying malfunctioning sensors, which can be used to maintain the outdoor sensor network.

The kiosks can include a human machine interface, such as a touch screen display, a microphone, a speaker, a coin-acceptor/dispenser, a card reader, a camera and a NFC reader. The kiosks can be configured to provide many different services. For example, the kiosks can be used to purchase parking, purchase event tickets, purchase car charging, purchase car sharing, purchase bicycle sharing, dispense promotions, provide general information about a city and report emergencies.

In one embodiment, a system configured to generate city services is provided. The system can be generally characterized as including a plurality of sensor nodes, a plurality of kiosks and management platform. The plurality of sensor nodes can each include one or more sensors and a first communication interface used to output sensor data from the one or more sensors. A portion of the plurality sensor nodes can be parking sensor nodes configured to generate the sensor data used to detect a presence of a vehicle at a parking spot.

The plurality of outdoor kiosks can each kiosk include a weather-proofed housing, display, one or more payment devices, a second communication interface configured to receive the sensor data from a portion of the plurality of sensor nodes, a third communication interface configured to communicate with a management platform and a CPU board, disposed within the weather-proofed housing. The CPU board can be coupled to the display, the one or more payment devices, the second communication interface and the third communication interface. The CPU board can be configured to control operation of the kiosk including publishing the sensor data from each sensor node in the portion of plurality of sensor nodes as a topic on a data distributed service (DDS) message bus generated by the management platform and generate a plurality of services including a parking service which enables a user to purchase parking.

The management platform can be configured to a) generate the city DDS message bus, b) discover new topics available for subscription on the city DDS message bus including the topics associated with the sensor data from each of the plurality of sensor nodes, c) generate a dictionary of topics available for subscription including updating the dictionary with the new topics which are discovered; d) receive subscriptions to each of the topics in the dictionary of topics; and e) route topic instances associated with each topic in the dictionary of topics to subscribers of the each topic. In particular embodiment, a unique topic is generated for each of the plurality of sensor nodes.

In additional embodiments, the management platform can be configured to instantiate a new topic each time a new sensor node is installed wherein the new topic is used to publish the sensor data from the new sensor node. Further, the management platform can be configured to receive an indication that a first sensor node from among the plurality of sensor nodes is uninstalled and in response, remove the topic associated with the first sensor node from the dictionary of topics. In addition, the management platform is further configured to generate a user interface which allows a user to select a particular topic from among the dictionary of topics and to subscribe or to unsubscribe to the particular topic.

The geographic data can be associated with topic instances from a particular topic. Further, the management platform is configured to filter topic instances according to whether the topics instances occurred in a particular geographic area using the geographic data. In addition, the management platform can be configured to receive a request to subscribe to a particular topic including a specification of the particular geographic area, instantiate a new subscription and only route topic instances occurring within the particular geographic area to a subscriber associated with the new subscription.

In one embodiment, the management platform can configured to manage a plurality of information distribution channels selected from the group consisting of VoiceXML, e-mail, instant messaging, text messaging, RSS and GeoRSS. Further, the management platform can be configured to receive a selection of one or more of the plurality of information distribution channels associated with a particular topic, receive topic instances associated with the particular topic, format data contained in the received topics instances in accordance with the selected one or more plurality of information distribution channels and deliver the formatted topic instances to a particular subscriber which selected the one or more of the plurality of information distribution channels. Also, the management platform can be configured to format topic instances of each of the topics in the dictionary topics in accordance with format requirements associated with each of the plurality of information distribution channels.

In one embodiment, the system can include a sensor data interpretation module. The sensor data interpretation module can be configured to receive a first topic instance including raw sensor data from a first topic associated with a first sensor node, based upon the raw sensor data, determine an event has occurred and publish the event as a second topic instance associated with the first topic to the city DDS message bus. Also, the sensor data interpretation module can be configured to determine calibration settings of the first sensor node.

In yet other embodiments, a first kiosk is configured to receive the sensor data from a charge station sensor node associated with an electric charge station used by electric vehicles. The first kiosk can be configured to use to the sensor data associated with the charge station sensor node to generate an electric charge service which allows a user to purchase charge time at the electric charge station. In addition, a first kiosk can be configured to receive the sensor data from a bike sharing sensor node associated with a bike sharing station. The first kiosk can be configured to use the sensor data associated with the bike sharing sensor node to generate a bike sharing service which allows a user to obtain access to a bike from the bike sharing station.

In further embodiments, the first kiosk can be configured to receive the sensor data from a moisture sensor node wherein the moisture sensor node is configured to measure moisture levels used to determine a watering schedule associated with a green area. Also, the first kiosk can be configured to receive the sensor data from a waste level sensor coupled to a waste receptacle where the waste level sensor is used manage emptying of the waste receptacle. In addition, a first kiosk can be configured to receive the sensor data from a lighting sensor node coupled to a street light where the lighting sensor node is used to determine maintenance needs and lighting levels for the street light. Further, the first kiosk can be configured to receive the sensor data from a traffic sensor node where the traffic sensor node is used to alert users of traffic conditions.

### BRIEF DESCRIPTION OF THE DRAWINGS

The included drawings are for illustrative purposes and serve only to provide examples of possible structures and process steps for the disclosed inventive systems and methods for managing a sensor network. These drawings in no way limit any changes in form and detail that may be made to the invention by one skilled in the art without departing from the spirit and scope of the invention.

FIG. 1 is a perspective drawing of a sensor network deployed in a city environment in accordance with the described embodiments.

FIG. 2 is a block diagram of a system including a sensor network in accordance with the described embodiments.

FIG. 3 is a block diagram of a system architecture for managing and leveraging data from a sensor network in accordance with the described embodiments.

FIG. 4 is a block diagram of a system including multiple kiosks distributed in various locations in accordance with the described embodiments.

FIG. 5 is an illustration of a portion of a human machine interface of a kiosk in accordance with the described embodiments.

FIGS. 6A-6E illustrates a configuration for a marketing campaign service in accordance with the described embodiments.

FIG. 7 is a block diagram of kiosk architecture in accordance with the described embodiments.

FIG. 8 is a block diagram of interactions between a host application, a kiosk framework and a plug-in in accordance with the described embodiments.

FIGS. 9A and 9B show a mapping of kiosk functions to kiosk hardware in accordance with the described embodiments.

FIG. 10 shows a specification for a CPU board which can be used in a kiosk in accordance with the described embodiments.

FIG. 11 shows specifications for a video display and a touchscreen interface which can be used in a kiosk in accordance with the described embodiments.

FIG. 12 shows a specification for a printer which can be used in a kiosk in accordance with the described embodiments.

FIG. 13 shows specifications for a coin acceptor, escrow device and anti-pin system which can be used in a kiosk in accordance with the described embodiments.

FIG. 14 shows a specification for a universal control module used to provide an unattended payment solution which can be used in a kiosk in accordance with the described embodiments.

FIG. 15 shows a specification for an NFC vending pass which can be used in a kiosk in accordance with the described embodiments.

FIG. 16 shows specifications for a card reader and a keypad input device which can be used in a kiosk in accordance with the described embodiments.

FIG. 17 shows specifications for a speaker and keypad interface which can be used in a kiosk in accordance with the described embodiments.

FIG. 18 shows a few initial display screens associated with a mobile application executed and output to a mobile device in accordance with the described embodiments.

FIG. 19 shows example display screens indicating settings associated with a mobile application executed and output to a mobile device in accordance with the described embodiments.

FIG. 20 shows an example display screen for a parking module in a mobile application executed and output to a mobile device in accordance with the described embodiments.

FIG. 21 shows example display screens associated with trip configuration for a parking module in a mobile application executed and output to a mobile device in accordance with the described embodiments.

FIG. 22 shows example display screens associated with marker details for a parking module in a mobile application executed and output to a mobile device in accordance with the described embodiments.

FIG. 23 shows an example display screen associated with routing guidance for a parking module in a mobile application executed and output to a mobile device in accordance with the described embodiments.

FIG. 24 shows an example display screen associated with traffic alerts for a parking module including example notifications in accordance with the described embodiments.

FIG. 25 shows example display screens associated with pay by phone option for only the time the parking spot is occupied in accordance with the described embodiments.

FIG. 26 shows example display screens associated with pay by phone option for purchasing a pre-selected amount of parking in accordance with the described embodiments.

FIG. 27 shows an example display screen associated with a geo-localized promotional offer in accordance with the described embodiments.

FIG. 28 shows example display screens associated with a transportation module of a mobility application in accordance with the described embodiments.

FIG. 29 shows example display screens associated with traffic information within a mobility application in accordance with the described embodiments.

FIG. 30 shows example display screens associated with public transportation within a mobility application in accordance with the described embodiments.

FIG. 31 shows example display screens associated with selecting options for public transportation within a mobility application in accordance with the described embodiments.

FIG. 32 shows example display screens associated with selecting options for obtaining a taxi within a mobility application in accordance with the described embodiments.

FIG. 33 shows example display screens associated with selecting options for car and bicycle sharing within a mobility application in accordance with the described embodiments.

FIG. 34 shows example display screens associated with selecting options for renting cars or motor bikes within a mobility application in accordance with the described embodiments.

FIG. 35 shows example display screens associated with a city phone book within a mobility application in accordance with the described embodiments.

FIG. 36 shows example display screens associated with a city phone book module including categories within a mobility application in accordance with the described embodiments.

FIG. 37 shows an example display screen associated within a city news feed module within a mobility application in accordance with the described embodiments.

FIG. 38 shows attributes which can be associated with a monitored city object in accordance with the described embodiments.

FIG. 39 illustrates the relationship between parents and children of different elements of the address vocabulary in accordance with the described embodiments.

FIG. 40 shows some examples of addressing in an XML format in accordance with the described embodiments.

FIG. 41 is a block diagram for publication service architecture in accordance with the described embodiments.

FIG. 42 is a block diagram illustrating a flow of a publication service process in accordance with the described embodiments.

FIG. 43 shows a data information channel configuration including a specification for topics associated with the channel in accordance with the described embodiments.

FIG. 44 shows a RSS, GEORSS configuration in accordance with the described embodiments.

FIG. 45 shows an Email, SMS and instant messaging configuration in accordance with the described embodiments.

FIG. 46 shows a configuration associated with a user's subscription to different topics in accordance with the described embodiments.

FIG. 47 shows one example of an RSS file configuration in accordance with the described embodiments.

FIGS. 48-50 show a list and description of channel elements in accordance with the described embodiments.

FIG. 51 shows items which can be in a channel in accordance with the described embodiments.

FIG. 52 is an example where a new item is added to an XML file for an RSS feed in accordance with the described embodiments.

FIG. 53 shows an item of an XML file in a first protocol for marking a location on a map in a GeoRSS feed in accordance with the described embodiments.

FIG. 54 shows an item of an XML file in a second protocol for marking a location on a map in a GeoRSS feed in accordance with the described embodiments.

FIG. 55 shows two items in an XML file in GeoRSS-Simple which can be used for marking a location on a map in a GeoRSS feed in accordance with the described embodiments.

FIG. 56 shows an example of a Voice XML page in accordance with the described embodiments.

FIG. 57 shows a main screen of a universal event monitor in accordance with the described embodiments.

FIG. 58 shows a history tab screen of a universal event monitor in accordance with the described embodiments.

FIG. 59 shows setting screens for a universal event monitor in accordance with the described embodiments.

FIG. 60 shows a format for storing configuration setting in a universal event monitor in accordance with the described embodiments.

FIG. 61 shows relationships associated with DDS domains and relationships between topics, publishers, subscribers, data readers and data writers in accordance with the described embodiments.

FIG. 62 shows a screen 640 which can be used to register new tops in the system in accordance with the described embodiments.

### DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

### System Overview: Parking

In the following sections, an overview of a system configured to provide city services is discussed. The overview includes a description of system components in the context of system applications. In particular, five system applications, parking management, traffic management, green area management, street light management and waste area management, and associated system components are discussed. These system applications and system components are discussed for the purposes of illustration only and are not meant to be limiting.

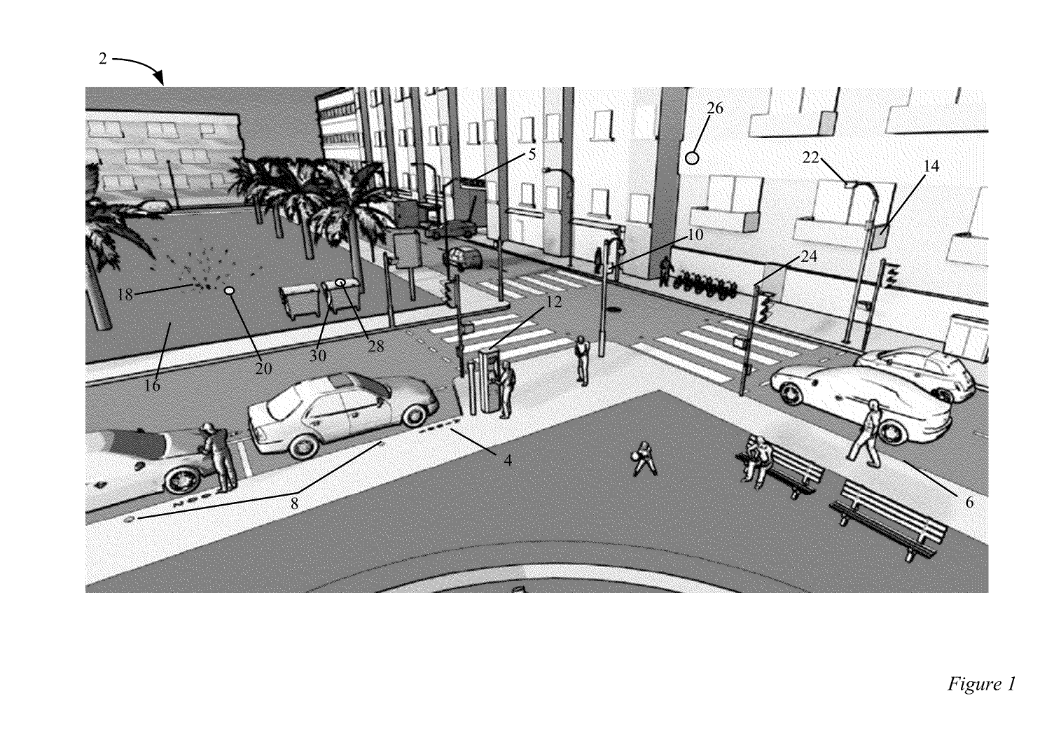

FIG. 1 is a perspective drawing of a sensor network 2 deployed in a city environment in accordance with the described embodiments. The system can be configured to control various types of existing regulated/unregulated parking surfaces and future parking surfaces (e.g., street parking 4 or a garage 5). The various types of parking surfaces can be but are not limited to a) resident where user lives in the parking zone and may benefit from a special rate, b) non-resident where a user does not live in the parking zone and may have to pay the normal rate in lieu of any other discounts, c) free regulated zone where the car park is free but limited to a duration, d) handicapped where the parking spot reserved for vehicles identified with handicapped individuals only, e) delivery where a zone of delivery is reserved for delivery trucks often for a limited duration, f) kiss & fly zone where a user can stop for few minutes to drop something or somebody off, g) electric charge station parking where a vehicle can park to receive power, h) car share parking where a shared vehicle which is available for rent can be parked, i) unregulated parking surface zones where parking is forbidden (e.g., street location 6) and j) temporary parking only available during certain hours of the day, such as no parking during commute hours.

To manage these various types of parking spot, the system may be able to take into account the maximum time of parking authorized. Further, the system can provide tools for implementing parking rules, such as time varying parking rates, time ranges where parking is regulated, temporary parking restrictions (e.g., construction permits), parking rates which go up with utilization, parking limitations during special events, such as festivals, parades and other instances where parking may be temporarily not allowed and period when parking is not regulated (e.g., Holidays where parking is free). It is important to notice that one parking spot can have one or many types of parking rules attached.

In the instance of parking rates which vary depending on utilization, parking rates can increase as the overall rate of parking utilization increases within some defined number of spaces such that two adjacent spaces within the defined spaces can have different rates depending on the time history of parking utilization. For example, a first parking spot can be occupied at a first time when utilization among some number of spaces is low and have a first parking rate, such as a 10% utilization rate. An adjacent spot can be subsequently occupied at a later time when parking utilization is high, such as a 95% utilization rate and a second parking rate greater than the first parking rate can be implemented. Further, if the first spot becomes available or the current occupant wishes to renew their parking spot while the utilization remains high, then the second parking rate which is higher can be implemented.

Parking rates can be tied to the utilization of other resources besides spaces. For example, congestion can be a measured resource where when the amount of congestion increases or decreases the parking rates can be varied, such as increase with the congestion level. As another example, pollution can be a measure resource (i.e., the city may only tolerate some level of pollution) where when the amount of pollution increases the parking rate can be varied, such as the pollution reaches some threshold limit, parking rates can increase. The resource utilization rates can be implemented in combination with one another, such a parking rate which depends on a level of congestion, an amount of space utilization and a pollution level.

Parking locations can be monitored using one or more sensors. For example, parking sensors can be configured to detect magnetic field disturbances and changes in lighting level. The sensor measurements can be used to determine whether a parking space is available. The determination can be done locally (i.e., on-the sensor), remotely (data can be transmitted to a remote device and interpreted) or combinations thereof.

In one embodiment, a parking sensor can be configured to measure the presence of vehicles at some time interval, such as each sixty seconds and/or transmit data every sixty seconds or when detecting changes in lighting level. The periodicity of the measurements and data transmission can be a rule that is modifiable via the central system. The rule can be modified to conserve power and to be consistent with utilization rates of the parking location. The lifetime of the sensor can depend on the rate of measurements that it is used to make. In some instances, a sensor can last up to eight years using an internal power source provided with the device. The approximate installation time can be about fifteen minutes. Dimensions can be an eighty five mm diameter×ninety mm height. The sensor can have a translucent cover and the resistance can be about IK 10.

In particular embodiments, the parking sensors can each be mounted on a curb in order to eliminate parking space downtime for installation, calibration and maintenance. Sensors mounted in the street can be problematic. When sensors are mounted directly in the street, the entire street is taken off line to configure, maintain and calibrate. With the sensors mounted in the curb, it eliminates downtime thus saving time and money.

Each parking sensor can be configured to detect both disturbances in the Earth's magnetic field “and” changes in lighting level. The combination enables the detection of space available or space taken. The sensors can be configured with automatic calibration capabilities (this can also be done at the system level. In automated calibration, sensors learn by detecting variances over a time period, such as 10-15 days, to provide better accuracy. System can be configured to allow a command to be sent to a sensor module to recalibrate. The number of days over which calibration occurs can be user selected. Thus, each sensor module can be individually calibrated with different calibration functions, which vary from parking location to parking location. The magnetic and lighting level sensors can be calibrated to detect the presence/non-presence of an object (i.e., a vehicle).

In one embodiment, the parking sensor uses sets of data collected during automated calibration to determine if a space is open. The sensor can automatically measure the presence of vehicles at a specified interval, such as each 10 seconds. The sensor can transmit data every 60 seconds or when detecting changes in lighting level or other specified sensor events.

In one embodiment, the parking sensors can be configured to communicate wirelessly to repeaters (e.g., 10) mounted on light poles or other places along street. The repeaters can be configured to send data wirelessly to concentrators. In one embodiment, the concentrator can be placed inside a kiosk (e.g., 12). The parking sensors near the kiosk, such as 8, can also directly communicate to the kiosk 12. The concentrator can be connected via IP network to an IT system. The IP network can use fiber, cellular, IP over power or combinations thereof to transmit data. In one embodiment, peer-to-peer communications between data common or different types of sensors can enable data communications to a remote device, such as central system server.

### System Overview: Traffic Management

The traffic management in the city can be vital to improving the living conditions of the people. Volume of traffic, level of pollution, occupation rate of parking places, weather condition may be some of the parameters taken into account to set up an intelligent management of the traffic in the city. For that purpose, it may desirable to be able to deploy sensors in the important crossroads and main streets of the city to measure the volume of traffic and combine them with the other measures (pollution, temperature, humidity). Rules can be developed that take into account of the following data, alone or in combination one another: a) level of volume of traffic, b) level of pollution, c) weather conditions and d) occupation rate of parking places.

Sensors which can be used with this application include traffic detection, weather monitoring, temperature and pollution. A sensor package 14 which can be used to monitor air quality, traffic conditions and weather is shown attached to a light post. Other quantities can be measured via a specific sensor and these examples are provided for the purposes of illustration only. For example, in one embodiment, road surface conditions can be monitored to detect areas requiring maintenance, such as pot-holes.

The data which is gathered can be used for multiple purposes. For example, air quality data and weather conditions can be used to manage traffic. However, air quality data and weather conditions can also be made available for other purposes. For example, an individual with asthma may be interested in air quality data in determining whether to go out or not.

In one embodiment, the system can be configured to receive real-time information about traffic affecting conditions, such as road work or construction projects. Further, the system can be configured to receive user input of observed traffic conditions, such as congestion or accidents. The received information can be synthesized and made available to public workers, such as emergency employees. In addition, the information can be made available to the public. The information made available can include maps with traffic conditions including congestion and construction work. Also, the system can be configured to output recommendations to avoid certain areas and to suggest routes for avoiding the areas.

The information can be time limited. For example, if the road work is completed for the day, a user at the work site may be able to enter this information and then the system can make this information available to users. Similarly, if a construction project has run-over because of unexpected delays (e.g., night work running into the morning), then a user at the site can enter this information and it can be made available to users, such as people whose morning commutes are affected.

In one embodiment, the information which is delivered can be location limited. For example, a user may specify that they are only interested in information which affects their morning commute. The user can enter their morning commute into a map interface and then the system can be configured to determine a geographic area around the commute and then only output alerts within the determined geographic area which affect the commute. In another example, the user can enter their residence and the system can determine a geographic region around their residence where alerts within the geographic region are to output to the user. The alerts can be provided on one-time basis, such as for a particular trip but the alerts can stop after the trip is completed, or on a recurring basis, such as traffic around a recurring commute or residence of the users.

This approach (i.e., specifying a trip with a start and an endpoint or a location and a surrounding area, can be used for any type of sensor data which the system gathers. For example, a user can specify a walking or jogging route and then the system can specify current pollution conditions gathered from pollution sensors around the route. As another example, a user may specify they are going to a recreational park and the system can specify an alert that construction is on-going at the park or portions will be watered at the time at which they arrive. As described below in the next section, watering schedules can be varied to optimize water usage. Thus, an alert associated with a current watering schedule can be of interest to a user.

A traffic sensor can be designed to collect information on the passage of vehicles. In one embodiment, it can be configured to measure the amount of vehicles passing, the type of vehicle (e.g., car, truck or motor bike) and each vehicle's speed. In a particular embodiment, it can detect the passing of vehicles by sensing the magnetic field perturbations. It may work by event (e.g., at night it may only transmit when a vehicle passes or some number of vehicles pass) or by periodic transmissions (e.g., every minute, five minutes, half hour or hour depending on the traffic which is detected).

In one embodiment, the traffic sensor can be mounted within a road or the side of a road. The sensor may not require an external power source. The lifetime of the sensor can depend on the rate that of measurements that are made. It can be up to eight years. Approximate installation time can be about fifteen minutes. Example dimensions can be eighty five mm diameter×ninety mm height. Resistance can be IK 10. In one embodiment, it can include sensors for measuring pollution levels.

### System Overview: Green Area Management

Management of the green areas (e.g., 16) may allow for better water management. For that purpose, it may be necessary to define for each of the monitored areas, the minimum level of soil moisture from which a request of irrigation is required. The irrigation can be provided by a water system including devices, such as sprinkler 18. These water systems can be distributed throughout a city.

With the composition of the green spaces evolving from a season to the other, it may be important to be able to define periods with different levels of soil moisture. The soil moisture can be measured by sensors coupled to the system, such as sensor 20. In these conditions, it may be necessary to be able to define rules including but not limited to a period of validity of this rule, a level of soil moisture and current or expected weather conditions. In one embodiment, these rules can be used to control a water delivery system which can deliver a specified amount of water to a green area.

### System Overview: Street Light Management

The management of the street lighting can have two objectives: a) bulb maintenance and b) optimization of electricity consumption. In one embodiment, the system can be configured to monitor a bulb status and send a maintenance message when a defective bulb is detected. A sensor can be used to monitor the bulb status. Electric consumption optimization can involve monitoring ambient lighting conditions, such as local light intensity and the light intensity generated by each of the street light bulbs. The system may be able to manage the lighting intensity (and by this way reducing the electric consumption) according to the ambient lighting intensity and the activity in the zone (using sound sensor).

In one embodiment, activity proximate to a lighting device can be used to determine a lighting intensity. For example, lighting intensity can be increased when many people are present and decreased when none or few people are detected.

Sensors, such as a camera, light detectors and/or sound detection devices, can be used to determine whether adjust lighting intensity for one or a group lighting devices. In one embodiment, a sensor or sensors (e.g., 22) can be mounted to a light pole. The sensors can be mounted to other locations as well, such as traffic signal 24 or wall 26.

To manage the lighting, thresholds allowing for optimal management of the lighting can be defined. The defined thresholds can be stored and used to control lighting intensity for individual lights. In particular embodiments, lighting intensity decisions can be performed in situ or remotely, such as in a kiosk or a remote server.

In various embodiments, a range of ambient lighting conditions which allow the required intensity of street lighting equipment to be defined can be specified. Further, one or more noise levels (e.g., noise levels can vary with time) which allow the balancing the level of lighting can be specified. In particular, when the level of activity in the street or other lighted area is low (e.g., pedestrian or vehicle traffic), a decision within the system can be made to reduce the lighting levels and not maintain a strong lighting (high consumption of electricity). In general, activity levels can be monitored via one or more sensors to determine whether to adjust lighting levels.

Ambient light from other sources, such as a full moon or building lights can affect whether to increase or decrease lighting levels. For example, during a full moon and when it is not cloudy, the lighting levels of the lamps may be reduced. As another example, lighting levels can be increased earlier in the day on cloudy/rainy day versus later in the day (closer to dusk) on a clear day. In yet another embodiment, based upon local crime statistics, more lighting can be provided to high crime areas if desired.

### System Overview: Waste Management

Because of the constant increase of population, the management of the waste is a major cost for cities. The dumpsters and other types of trash receptacles (e.g., 28) including sensors (e.g., 30) may allow for a better management of the waste and its collection. The trash receptacles can be configured to accept a particular type of waste, such as recyclables or general trash. To be able to optimize the collection of waste, thresholds of dumpster filling, which are measured by sensors, such as 30, can be specified.

Using the thresholds and the measured fill levels of dumpsters, optimal routes for trucks used to collect waste can be specified. The routes can vary as a function of time depending on the fill levels of various trash receptacles. For example, most trash collection occurs on a regular schedule. Using the fill levels, if a trash receptacle doesn't need to be emptied it may skipped. Further, the fill levels can be matched to the volume of the dispatched trucks. Thus, if the volume of trash is great over a number of receptacles, the number of trucks can be increased or the number receptacles to which a truck is dispatched can be reduced.

The system can work with an application that can be output to a display device available on a collection device, such as truck. In one embodiment, the application can be made available on a portable electronic device, such as a smart phone. The smart phone can be carried by waste management employees, such as employees responsible for removing waste, management employees who check routes and maintenance workers responsible for maintaining the sensor system.

In one embodiment, the system can display a route, waste bins and their locations to be emptied and a status of each targeted waste bin, such as whether the waste bin on the route has been emptied or not. Also, the system can plot a progress along a designated route and indicate location of trash receptacles which need emptying.

In one embodiment, each waste bin can include a bar-code or RFID tag. As each waste bin is emptied, the waste bin can be identified and marked as having been emptied. In other embodiments, the waste bin can include sensors that allow it to be determined if a particular waste bin has been emptied. For example, a tilt/accelerometer sensor can be included that allows the system to determine that the waste bin has been picked up and turned over.

The system can be configured to output an alert if it appears, based upon the position of the waste collection truck that a receptacle has been missed. Further, the system can be configured to output a remedial action, such as directing the collector to go back and empty the receptacle or output an indication to continue on the route and then schedule a priority pick-up for the next day. Whether the system indicates a trash receptacle is to be emptied or not, after it has been missed, can depend on the fill level of the receptacle, local traffic conditions, an amount of progress made along the route as compared to some target or threshold time and a prediction of how long going back to empty the skipped waste receptacle will take. For example, if it typically takes thirty minutes to reach a particular location on a route and the location has been reached in twenty five minutes, traffic is not bad and the waste receptacle is full, then the system can predict how long it will take to return to the missed receptacle and decide to indicate for the collector to go back and empty the missed receptacle. As another example, if the location was reached at forty minutes, which is ten minutes behind schedule, the traffic conditions are congested such that doubling back is predicted to take a long time and possibly worsen traffic conditions and the waste receptacle is only three quarters full, then the system can be configured to note the pick-up was missed and adjust a future pick-up to ensure the receptacle is emptied.

The application can include input that allows a waste receptacle to be designated for replacement or maintenance. Further, progress along a route, such as a time each receptacle was emptied and times to empty a receptacle can be determined. Also, the time to complete the route as well as a time to reach various points along the route can be determined.

In one embodiment, traffic conditions can be taken into account in route planning. For example, if a particular area is congested, a garbage collection for particular receptacles or a street cleaning can be moved to an alternate time. The alternate time may involve performing the action at a different time in the route, such as at the end of route as opposed to the beginning or moving the action to another day.

One or more waste receptacles can be assigned to a route and/or an area. For each dumpster it may be possible to define one or more of the 1) the type of waste managed, 2) level of filling required to send a collection message and the level of filling required to generate a collection request. This information can be used in route planning for the waste receptacles within an area.

A described above, a sensor device can be configured to monitor the status of waste receptacles, such as the fill level of containers. In one embodiment, the sensor device can monitor the fill level of dumpsters using ultrasound measurements. The measurements can be used to determine the distance between the sensor and waste in the container. The measurements might also be used to detect movement in the dumpster resulting from vermin, such as rats. This information can be used to schedule pest management operations within a particular area.

In one embodiment, measurements and data transmission can be made every one hour or some other configurable time period. The approximate installation time of adding a sensor to a waste receptacle can be seven minutes. Example dimensions of a sensor can be forty five mm diameter×ninety mm in height. The sensor can be mounted near the top of the device so that it can detect a fill level beneath it.

### System Overview: Sensor Network

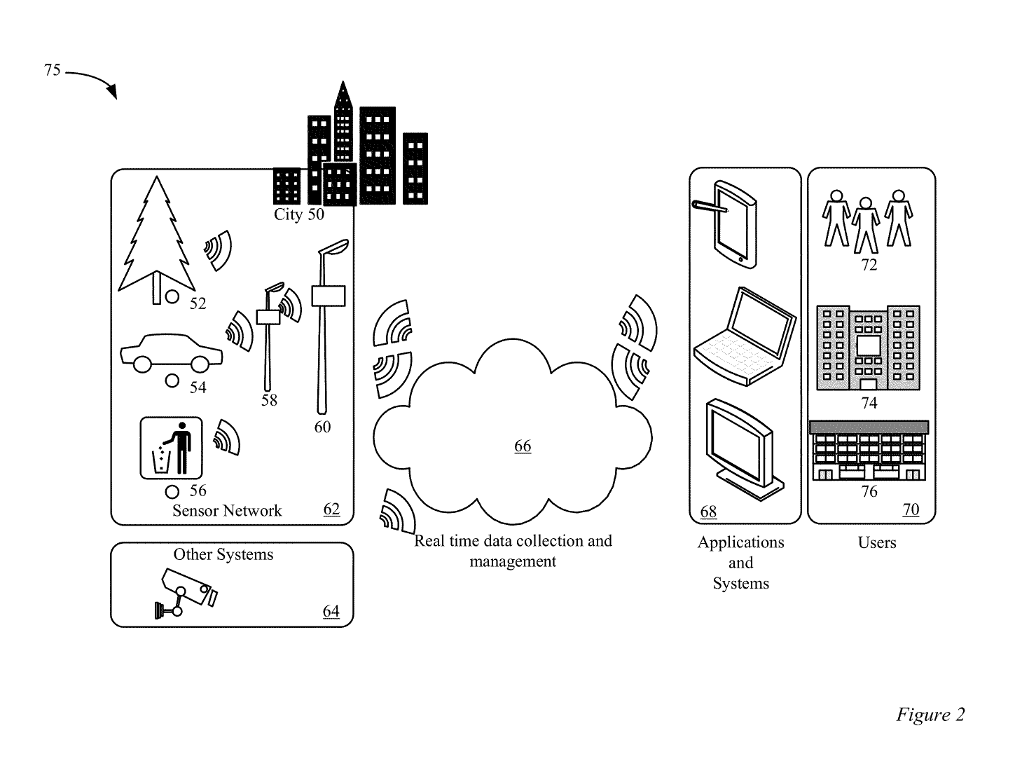

A number of sensor types are described in the previous section describing applications of the system. FIG. 2 is a block diagram of a system 75 including a sensor network 62 in accordance with the described embodiments. In this section, for the purposes of illustration, a sensor network 62 and sensor devices (e.g., moisture sensor 52, traffic/parking sensors 54 or waste receptacle sensors 56 as well as other sensor devices described herein) which can be utilized in the sensor network are described. The sensors can be distributed around a suburban and/or urban area, such as a city 50. In one embodiment, the sensor network and sensor devices can be provided by Urbiotica (Barcelona, Spain).

The wireless sensor network 62 can capture real-time information associated with different parameters of the city. The data from the sensors can be transmitted wirelessly, wired or combination thereof to the communication elements, such as 58 and 60 which are shown mounted to light poles 58 and 60. As described above, communication elements 58 and 60 can receive and concentrate data received from multiple sensor devices. In one embodiment, the communication elements can be provided using technology developed by Urbiotica®.

The data which is collected can be sent to a data management platform, such as 66. In one embodiment, the data can be sent over some network segments via a wireless protocol, such as but not limited to W-Fi, WiMax, Cellular, or GPRS (General Packet Radio Service). On the management platform 66, the real time data can be converted to useful information and which then stored and/or delivered to computer systems and external applications 68 at the right time.

In one embodiment, the management platform 66 can receive data from other sources 64, such as data from traffic cameras, security cameras and weather sensors. This data can be synthesized with the data received from network 62 and utilized in various applications. The applications which are provided can be configured to execute and/or output data, such as visual data and audio data, to smartphones, tablets, netbook, desktops and municipal displays (e.g., outdoor displays or kiosks). The applications can be utilized by users 70, such as citizens 72, municipal workers 74 and workers associated with private enterprises 76.

The communication device 58 can be responsible for collecting information from sensors and distributing the information to the different communication devices, such as gateway 60. In one embodiment, device 60 can be a data concentrator which receives sensors data gathered from multiple different instantiations of device 58. One of the basic functions of device 58 can be to act as a router or a repeater.

Multiple instantiations of device 58 can be coupled as a mesh network where devices are added without a central hierarchy. Therefore, a network in the shape of net can be formed. This architecture allows for point failures. If one of the instantiations of device 58 fails, then data can be rerouted through another one of device 58 in the network.

In one embodiment, a mesh network infrastructure using the ZIGBEE protocol can be used. This network can also serve as a communication network for the kiosk. This “mesh” network deployed in the city cam provides the communication between sensors' networks, kiosk, others devices deployed in the street and the information system. In this context, the kiosk becomes a node of the “mesh” network. The network can be configured to pass on the data from the sensor network and the data from information system towards the kiosk, such as topics to which the kiosk subscribes. Further, it can be used to transfer the data issued by the kiosk towards the information system, such as events published by the kiosk.

When the “mesh” network uses a ZigBee protocol, it may be necessary to embed in the kiosk a TCP/IP—ZigBee bridge. It may be desirable to install the bridge in the kiosk as high as possible to optimize the quality of the communications between the ZigBee bridge on the kiosk and the “mesh” network. The antenna may be integrated on an electronic board. Since the antenna is integrated on the electronic board, it may be important to take into account in the plan of setting-up and securing of the board in the kiosk such that the direction of the antenna can be adjusted.

Device 58 can be designed for easy installation and integration with the different elements of street furniture, such as lamp posts or building walls. In one embodiment, the device 58 may be connected to an external power source. However, it may also be able to utilize solar power, alone or in combination with the external power source. Some example functions of device 58 can include but are not limited to: i) acting as a router, ii) receiving data from the sensors (e.g., 52, 54, 56) and forwarding it to the device 60, iii) can be powered via electricity sources associated with public lighting, iv) twenty four hours power may not be required, v) can provide up to 4 days battery in case of power failure, vi) ten years lifetime and vii) dimensions of fifty two mm×one hundred thirty seven mm×two hundred seven mm. In one embodiment, environmental sensors, such as temperature, moisture and/or pollution sensors can be integrated into device 58.

Device 60 can be a hub which sends the information collected within the network 62 to the management platform 66. The data can be sent via a wired communication protocol or a wireless communication protocol, such as such as but not limited to W-Fi, WiMax, Cellular, or GPRS. The device 60 can be installed on lampposts, walls or other street furniture. Some models can require an outside electric source while other can be solar powered. Some example specs are that it receives data from the sensors directly in network 62 and/or concentrated sensor data from device 58, continually operations including battery backup in case of power failure and ten years lifetime. The dimensions can be about seventy mm×one hundred fifty eight mm×two hundred fifty seven mm. In one embodiment, environmental sensors, such as temperature, moisture and/or pollution sensors can be integrated into the device 60.

### System Overview: Example Architectures

Some example architectures that can be used to implement the applications described above are discussed. In particular, two architectures are described and an example implementation for parking control is discussed. Additional details of the components shown in the figures are described with respect to the following sections.

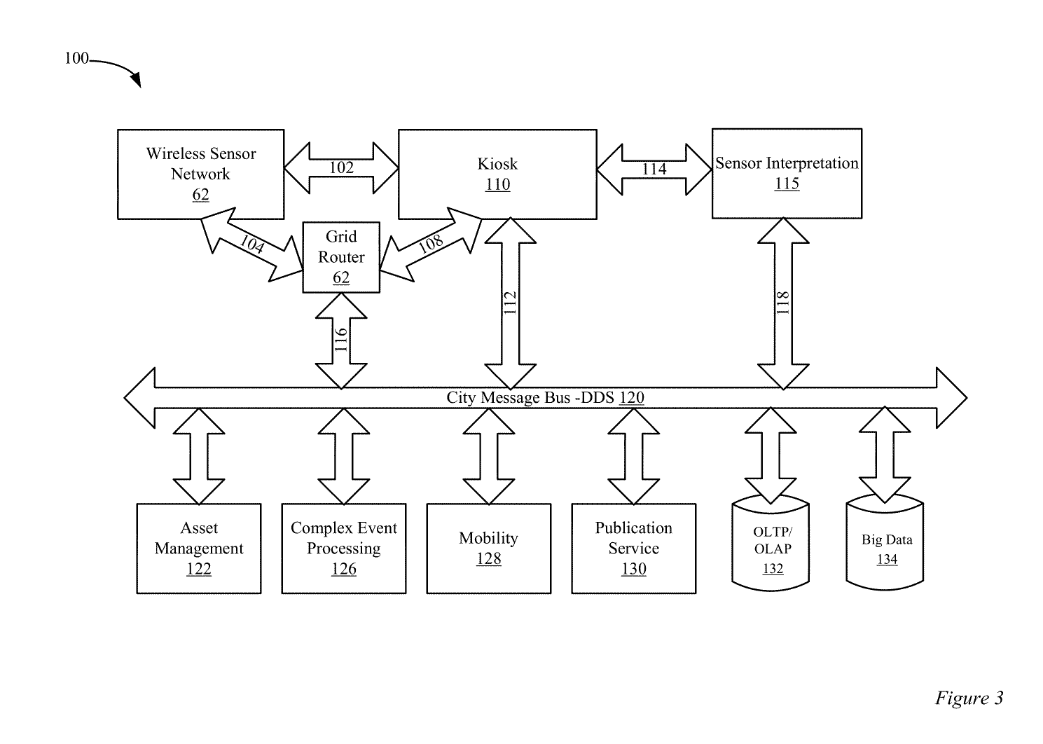

FIG. 3 is a block diagram of system architecture 100 for managing and leveraging data from a sensor network 62 in accordance with the described embodiments. The sensor network 62 can refer to individual sensors that are installed in an urban environment. The sensors can be configured to measure many different quantities that can be used in many different applications.

In one embodiment, the sensors in sensor network 62 are configured to communicate with a device which acts as a data concentrator (e.g., 58 or 60 in FIG. 2). The data concentrator can be configured to communicate via 102 with a multiservice kiosk 110 which forwards information via 112 to a city message bus 120. In one embodiment, connection 102 can include a wireless communication pathway. In alternate embodiments, connection 102 can include a combination of wireless and/or wired communication pathways. The multiservice kiosk 110 described in more detail below can be configured to provide customer services and to help service the sensor network 62. For example, the kiosk 110 can provide parking fee payments, weather forecasts, advertisements, alert information, city information and transportation services.

The city message bus 120 can allow communication of information between different message sources. In one embodiment, a data distribution services (DDS) OpenSplice can be used to distribute data. Other applications can be used as middleware for providing this service and OpenSplice is but one example.

DDS is networking middleware that simplifies complex network programming. It implements a publish/subscribe model for sending and receiving data, events, and commands among the nodes. Nodes that are producing information (publishers) create “topics” (e.g., temperature, location, pressure sensors) and publish “samples.” DDS takes care of delivering the sample to all subscribers that declare an interest in that topic.

DDS can handle all the transfer chores: message addressing, data marshaling and remarshaling (so subscribers can be on different platforms than the publisher), delivery, flow control, retries, etc. Any node can be a publisher, subscriber, or both simultaneously. The DDS publish-subscribe model can eliminate complex network programming for distributed applications.

DDS can support mechanisms that go beyond the basic publish-subscribe model. One benefit is that applications that use DDS for their communications can be entirely decoupled. Thus, very little design time has to be spent on how to handle their mutual interactions. In particular, the applications may not need information about the other participating applications, including their existence or locations.

DDS can be configured to automatically handle all aspects of message delivery, without requiring any intervention from the user applications, including but not limited to a) determining who should receive the messages, b) where recipients are located and c) what happens if messages cannot be delivered. DDS allows the user to specify Quality of Service (QoS) parameters as a way to configure automatic-discovery mechanisms and specify the behavior used when sending and receiving messages. The mechanisms are configured up-front and require no further effort on the user's part. By exchanging messages in a completely anonymous manner, DDS can greatly simplify distributed application design and encourages modular, well-structured programs.

DDS can be configured to also automatically handle hot-swapping redundant publishers if the primary fails. Thus, subscribers can always get the sample with the highest priority whose data is still valid (that is, whose publisher-specified validity period has not expired). It can be configured to automatically switch back to the primary when it recovers, too. OpenSplice DDS is a COTS and Open Source implementation of the full OMG DDS specification (Stirling, Stirlingshire, United Kingdom).

In another embodiment, a connected grid router 62 (e.g., Cisco, San Jose, Calif.) can be used to receive 104 and transmit information 108 or 116 from the sensor network 62. In one embodiment, the data from the sensor network can be received via an Internet communication protocol, such as 6LoWPAN which is an acronym of IPv6 over Low power Wireless Personal Area Network. The 6LoWPAN group has defined encapsulation and header compression mechanisms that allow IPv6 packets to be sent to and received from over IEEE 802.15.4 based networks. IPv4 and IPv6 are the work horses for data delivery for local-area networks, metropolitan area networks, and wide-area networks such as the Internet. Likewise, IEEE 802.15.4 devices provide sensing communication-ability in the wireless domain. The inherent natures of the two networks though, are different.

Data can be sent from the grid router 62 to the kiosk 110 via connection 108. In a particular embodiment, connection 108 can employ cellular communications using a cellular network protocol to send sensor data to the kiosk 110. The kiosk 110 can include a router (e.g., a Cisco 819 integrated services router). An integrated services router (ISR) can support machine-to-machine (M2M) applications that can enable enterprises to use 3G, 4G, Wi-Fi wireless WAN network services to go beyond traditional branch locations.

In one embodiment, the kiosk 110 can include a network switch. A switch can serve a controller enabling network devices to talk to each other efficiently. For example, a switch can be used to connect computers, printers and other devices within the kiosk 110. In one embodiment, the switch can be a Cisco Edge switch. The Edge switch is an all-in-one device delivers which consolidates computing, wired and wireless LAN, and full media connectivity. It can include an integrated wired LAN, wireless access point, HDMI and audio, USB, Bluetooth, and computing for all-in-one connectivity.

The grid router 62, integrated service router and switch technologies can implement many different QoS (quality of service features). In one embodiment, these features can supplement QoS features found with DDS used in the message bus 120. QoS can also refer to the ability of a network to provide improved service to selected network traffic over various underlying technologies including Frame Relay, ATM, Ethernet and 802.1 networks, SONET, and IP-routed networks. In particular, QoS features provide improved and more predictable network service by providing the one or more following services: a) supporting dedicated bandwidth, b) improving loss characteristics, c) avoiding and managing network congestion, d) shaping network traffic and e) setting traffic priorities across the network. QoS features can be configured throughout a network to provide for end-to-end QoS delivery. The following three components can be used to deliver QoS across a heterogeneous network: i) QoS within a single network element, which includes queuing, scheduling, and traffic shaping features, ii) QoS signaling techniques for coordinating QoS for end-to-end delivery between network elements and iii) QoS policing.

In particular embodiments, only a communication connection 102 between network 62 and kiosk 110 with no grid router 62. Thus, the QoS capabilities provided by the grid router technology may not be used. In another embodiment, the only grid router 62 and its associated communication connections 104, 108 and 116 may be used and the connection 102 may not be provided. In this embodiment, the QoS capabilities provided by the grid router 62 and its related technologies (e.g., the integrated service router and network switch) can be used with the DDS QoS capabilities. In yet another embodiment, a combination of the grid router 62 and its connections 104, 108 and 116 can be used in some portions of system 100 and a connection 102 between the wireless network 62 and kiosk 110 can be used for other portions of the system.

The asset management 122 can be used to manage the inventory of all public places and/or installed equipment (each item can be called a Monitored City Object (MCO)). Each MCO can be monitored by one or more sensors (e.g., parking, garbage, street lights and watering sensors). Asset management 122 can perform one or more of the following: 1) manage the inventory of all the public places and/or the installed equipment, 2) establish the link between the sensor and the MCO and 3) manage the system maintenance.

Complex vent processing 126 can involve processing various events which occur within the system, such as fraud detection, checking the health of the devices and yield management. Yield management is the process of understanding, anticipating and influencing consumer behavior in order to maximize yield or profits from a fixed, perishable resource. For example, in parking, yield management can involve maximizing parking revenues. Fraud detection may involve detecting individuals illegally obtaining parking services. Health of the devices may involve events involving a failure of a parking related sensor.

In one embodiment, event processing can be performed using Esper. Esper is an event stream processing (ESP) and event correlation engine (CEP) written in Java. Basically instead of working as a database where you put stuff in to later poll it using SQL queries, Esper works as real time engine that triggers actions when event conditions occur among event streams. A tailored Event Processing Language (EPL) allows registering queries in the engine, using Java objects (POJO, JavaBean) to represent events. A listener class—which is basically also a POJO—will then be called by the engine when the EPL condition is matched as events come in. The EPL allows expressing complex matching conditions that include temporal windows, and join different event streams, as well as filter and sort them.

The Esper engine works a bit like a database turned upside-down. Instead of storing the data and running queries against stored data, the Esper engine allows applications to store queries and run the data through. Response from the Esper engine is real-time when conditions occur that match queries. The execution model is thus continuous rather than only when a query is submitted. For parking, Esper might look for events related to parking payments or an expiration of parking.

Mobility 128 can be used to support a number of integrated transportation applications within a city, such as parking, taxi, bus, car rental, bike rental, train, etc. Mobility 128 can process sensor data which is used in mobility application which allow users to park and move efficiently in a city. Further, it can help a user get information regarding city, activities. In one embodiment, an application including three modules can be supported: a) EzPark—a module for helping users find the best way to park their vehicles in the city, b) EzMove—a module helping users to move inside the city, c) EzCity—a module providing general information of the city.

Different applications can be coupled to the city message bus and can be configured to utilize sensor data published on the bus 120. Thus, the example of the mobility application is provided for the purposes of example only and is not meant to be limiting. The different applications residing on the message bus can use unique sensor data, which can be published on the bus 120, or can share sensor data. For example, a traffic management application and a waste management application can each subscribe to traffic sensor data and use it for different purposes. However, the waste management application may also subscribe to fill level sensor data which the traffic management application doesn't use.

Publication services 130 can publish data derived from the sensor network 62. One function of this service is to publish information concerning urban space activity in a standard format. The information can be made available for the attention of the users or agents working directly/indirectly for the city. It aims at supplying pre-formatted information to application editors and companies needing information without requiring a specific software interface.

OLTP/OLAP 132 is associated with on-line transaction processing and on-line analytical processing. OLTP systems provide source data to data warehouses, whereas OLAP systems help to analyze it. OLTP is characterized by a large number of short on-line transactions. The emphasis for OLTP systems can be on very fast query processing, maintain data integrity in multi-access environments and an effectiveness measured by a number of transactions per second. In an OLTP database there can be detailed and current data, such as operational data.

OLAP can be characterized by relatively low volume of transactions. Queries are often complex and involve aggregations. For OLAP systems, a response time is an effectiveness measure. OLAP applications are widely used by data mining techniques. In an OLAP database, there can be aggregated, historical data, stored in multi-dimensional schemas. OLAP data can come from multiple OLTP databases.

Some transactions involving parking which can be associated with an OLTP system are expired parking and parking payments. In general, the OLTP system can involve operational decisions derived from the sensor network 62, such as scheduling for a waste management trip. An OLAP system might involve synthesizing and analyzing historical traffic data, waste receptacle fill levels and routing data to improve system operations.

Big data 134 can be the term for a collection of data sets so large and complex that it becomes difficult to process using on-hand database management tools or traditional data processing applications. The challenges can include capture, storage, search, sharing, transfer, analysis, and visualization. The trend to larger data sets is due to the additional information derivable from analysis of a single large set of related data, as compared to separate smaller sets with the same total amount of data, allowing correlations to be found for applications, such as to spot business trends and determine real-time roadway traffic conditions. Big data 134 may involve the analyzing the large amount of sensor data which is generated by the sensor network 62.

Sensor interpretation application 115 can receive sensor data from the kiosk 110 and process it to provide some interpretation of the sensor data. The interpretation can be published on the message bus and used by other applications. For example, sensor interpretation application 115 can receive a magnetic field measurement from a parking sensor installed in a curb and then determine whether a space near the sensor is occupied or not. This information can be published on the bus 120 and received by the mobility application 120.

In another embodiment, the sensor applications 115 can receive data from a waste level sensor. The application 115 can interpret the signal, such as determining the receptacle is ¾ full or full and then publish this information on the message bus 120. Another application, such as waste management application, can receive the fill level information. In response, the waste management application may be perform some action with the information which can then be published to the city message bus 120. For example, the waste management application can generate a service required message which indicates the waste receptacle is in need of service which is published to the city bus 120 via connection 118.

In yet another embodiment, the sensor interpretation application 115 can also perform calibration functions. For example, the sensor interpretation application 115 can receive other data, such as data from a light sensor which indicates whether a parking space is empty or not. If this data conflicts with the interpretation from the magnetic sensor data (e.g., the magnetic sensor data indicates the spot is empty while the light sensor data indicates the spot is occupied), then the application 115 can be configured to adjust threshold values for interpreting the magnetic sensor data, such that the sensor data is interpreted correctly.

In another example, a user or a maintenance worker can input information which affects a sensor interpretation. For example, a user application may allow a user, such as parking customer, a maintenance worker or a parking enforcement official, to input an indication that a spot is empty when the system indicates it is not empty or a spot is not empty when the system indicates it is empty. Based upon this information, the interpretation application 115 may attempt to adjust its interpretation algorithm, such that its interpretation is in agreement with the data observed in the field. If the interpretation application 115 continues to make faulty interpretation then it may publish a message on the message bus indicating the sensor is faulty. Another application, such as a maintenance application can receive this information and then schedule maintenance for the sensor.

In one embodiment, the kiosk 110 can be configured to directly send the raw sensor data to the sensor interpretation application 115 which can be residing on a remote computational device, such as a server, via communication connection 114. In another embodiment, the sensor data can be published to the city message bus 120 via connection 112 from the kiosk 110 without the use of connection 114 (or there may not even be a connection 114). Then, other applications, such as, the sensor interpretation application 115 can receive raw or pre-processed sensor data from the message bus 120 (The complex event processing 126 may process the raw sensor data before it is sent to application 115 via 120 and 118.).

In yet other embodiments, sensor interpretation related functions can be performed on the kiosk 110. The kiosk 110 can include hardware and/or software for processing and interpreting raw sensor data. For example, the kiosk 110 can be configured to receive raw sensor data from a parking sensor, such as magnetic field measurements, and determine whether a vehicle is present. Then, the kiosk 110 can be configured to publish this information on city message bus 120.

In some instances, the raw sensor data used to make an interpretation can be published for use by other applications and archival storage. In other instances, only the interpretation may be sent out. For example, the kiosk 110 can publish the information that a parking space is occupied or not occupied to the message bus 120 but may not publish the raw sensor data to the message bus 120 unless specifically requested by another application.

In various embodiments, sensor data can be interpreted locally within a sensor node, within a kiosk, within some other remote device or combinations thereof where the distribution of processing functions can vary from sensor node to sensor node. For example, a first kiosk, such as kiosk 110, can process raw sensor data from a first type of parking sensor whereas application 115 can process raw sensor data from a second type of parking sensor. In another example, raw data from all parking sensors can be processed remotely, such as via application 115, after it is published to the city message bus 120 whereas raw sensor data from fill level sensors can be processed before it is published on the city message bus, such within kiosk 110.

In general, raw sensor data can be processed before it is published on the city message bus or after it is published on the city message bus. In the case, where it is processed before publication to the city message bus, the interpretation of the raw sensor data can be published to the city message bus. However, all or a portion of the raw sensor node data may not be published to the city message bus 120 with the interpretation. For example, only the indication of whether a parking spot is empty or not can be published to the bus 120 but not the raw sensor data unless an error condition is detected in which case the raw sensor data can be also published to the bus.

In other embodiments, the interpretation of the raw sensor data and the raw sensor data can both be published to the bus 120. For example, the interpretation of the raw parking sensor data can be initiated at the kiosk 110 to determine whether a spot is empty or not before the raw sensor data reaches the bus 120 (i.e., when it is first received by the kiosk 110). Then, the interpretation of the raw sensor data can be published to the bus 120. Further, the raw sensor data 120 used to make the interpretation can also be published to the bus 120. The raw sensor data 120 can be published to allow other applications to use the data and potentially publish information associated with the data to the message bus 120.

### Multi-Service Kiosk

The implementation of new mobility options in cities (bicycle and car sharing services), new services, such as electric charge and the modernization of the car parking management is an opportunity to revisit the management of transportation services in the urban space. Traditionally, each of these transportation services has utilized a separate and unique service kiosk. This situation can have the following impacts: an additional cost of operation and installation for all these services because infrastructures are not mutualized, a lack of coherence in the implementation of services in the urban space, the perception by the users of an unstructured and sometimes inconsistent service offering, a visual pollution for the users and additional maintenance costs associated with upkeep of many different types of devices.

For at least these reasons, it may be desirable to provide multiservice kiosk. The multiservice kiosk may offer various services to their users, such as but not limited to i) payment of parking fees, ii) multimedia information access related to city events and attractions, iii) advertising including geo-located offers, iv) point of sale (subscription, card dispensing, etc.) for services, such as public transportation, car parking, cars sharing and bicycle sharing and v) emergency services. Further, kiosks can be used for supplying services to users and/or agents in charge of the management of the public road network (municipal agent or contractor working for companies). In addition, a multiservice kiosk can provide an entry interface into the city network along with other devices (e.g., candelabras, etc.). The information collected by the various sensor nodes installed in the city can be routed to various information systems, processed and returned to users as various services that are available at various entry interfaces to the city network, such as multi-service kiosks.

Whether it is in city center or in suburb, the need for services can vary from location to location. A multiservice kiosk as described herein can provide a similar technical platform for many different services where the services can be easily customized depending on the needs of a particular location. The kiosk can be modular and flexible in both its hardware and software architectures. The modular architectures enable upgrades or modifications as current services evolve and new services are added or the needs of particular kiosk location changes.

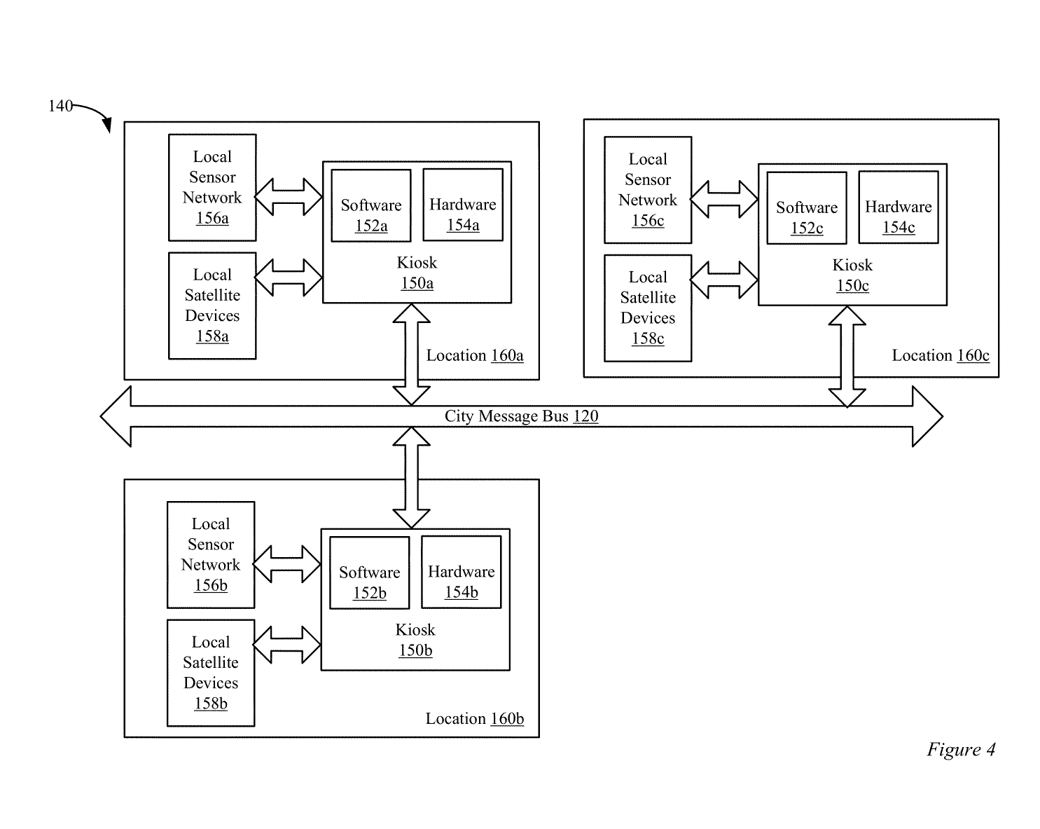

FIG. 4 is a block diagram of a system 140 including multiple kiosks, such as 150a, 150b and 150c, distributed in various locations, 160a, 160b and 160c, in accordance with the described embodiments. In one embodiment, the kiosks can be distributed across a region, such as different locations within a city. The kiosks can be located indoors or outdoors. The kiosks can each be configured to communicate with a city message bus 120. Further, peer-to-peer communications between kiosks, such as between 150a and 150b or 150c, may also be possible.

The kiosks can be configured to each receive data from a local portion of the sensor network. For example, kiosks, 150a, 150b and 150c, receive data from the local sensor networks, 156a, 156b and 156c, respectively. In one embodiment, the sensor data can be received from one or more hubs, which may also be a concentrator (e.g., see 60 in FIG. 3), from a repeater (e.g., see 58 in FIG. 3), from one or more sensors directly or combinations thereof.

The types and number of sensors in each local sensor network can vary. For example, kiosk 150a can be configured to receive sensor data from parking and traffic sensors while kiosk 150c can be configured to receive sensor data from a car charge station, a bike share station, street lights and waste receptacles. The number of sensors and the types of sensors from which a kiosk receives data can change over time. For example, at a first time, kiosk 150a may only receive data from parking sensors. Later a car share/car charge station can be installed near the kiosk 150a and then the kiosk 150a can be configured to receive sensor data from the car share/car charge station.

Each kiosk can be coupled to one or more satellite devices (e.g., 158a, 158b and 158c). Although, in some instances, a kiosk, such as 158a, 158b, 158c, may not be coupled to any satellite devices. The number and type of satellite devices to which a kiosk is coupled can vary from kiosk to kiosk and may change as a function of time for each kiosk. Some details of satellite devices which can be coupled to a kiosk are described below.

In particular embodiment, a multi-service kiosk, such as 150a, 150b and 150c, can be designed to meet one or more of the following constraints: a) for security, it can include devices for ensuring physical and logical protection, such as resistance to vandalism and fraud, b) for ergonomic and aesthetics, it can be integrated into the urban environment (kiosk customization) and facilitate users' and maintenance workers' operations, c) for damage resistance, it can be designed to protect against the intrusion of solid objects, intrusion of liquids and mechanical shocks, d) for accessibility, it can be designed for persons with reduced mobility (i.e., handicapped), e) for maintenance efficiency, it can designed to allow remote software and firmware updates, remote updates of the kiosk configuration (parking fee, tickets, promotions, information), backup of the configurations at the local level and at remote servers allowing for fast reconfiguration in case of replacement of the CPU are other hardware defects, on-site technical maintenance in case of pre-alarm or tilt events (e.g., hardware defect or need more paper), f) sustainable development g) for global applicability, it can be designed for compatibility in many different countries, h) remote administration and combinations thereof.

In particular embodiments, it can be designed to an IP34 rating, which protects against intrusion of solid objects greater than 2.5 mm and against the projections of water from all the directions. Further, it can be designed to an IK07 rating, which protects against mechanical shocks, such as against a shock equivalent of a mass of 1.5 kg dropped from a height of 40 cm, which corresponds to an energy of 6 joules. In addition, the human machine interface (HMI), such as display, input buttons, etc., may be situated between 70 cm and 1.30 m to better allow handicapped access.

A kiosk, such as 150a, 150b and 150c, can employ a modular hardware and software architecture. In this context, the kiosk can provide a common platform with the possibility of adding additional hardware devices and/or services (software applications). In one embodiment, the multiservice kiosk can produced as a “master” kiosk having one or more of the following characteristics, alone or in combinations with one another: a) single block “anti-vandal” case in extruded aluminum, shockproof to vehicles and covered with anti-graffiti paint, b) power supply 240V/120V allowing answering energy needs of the various electronic devices present in the kiosk (5V, 12V, 24V) where an electric supply by battery can be provided optionally to maintain a reduced service in the case of electricity cut, c) an HMI taking into account of specific constraints for the persons with reduced mobility and d) local and remote communication interfaces.

In one embodiment, the HMI can include a touchscreen LCD display with anti-vandal protection, a card and/or RFID reader, payment devices, ticket printer and optionally one or more of a video camera, microphone, speaker and motion sensor. The front panel of the kiosk can be designed to take into account the modularity and the evolution of the kiosk needs once installed. For instance, it can be configured to be removable so that different combinations of human interface devices can be installed and existing devices can be upgraded or easily repaired. Different combinations of payment devices are possible. For coins, the kiosk can be equipped with a coin acceptor, with or without coin redemption, including an escrow and a safe allowing for the collection amounts paid. For payment cards (e.g., credit/debit cards), the kiosk can include a magnetic stripe card or a smart card reader. Further, it can include a NFC (Near Field Communication) payment interface or similar wireless interfaces (e.g., Bluetooth) that enable mobile wallet applications. The local and remote communication interfaces can include an Ethernet/Zigbee bridge to ensure the communication between the kiosk, devices deployed in the street network (sensors, digital signage, etc.) and the information system deployed on remote server(s).

Further, some embodiments of the kiosk can include optional software and hardware devices to manage the charging of an electric car, car-sharing services and bicycle-sharing services. These devices can be integrated into the “master” kiosk or in satellite systems coupled to the master kiosk. A kiosk system installed at a particular location can include a master kiosk and a number of nearby installations (satellite systems) that include devices that are communicatively and/or mechanical coupled to the master kiosk. The master kiosk can control a number of slave devices located within the nearby satellite systems and provide remote communication capabilities for these devices. Some examples of satellite systems are described as follows.

An electric charge satellite device configuration can allow for the management of the electric charge only, or electric charge and/or a car-sharing service. In one embodiment, these kiosks (which comprise a number of satellite devices, such as 158a, 158b or 158c) can be slaves of the “master” kiosk, such as 150a, 150b or 150c. In one embodiment, all payment operations and activation of the service can be made at the master level. The satellite devices can manage one or two parking spots according to the configuration wished with a possibility of fast or slow charge.

The satellite device configuration can include one or more of a) single block “anti-vandal” case in extruded aluminum, shockproof to vehicles and covered with anti-graffiti paint, b) one or two charging sockets (in general, one or more can be provided), c) locked trapdoor(s) allowing the access to the charging socket(s) to be secured, d) a differential protection and contactor for engaging/releasing of the socket, e) communication module for communicating with the master kiosk, such as 150a, 150b or 150c, f) status interface, such as a headband of LEDs on its top representing the state of charges for cars parked at the parking spot(s) managed by the satellite device and g) combinations thereof. The status interface may be visible at a certain distance. In particular embodiments, the interface can specify the following information (other color schemes are possible and the schemes below are provided for the purposes of illustration only): i) green-charge available, ii) red-charge unavailable, iii) blue-charge (slow) in progress and iv) purple-charge (fast) in progress.

The charge status information can also be made available to the master kiosk (or some other device which connects to the message bus 120) and published via the city message bus 120. This information can be used by another application. For example, an application may use the information to find the next available charging station which will become available relative to a specified location and provide directions to this determined charging station.

Satellite devices for a bicycle sharing service can be configured to manage the provisioning of bikes. For each location, an electromagnetic tie system which allows a bike to be blocked or unblocked (secured) can be provided. In one embodiment, the bikes can hang from a bar and an interface can be provided on the bike that allows it to be secured to the bar. Sensors in the bar can report to the satellite devices and/or master kiosk to report whether a bike is secured or not secured. A status interface, such as an LED indicator for informing the users can be provided. For example, the status interface can be configured to display: a) green-bike available, b) red-bike unavailable and c) orange-bike present but out of order. This information can also be made available to the master kiosk or another communication device so that it can be published on the city message bus 120.

One or more digital signage satellite devices can be coupled to the master kiosk. For example, digital signage might be incorporated into a bus shelter at a bus stop. The signage can be driven by the “master” kiosk and can display advertisements, city information messages, etc. In one embodiment, the signage can include one or more display panels, such as a color LED display and a communication module which enables communications with the master kiosk. Next, some services which can be provided at a kiosk, such as 150a, 150b and 150c, are described.

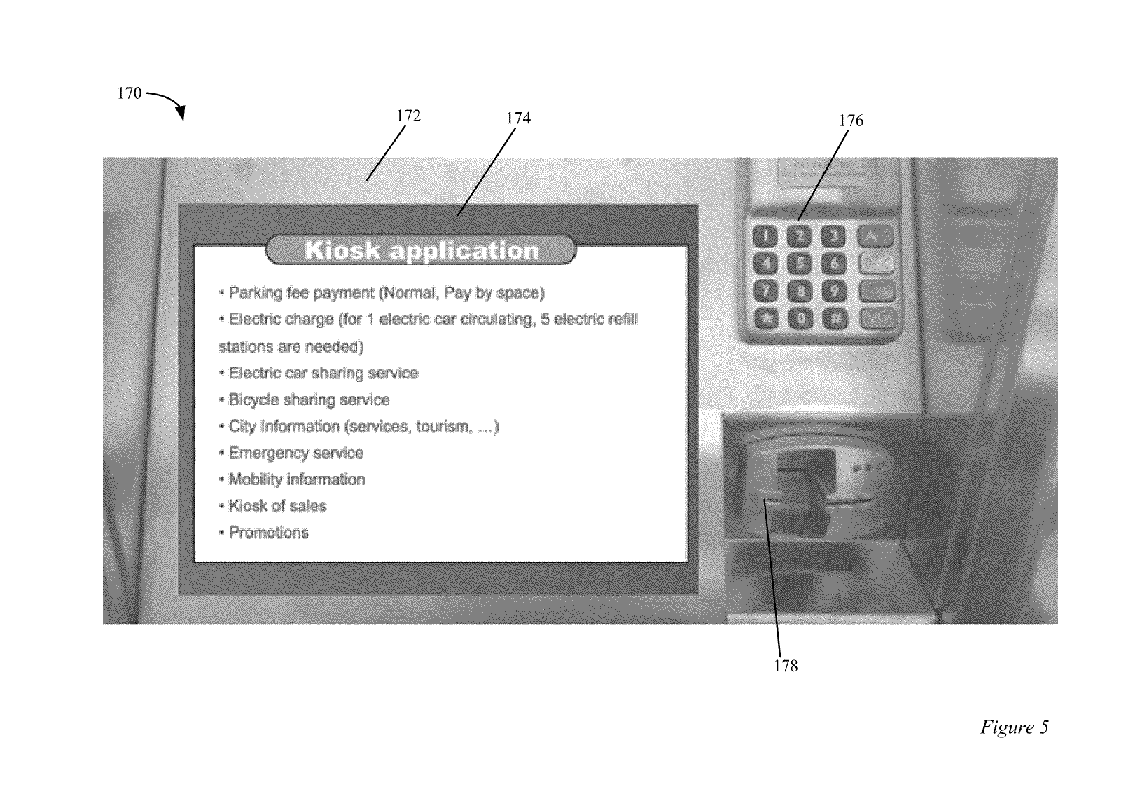

FIG. 5 is an illustration of a portion 170 of a human machine interface of a kiosk. The portion 170 of the HMI includes a metal front panel 172, a display 174, a key pad 176 and a card reader 178. The display 174 can be a touch screen display. The display 174 includes video images of a number of services which are available on the kiosk. In one embodiment, the user can select a service via a touch to a touch screen which can cause a processor within the kiosk to generate a video image to the display associated with the service. Some examples of services include but are not limited to a) parking fee service, an electric charge service, electric (or non-electric) car-sharing service, a bicycle sharing service, emergency services, a kiosk of sales, a marketing campaign, city information, mobility information and digital signage. Details of some of these services which may be available on the kiosk are described as follows.

First, parking services are discussed. Pay and display kiosk machines can be a subset of ticket machines used for regulating parking in urban areas or in car parks (parking lots, garages or any other regulated parking spaces which may be numbered or unmarked spaces). It can rely on a customer purchasing a ticket from a machine and displaying the ticket on the dashboard, windshield or passenger window of the vehicle. Details included on a printed ticket can include the location and operator of the machine, an expiration time, fee paid and time entered.

Other information can also appear on the ticket such as the zone, the identification of the machine having delivered it, a unique code allowing identifying fake tickets, the license plate of the vehicle, etc. The unique code can be provided by a remote server in contact with the kiosk. The remote server can be configured to verify the code. For example, a parking service operator may attempt to verify the code.

Parking fee service may support multiple configurations, such as but not limited to: a) managing the payment for generic spaces that are not individually identified, b) “Pay by Space” where each parking spot are delimited or c) combinations thereof. In Pay by Space, every spot can be bounded and numbered. One or more sensors can be associated with the space. This solution aims can manage the rotation of vehicles and the enforcement of the car park rules.

The parking fee service can allow for the management of certain combination of features, such as but not limited to: i) a type of parking spot (Normal, Resident, Handicap, Ecological Vehicle [e.g., low or zero emissions], etc.), ii) promotional coupons offering discounts on car parking (sponsored or not by a storekeeper, free car park for electric vehicle), iii) one or more Method of payment (Coins, NFC, Bluetooth, bank cards or other mobile wallet interfaces), iv) a capability of printing of a customizable ticket indicating the purchase of parking and v) a capability of printing of geo-localized promotional offers (i.e. Marketing Campaign) which may or may not be related to parking. For example, in one embodiment, the promotional offer can be locations where individuals can receive validation for a discount on parking, such as a movie theater. Another example, a promotional offer can be for discount at a store.

Next some details of the parking fee service are as follows. If <<Pay by Space>> mode is activated, the can system can prompt for a selection or input of the parking spot number. If a sensor is installed on the parking spot, the system can be configured to suggest the choice to the user among spots occupied in the last number minutes (the number of minutes can be customizable input of the operator), i.e., the system can display a list of recently occupied spaces and/or a map including the kiosk. The items in the list can be user selectable. When a parking spot is selected from the list, a parking transaction associated with the spot can be initiated.

Otherwise it may be possible to manually enter the spot number (an input format may include the zone number, kiosk number and the spot number to prevent typing errors). In one embodiment, a key board can be displayed on the kiosk where the keyboard only includes the symbols, such as numbers needed to enter the correct information. For example, if zones are one of A to F, and kiosks are only numbered, then the keyboard can display the letters A to F and the numbers needed to identify the kiosk (e.g., one to five, etc.).

Once a spot is identified. A user can select a category, such as normal, resident, handicap, medical staff, etc. A user identification (RFID/CARD, PIN Code) interface can be used if the category requires an identification, such as insertion of a card in a card reader, a swipe of the card near an RFID reader or an input of a PIN. A combination of verification techniques may be used. For example, the user may enter a card in a card reader and then receive a text with a one-time PIN or may be required to enter a fixed PIN to initiate the parking transaction. If the category doesn't require user to be identified, the system can default to the normal mode, otherwise the procedure continues.

Next, a selection of the method of payment (coin, NFC, Bluetooth-enabled mobile payments, payment card, parking card, other mobile wallet application, credit card, etc.) can be made where payment options that are available may vary according to the selected category. In one embodiment, it may be possible to input a promotional code which may result in a reduction of the payment. A selection of the amount of time according to the configuration can be made, such as selection from among a list of offers (different amounts of times) or a selection of the amount to be paid or insertion of coins (amount inputted between a minimum/maximum rising by +/−step). If coins are used the calculation of time purchased may be automatically made as the coins are entered. Next, validation of the amount of time purchased and the purchase price can be made and then a verification of the payment (in case of payment not using coins or currency) can be performed. For example, a credit card can be verified.

Next, after payment is received, a customizable ticket (customization can involve an operator choosing different parameters). In various embodiments, a printed ticket can include one or more of a date, a time up to when the parking is valid, offer type (resident, handicapped, etc., an area number and/or kiosk number, a park, a parking spot number and advertising. A marketing campaign coupon can printed if it is linked to a parking fee service.

Secondary services may be available in the menu associated with “parking fee” and may have a direct link with the main menu. A few examples of secondary service can be associated with the refill of the parking cards which can involve adding more funds to a parking card. A second service can be payment of a fine directly via the kiosk and communication with a remote device.

Next, electric car-sharing service is described. The electric car sharing service and associated sub-menus can be initiated via a selection of the electric car sharing service on the main menu in 174. New ways of using automobiles that are more environmentally-friendly, use space more efficiently and easier to use are being developed. “Green vehicles” with auto-sharing allow for a rational usage of vehicles, can contribute to the reduction of the polluting traffic from both a vehicle emission perspective as well as possibly reducing the number of vehicles entering the city and can constitute a flexible service to the user that can be complementary with public transportation options.

The electric charge service, which may be a software module executing on the kiosk, may manage a number of features, such as but not limited to subscription services, parking spots, geo-location services, promotions and payment. The subscription to this service may be necessary due to various administrative formalities, such as determining a user holds of a valid driver license and verifying the user's ID in case of violations (e.g. fines). Parking spots with charging stations may be equipped with sensors in order to detect the presence of a vehicle and optionally a deployable arch/barrier or some other device for preventing other vehicles from parking there when the parking spot is not in use. For example, a barrier may be deployed in the spot unless information associated with a qualified vehicle has been entered or the presence of a qualified vehicle is detected.

Geo-localization can involve keeping track of a position of an object, such as a vehicle or a person, determining its position relative to other objects in the system, which can be fixed or moving, obtaining information about objects deemed to be of interest and then deriving actions based upon the positions, the objects determined to be of interest and the information which can be learned about the objects. For example, geo-localization of vehicles can involve routing calculation according to the level of charge of the battery in vehicle. This service may require determining the position of a vehicle, retrieving map information, receiving a charge level from car, receiving traffic information and receiving a user requested destination.

With this information, a route can be plotted which allows for the battery level and expected traffic conditions. Further, a place for parking the car can be reserved, which is near the intended destination. In one embodiment, the car sharing may involve only one portion of the trip where a remaining portion can be made via another transportation mode, such as a taxi, bus, bike share, train or walking Thus, the system can be configured to output travel solutions which involve car sharing and other modes of transportation including details related to each mode of travel during a trip, such as driving a car-share to a particular location, then renting a bike a first location and returning to a second location, etc. The service can involve providing a visualization of the charge kiosk available in public road network and/or in parking (e.g., displaying available charge stations on a map and their status or displaying a location of a reserved charge station.) Further, the service can involve locating of the vehicle in case of voluntary or involuntary abandonment (technical problem, battery empty). The implementation of the service can involve the implementation of software at the kiosk and/or system level.

Promotions can involve offering a reduction on the parking fees. In one embodiment, the promotions can be sponsored by merchants in addition to reduced parking rates. In one embodiment, special promotions can be offered for only green vehicles or other designated class of vehicles (e.g., car pool vehicles or handicapped designated vehicles). In one embodiment, geo-localized promotional offers associated with one or more marketing campaigns can be output at a kiosk, such as via a printed ticket or an electronic transfer of an electronic ticket or other information to a user's mobile device.

Methods of payment can be similar as what was described above in relation to the parking service. As described above, the kiosk may off various mechanisms for payment. Also, the service can involve a printing of a customizable ticket (optional).

An example of using the electric car share service can involve receiving user identification, such as an RFID, card or PIN code. Then, method of payment can be received if the user has to pay for the service. The kiosk can be configured to display selectable payment options, such as coin, currency, NFC, payment card and/or display credits available. Next, the kiosk can be configured to receive promotional code which can reduce payment. This step may be optional.

Next, the kiosk can receive a selection of the amount according to the configuration which has been specified, such as a final destination where the amount can vary according to the distance from the current destination to the final destination. The kiosk can be configured generate, display and receive a selection from among a list of offers. The offers can be location specific and can involve communicating information to remote server, such as ID information, time and location, and receiving offers from remote server for output to display.

Next, the kiosk can receive a selection of the amount to be paid or payment/selection can be initiated by an insertion of coins. If coins are used the determination of what is purchased, such as an amount of time, may be automatically made during the insertion on a per coin basis. When a non-cash method is used, a validation of the amount and check of the payment can be made via communications with remote server. If desired, the kiosk can be configured to print a customizable ticket, such as a receipt or a promotional coupon.

Next, a bicycle sharing service is described. The system can consist of bike stations spread throughout the city and/or a zone to be covered. Every station may consist of several rows of ties for bikes and a kiosk which serves as interface between the users and the management system. As described above, one or more devices, such as the rows of ties, can be considered as satellite devices to the kiosk.

After registering with the system, the user can take a bike from a station using an activation device, such as a card/RFID badge and a code. At the end of its use, the bike can be returned to any other station by hanging it up onto the border of tie. According to the system, users can register with the administrator either directly on the kiosk deployed in station, normally by using a payment card (short-term subscription). A pledge (deposit amount) can be generally requested during the registration. The deposit amount can be kept if the bike is not subsequently returned.

The rent is normally limited to amount of time. A significant number of stations may be provided to offer a good meshing of the city or the zone that is served. The system can be compared to a transport network where every station of the network can be connected with the others directly. This is different than public transportation services where correspondences can be necessary.

In one embodiment, the system can be configured to receive an indication that a bike is in need of service. For example, a person may attempt to check out a particular bike and determine it is damaged. The person can return the bike and attempt to check out another. When the system determines that a person just checked out a bike, quickly returned it and then attempted to check out another bike, the system may query the user as to the condition of the just returned bike, such as flat tire, broken chain, operational/non-operational, etc. This information can be published to the city wide message bus.

In one embodiment, the bikes can include a GPS device and a wireless transceiver. Via the wireless transceiver, the bike can transmit its coordinates to a local wireless access point. This information may be used to recover and abandoned bike.

In one embodiment, a tracker sensor node can be provided near the bike station (It is can also be used separately from a bike station). The sensor can be used to monitor the state of particular objects near the sensor (e.g., within one hundred meters). For example, the sensor can be used to monitor a state of an electrical cabinet, man-hole cover or bike station.

This bike share stations can be complementary to a public transport network. With sensibly placed stations, a particular route to a destination can be alternately made, partly, with a bike and with public transportation. Contrary to what would take place with his own bike, the user does not need to take care of it as soon as he finished his trip. This principle offers advantages in terms of mobility but also new multimodal combinations.

Next, emergency services are described. The emergency service allows citizens to send an alert message for assistance from a kiosk. The messages are geo-localized because the kiosk broadcasting the message is geo-localized. For example, information associated with the zone of the kiosk, kiosk number, address where it is located can be included in a message or determined from information in a message. The emergency messages can be published to the city message bus.

The system, according to the type request, can allow checks via video surveillance system of the area proximate to kiosk, such as via a camera built into the kiosk or another camera with a view near the kiosk. Based upon, the video check, the appropriate service (police, fireman, ambulance, etc.) can be contacted. In addition, when the kiosk includes a microphone and/or speaker, the system may allow a person to talk with an operator that can gather information that allows an appropriate service to be contacted. Further, via the kiosk, a person may be able to select a particular service from a list of services presented on the kiosk, such as selecting from among police, fireman or ambulance.

An example of utilizing an emergency service with a kiosk is as follows. First, User pushes an “emergency call” button displayed on the LCD touchscreen display or on the button installed on the control panel of the kiosk which can be a mechanical button. In one embodiment, the camera installed on the control panel of the kiosk can be activated to take a photo (or video images) of the applicant. The photo can be sent to the operator to record the incident. If a camera on a camera system separate from the kiosk is available, then a camera on the camera system may also be activated.

In one embodiment, the following information can be sent to a dispatch center i) area number, ii) kiosk number, iii) kiosk address (e.g., street location and street or closest intersection), iv) timestamp of the emergency call, v) photo of the applicant or combinations thereof. Next, an operator in accordance with the request may contact the appropriate services. If available, the operator may be allowed access to communication devices on the kiosk, such as a speaker and microphone. Via the devices, the operator may attempt direct communications with a person at or near the kiosk. The communications can be recorded. An event can be sent towards the kiosk. In one embodiment, the event can include a message that indicates what service was dispatched. At an appropriate time, an operator can end the communication on its system.

Next, a sales service on the kiosk is described. A sales service can be used for the promotion and sale of events (sports, shows, subscriptions to urban services, tickets to museums, etc. The system can be configured to allow the various offers to be organized into a hierarchy by category of services which can be output to the kiosk display. Each offer may have its own configuration. The offer configuration can include one or more of the following: an offer description, a unit price inclusive of tax, one or more methods of payment accepted for the transaction, a specified format for printing of the ticket (In one embodiment, an electronic representation of the ticket format can be output to a user's mobile device.), refund/return policy, where information associated with collected payments are to be sent and combinations thereof.

In one embodiment, the offer can be presented as an HTML(5) enriched page that supports flash. In another embodiment, it can be made via a mobile application executing on a user's mobile device that receives offer information via a communication interface associated with the kiosk or from a cellular data network accessed from the mobile device. The offer information can be provided from a central server in communication with the kiosk and/or directly in communication with the mobile device. Since the kiosk can provide offers from various municipal services (transport for example) and private companies, the kiosk can keep track of and forward information regarding collected amounts (prices, commission, etc.). This information can be used to reimburse a service provider or a party which originated the offer (e.g., a concert promoter).

The kiosk can support different reimbursement systems, such as payments which are collected by the company/service managing the kiosk where the amount owed for every transaction can be sent to the supplier of the service or payments which are directly collected by the supplier of the service which then gives back a commission to the administrator of the kiosk. In both cases, the kiosk can manage for every transaction a transaction record including payment and service description that can be used for auditing and reimbursement purposes. A summary report by supplier of service is available for each of the parties. Transactions can also be published to the city message bus and subsequently stored at other locations, such as in the cloud.

Next, a city information service is described. Simple navigation within city for the users is one of services that can provided by the kiosk. The kiosk and underlying system can be configured to allow new information to be added, such as new events, and old information to be deleted (i.e., information that is no longer pertinent) as the city evolves over time.

In one embodiment, multiservice kiosk can be endowed with a multilingual portal information (French, English, Spanish, German, Russian, Japanese, Chinese, etc.) allowing users to obtain general information on the city and to emphasize certain information. Examples of certain information that can be emphasized can be one or more of general information, tourism, shopping, leisure activities, cultural activities, main events, work and road and other closures associated with events or maintenance operations and combinations thereof. In particular embodiments, general information can include general services of the city, such as information associated with an aadministrative center, city hall, police stations, consulates (important for the tourists), libraries, parking and transport.

Tourism can include information about major attractions and locations of tourism information centers. Shopping information can include information associated with various shopping venues, such as the location and types of shops within a shopping mall, main stores and stores promoting regional products. Leisure activities may include information about swimming pools, sports and recreation centers and night Clubs. Cultural information can include information associated with cinemas, opera/theater, museums and parks. Main events can include information associated with sports, concerts, festivals, etc.

The information may be made available on the kiosk in conjunction with a mapping application, such as Google Maps. Via the map, a user can select a category and all pertinent information can be displayed automatically on a map, which is output to the display, with the various mode of transportation available to go there (bus, tramway, car-sharing and/or sharing bike . . . ). If the user clicks on one of the bubbles icons shown on the map, additional information can be displayed (address, opening time). In certain cases, a link “more information . . . ” when selected can cause further information on the selected site to displayed.

In another embodiment, a limited set of information may be made available at the kiosk. To access a fuller set of information, the kiosk can be configured to provide a link to web location where a user can download an application to their mobile device that allows a fuller set of information to be accessed. In another embodiment, the kiosk may be able to download this application to the user's mobile device. In yet another embodiment, the kiosk can be configured to interact with user's mobile devices. For example, the kiosk can be configured to wireless connect to nearby devices and provide access to the information via a web browser executed on the user's device or another application executing on the user's mobile device. The kiosk can be configured as a local web server that supports browser requests on nearby mobile devices that have connected to the kiosk. One advantage of this approach is that the kiosk may be able to serve multiple users at the same time so that individuals don't have to wait for the kiosk interface to become available.

Each kiosk can be configured to support information that is unique to the particular kiosk (kiosk centric). For example, each kiosk may support an interface that shows only items of interest near the kiosk, such as bike sharing near the kiosk, buses nearby the kiosk or places of interest near the kiosk. The kiosk centric information that is tailored to the particular kiosk can be an interface option that is made available a selectable option to the user. This service can use Web technologies (HTML Page, Flash) and can be deployed locally in order to avoid excessive network traffic. The local applications can be regularly updated via remote maintenance. Its management can be made by the various services of the city involved in its contents.

Next, a mobility service is described. The mobility application can be a portal service that allows for displaying various modes of movement in the city using a mapping application, such as Google maps. The system can be configured to show a plan of the geographical zone around the kiosk. (Possibility of setup by default the range of the visible area, for example, 400 meters around the kiosk. In one embodiment, the kiosk can be configured to receive an input of a desired destination. Selectable options, such as a choice of mode of transportation can displayed including but not limited to on foot, public transportation, such as bus, tramway, train, boat, taxi, bicycle sharing and car-sharing. In addition, traffic information in the area of interest can be displayed if the user selects an option, such as car-sharing.

According to the selected transportation choice the kiosk can output the stops of public transportation which can get them to their destination, and the next time when the vehicle (bus or train) will arrive at its stop. In one embodiment, the actual positions of vehicles can be tracked and an arrival time of the next vehicle can be estimated based upon this information. In other time, the arrival time can be based upon a published schedule. If taxis are selected, the stations and the number of taxis available per station can be displayed. The taxis information can be real-time information based upon gathered sensor data. If bike sharing is selected, the bike stations and the number of bicycles currently available for sharing at each station can be output. If car-sharing is selected, the stations and the number of cars available for sharing at each station can be displayed.

In one embodiment, an estimated cost for each selected transportation choice can be displayed. For example, the cost to take a taxi to a selected destination can be displayed. Further, a time to a destination using each mode of transportation can be estimated. For modes affected by traffic, such as car sharing, buses or taxis, local traffic conditions can be taken into consideration in an estimation of the time. In one embodiment, the estimated costs and estimated times can be displayed next to each transportation option. In another embodiment, after a user selects a destination and a mode of transportation, the system informs the user of the best route, cost, distance to the destination and estimated time. In a particular embodiment, a user may be able to select multiple modes of transportation, such as bike and walk, or bus and bike.

Next, a digital signage service is described. As described above, one or more digital signs can be provided as a satellite device. Further, a secondary display can be integrated into the kiosk which can be used as a digital sign. The integration of a digital signage service on the kiosk can add a multimedia tool allowing a user to configure communications that can be output on or more displays. The communications can be related to one or more of services of the kiosk, services of the city, general information of the city, sports, artistic events and general advertising.

The Digital signage module may consist of a frame or other housing containing a screen of a varying size and a computer including a processor and memory for driving and managing the display and its content. In one embodiment, a speaker or other audio device can be provided with the signage. As described above, the digital signage module may be configured to act as a slave to the kiosk. The internal computer can be configured to run software for managing multimedia content, such as a download of multimedia content (commercial, information, etc.), scheduling of broadcasting of spots and the broadcasting of spots.

Next, a marketing campaign service including configuration setting is described. A few examples of types of marketing campaigns that can be managed by the kiosk are as follows: i) special offer on the use of the kiosk services, ii) special offer on stores/shops located in the parking area, near a kiosk or possibly away from a kiosk and iii) general offers/advertising not necessarily tied to a specific location. The special offer on the use of kiosk service can be a discount to services of the kiosk, such as mobility services, parking, car-sharing, bike-sharing, etc. The service in charge of the specified services (typically, but not necessarily a government agency) can specify coupons to print which offer discounts on the car parking and mobility services.

Another offer type is a discount offer on stores located near the kiosk. When user proceeds to the payment of the parking fee at the kiosk, promotional coupon can be dispensed if user is determined to be eligible for the promotion. The dispensing of a coupon can be involve the printing of a coupon using a printer on the kiosk, transferring an electronic image of the coupon to a user's mobile device, which can be output to a display on the mobile or combinations thereof.

In one embodiment, a payment may be required to be eligible for a coupon. For example, the kiosk can receive a selection of an available service and an associated payment. For parking, a receipt, such as a receipt displayed in the car window can be printed. Once the receipt is printed, the kiosk can be configured to dispense the promotional coupon (i.e., print it or electronically transfer it). For other service purchases, the kiosk may or may not print a receipt (e.g., bike sharing or car charging) but can print a promotional coupon after purchase. As described above, the kiosk or central system can be configured to send an electronic receipt and/or electronic coupon to a user's mobile device. The electric coupon can be sent in lieu of or in conjunction with the printed coupon.

In one embodiment, a user can initiate an electronic payment via their mobile device. Once the payment is verified, a user can receive the confirmation of the payment by SMS as well as a web link to the promotional coupon. If desired, using the web link, the user may be able to print the coupon at home and subsequently redeem it. For example, the promotion can be for a parking discount on a future purchase of parking. Further, information can be sent to the user's mobile device that allows the promotion coupon to be generated in a mobile application and displayed on the user's mobile device.

In one embodiment, the kiosk can be configured to receive an input which allows the promotional coupon to be dispensed at the kiosk. For example, a unique code can be associated with the coupon and appear in an SMS message or otherwise displayed on the user's mobile device. The user can input the unique code via the kiosk interface. Once the code is entered, the code can be verified by the kiosk. For example, a remote server can store a list of unique codes for coupons previously issued by the server. When the coupon is determined to be valid, it can be dispensed at the kiosk (e.g., it can be physically printed out or an electronic representation of the coupon can be generated which is similar in format to its printed appearance).

The system can be configured to dispense a coupon only once or some user specified amount of times where the coupon can be dispensed at the system level or directly at a kiosk. An indication can be saved in the system of how many times a coupon has been dispensed (whether at a kiosk or via some other mechanism). If an attempt is made to subsequently dispense the coupon at any of the kiosks coupled to the central system which has already dispensed the maximum number of times, then the kiosk can be configured not to dispense the ticket and indicate it has already been dispensed its maximum allowable times. The user may still be able to print out the coupon at home but not via the kiosk.

In one embodiment, the system (e.g., a central server) can also be configured to keep track of how many times a coupon has been redeemed, such as once, never or multiple times. The system can be configured to not allow a kiosk to dispense a coupon if it has been previously redeemed once or some maximum number of times (and/or if the offer associated with the coupon is expired). Further, the system including the kiosks can be configured not to honor a coupon that has been previously redeemed once or up to some maximum allowed threshold value (and/or the offer associated with the coupon is expired).

This feature may allow coupons to be issued which can be redeemed multiple times, such as a 10% discount on parking or shopping which can be used on up to three different occasions. Further, it may allow a coupon to be shared with another user. For example, a first user can share a coupon with a second user which is usable two times. The coupon can be redeemed twice by the first user, twice by the second user or once each by the first user and the second user.

Promotional coupons can include, optically formatted data, such as a Flashcode's bar code or a QR-code that allows for checking of the coupon's validity. Flashcode is the brand of the 2D bar codes developed by the French Association of mobile multimedia. These pictograms consist of squares, which can be decoded by mobile phones having the Flashcode reader. Many mobile phones are already equipped with this software, for the others, its installation is simple. The optically formatted image data can be displayed on an actual printed coupon or an electronic representation of the coupon which can be stored on a portable electronic device.

When a user goes to the shops to redeem the promotion. The storekeeper can use his mobile phone to register the promotion which is printed on the coupon or displayed on a user's mobile device. The photography of Flashcode with the mobile activates the sending of an e-mail of acknowledgment towards the service “Promo Park” (or other type of offer) to ensure the follow-up of the coupon. Flashcode uses norm of the standard of matrix codes, Datamatrix, and a “grammar” which allows defining action activated by the scan of Flashcode. One benefit of this solution is that it requires on behalf of the storekeeper no investment in equipment. The coupon can also contain a coupon number which can allow the storekeeper to make a manual data entry of the number via a device coupled to the Internet.

Kiosks can also be configured to allow a user to input a coupon number to redeem a coupon. Further, kiosks can also include a scanner or a camera which can be configured to receive optically formatted image data. For example, the kiosk can be configured read a QR-code or a Flashcode.

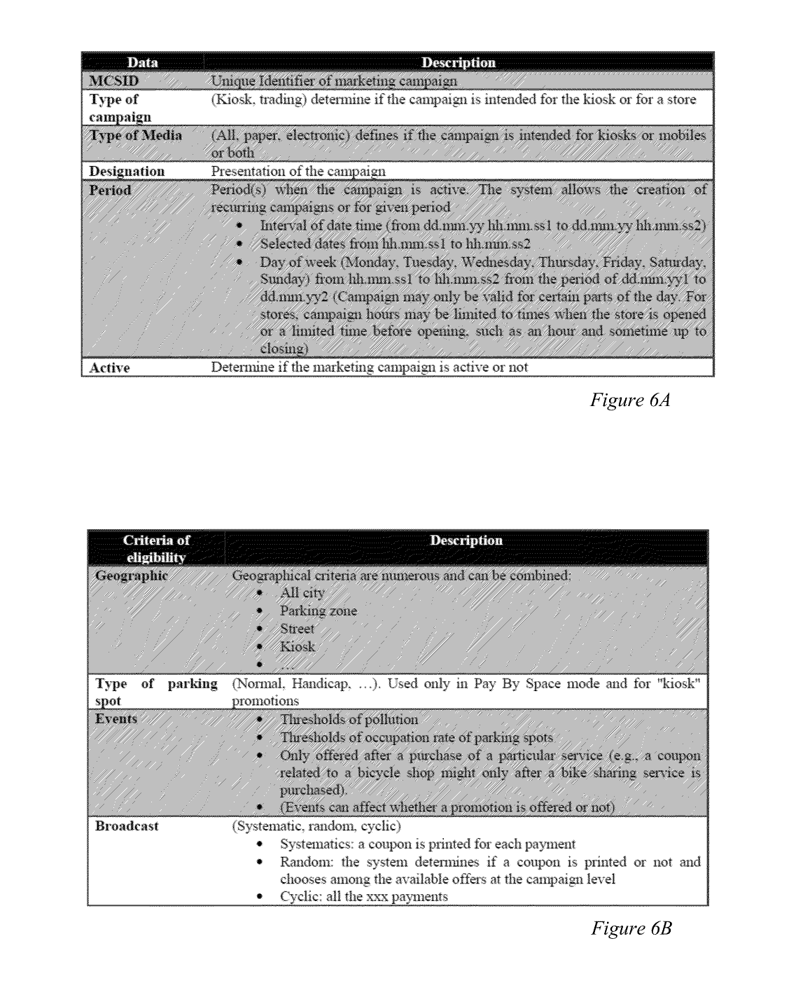

Next, details of a marketing campaign configured are described. FIGS. 6A, 6B, 6C, 6D and 6E illustrate a configuration for a marketing campaign service in accordance with the described embodiments. A unique identifier can be assigned to each campaign. In FIG. 6A, information associated with a campaign, such as a type of campaign, a type of media, a period for the campaign and whether it is active or not is described. This information can be input and made available to a user via a system interface. In FIG. 6B, information related to an eligibility criterion, which can be implemented by the system, are described. The different criterions listed are optional and various combinations can be implemented which differ from campaign to campaign.

Next, the promotional offers associated with a campaign are described. One or more promotional offers can be associated with the same marketing campaign. For each, the electronic and paper representation of the coupons can be specified. The electronic and paper representations of an offer may be identical (i.e., the electronic representation looks the same as a printed coupon), similar (e.g., formatting may be slightly different, such as to fit on a user's mobile device display, but the same information is provided in each representation) or totally different from one another (formatting can be totally information and the information appearing on the representation can be different). In particular embodiments, Templates associated with coupons can be reused for numerous marketing campaigns.

In another embodiment, multiple campaigns can be active at one time which are applicable to different groups of kiosks that may or may not overlap. The campaigns may utilize a subset of kiosks to dispense offers, such as kiosks within defined geographic areas. In one embodiment, a subset of kiosks can dispense offers which are valid at any kiosk. In another embodiment, a subset of kiosks can dispense offer that are valid only at the subset of kiosks which dispensed the offer. For example, a first kiosk can dispense an offer for a parking discount which can only be redeemed at the first kiosk. In another embodiment, a first subset of kiosks can dispense an offer which is redeemable at second subset of kiosks where the kiosks in first subset and second subset may or may not overlap. For example, a first kiosk can dispense an offer which is only redeemable at a second and third kiosk different from the first kiosk.

FIG. 6C shows some parameters associated with an offer. The model XAML can refer to a file(s) defining formats in regards to how the coupon is printed and/or represented electronically. FIG. 6D shows some parameters which allow a defined offer to be specified with a specific marketing campaign. The specified parameters can be monitored by the system, such as whether the number of coupons available for the campaign. Again, multiple offers can be associated with a single marketing campaign.

FIG. 6E shows some information which can be generated and stored as coupons are issued. Again, the issuing of the coupon can involve sending an electronic representation and/or printing a representation of the coupon at the kiosk. For each of the campaigns, the system can provide an interface for visualizing some combination of the following information: a) state of the campaign (pending, active, closed), b) number of coupons dispensed by the kiosk (for all kiosks or on a per kiosk basis where this information can be output to a map showing kiosk locations), c) amounts to invoice, d) number of coupons used at the kiosks (for all kiosks and/or on a per kiosk basis for coupons redeemable at a kiosk), e) number of coupons used at a store, f) number of coupons dispensed electronically, such as via text or e-mail, g) number of electronically dispensed coupons redeemed, h) locations where electronically dispensed coupons are redeemed (kiosk, stores, etc.) and number of each and i) statistics, such as return rate of the campaign (global, kiosk, electronic) and j) distribution between printed and electronic issuance methods.

Once the campaign is ended, the system can proceeds to the issuance of the invoice. In one embodiment, an interface including this information can be provided to campaign sponsors during a campaign. In addition, historical campaign data can be made available. This information may allow a sponsoring entity to construct a campaign. In one embodiment, data for multiple campaigns can be aggregated and displayed on a kiosk by kiosk basis.

For example, the number of coupons printed at particular kiosks and redemption rates can be displayed on a kiosk by kiosk basis. Further, redemption rates can be displayed on a day by day basis. Using this information, a sponsoring entity may be able to use the system to define offers that are kiosk specific and/or day specific. For instance, if the redemption rate of coupons drops off based upon a distance of a kiosk from a store, a sponsoring entity may be able to tailor the campaign to offer more valuable coupons for kiosks farther away from the store as compared to kiosks closer to the store to increase redemption rates. As another example, a user may see that redemption rates are lowest on Monday and greatest on Fridays. In response, the user may define a campaign that provides more valuable offers on Monday as compared to Friday to increase coupon redemption rates.

### Kiosk Software Architecture

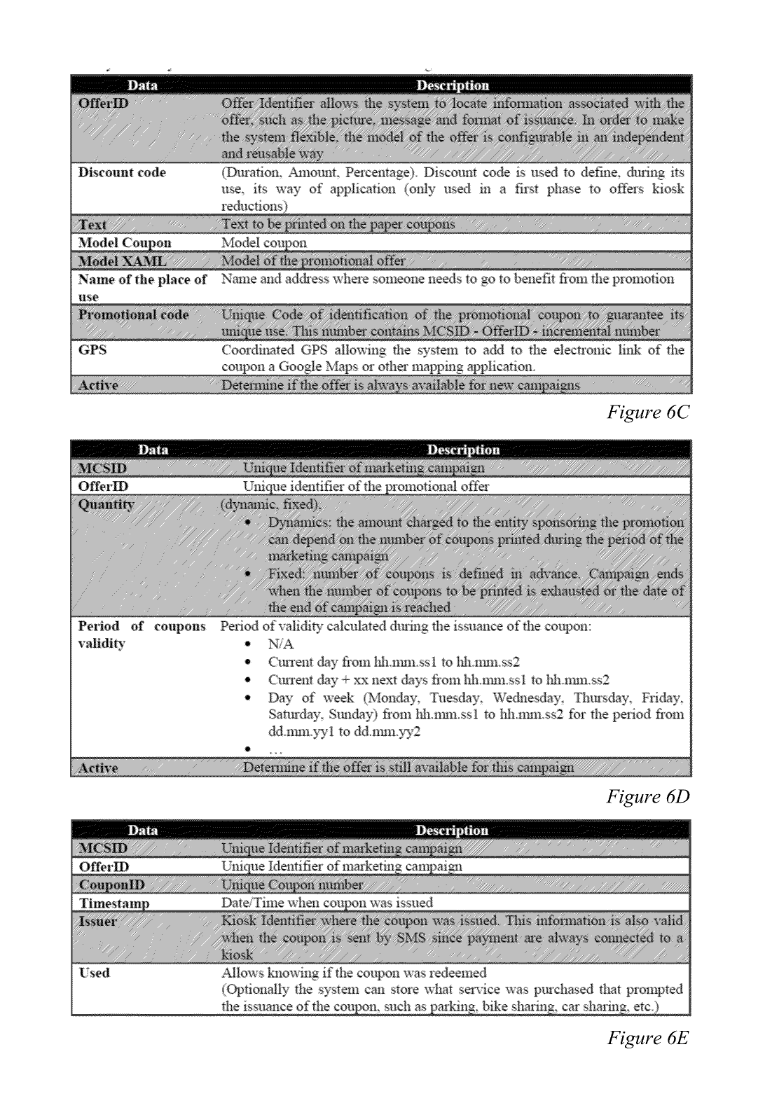

Next, details of kiosk software architecture are described. FIG. 7 is a block diagram of kiosk software architecture 200 in accordance with the described embodiments. The implementation of a modular architecture can allow the mutualization of a set of basic services used at the kiosk. This architecture can be designed to enable the addition of new functions, devices and services for the users in the future.

Kiosk Framework 202 can supply a set of common features to the applications, such as device management, payment, communications, user interface, etc. Host Application 206 can be a “container” application allowing for the management and the execution of plug-ins. Plug-ins 204 are individual services provided to the users' and/or the city agent in charge of the management of the services and/or functions accommodated by the kiosk. The number and type of kiosks can vary from kiosk to kiosk. As described above, one factor which may affect the installed plug-ins are the satellite devices associated with a kiosk.

The framework component 204 groups together all common services for all of the users' services accommodated by kiosks. Framework controller 208 can be a transverse service in charge of controlling the operation of all the sub-systems of the kiosk. In particular, it can perform one or more of the following tasks: a) control the execution of business applications (host application and plug-in in the case of the kiosk) and various services of framework 202 and b) ensure updates of various services of the framework, applications and plug-ins of the kiosk. It can utilize the services managed by the device controller to perform updates.

Further, the framework controller 208 can enable one or more of the following: i) displaying maintenance messages of the kiosk for the attention of the users (typically, operational personnel will view this menu), ii) determining whether one or of several services need updating, iii) installation of the updates and the reconfiguration of these by device controller 210, iv) restart of all or any of the services and/or the kiosk, vi) implementing the startup/restart procedure (watchdog managed by the device controller 210) of the system by starting automatically the services in the pre-defined order (start-up sequence). All the services within the kiosk can be directly or indirectly controlled by this component.

The communications service 212 allows the implementation of a communication interface between the kiosk sub-systems and the information system (central server) via DDS, such as publication and subscription to message on the city message bus 120 as described above with respect to FIG. 3. The events service allows the publication of events towards the information system or the subscription of events from the city message bus. Publication can involve sending of events associated with a state or alarms related to the functioning of the kiosk. Further, an income statement from the car park fees “plug-in” can be published. In addition, statistics on the state of the car park can be published.

In general, each plugin, such as the parking fees, electric charger, car/bicycle share, city information and marketing promotion can use the external communication DDS to publish and to subscribe to events. A few events to which an application subscribe are a change of settings of the kiosk, change of settings of a service of the kiosk (e.g., for one of the plug-ins) and multimedia content updates. An example of a change of settings of a service can be a new parking fee structure. Multimedia content updates may be related to digital signage, city information and marketing promotions.

The encryption service can allow the kiosk to encrypt/decrypt all information published on the ESB. In one embodiment, a symmetric encryption algorithm can be employed. As an example, Blowfish uses a size of block of 64 bits and the key of variable length can go from 32 to 448 bits. Blowfish provides a good speed of execution except during a change of key. It is approximately 5 times as fast as Triples DES and twice as fast as IDEA. In spite of its age, it is still solid from the cryptographic point of view with relatively few effective attacks on the versions with fewer tours. The complete version with 16 tours is completely reliable today and the exhaustive search remains the only means to attack it. It is available currently on Linux and Windows. Other types of encryption software can be used and the example of Blowfish is provided for the purposes of illustration only.

The message bus can be used for the file transfer between the information system and the kiosk. It may be optional in the case where a FTP server is employed. Some reasons the message bus may be employed are as follows. The message bus can be multicast. Thus, it allows sending the same file to many kiosks simultaneously. This solution allows for reducing the use of the bandwidth and de facto, increasing the performances of the system. Further, FTP is not secured while all data packets sent via the message bus can be encrypted. In one embodiment, the external communication service may not be used for internal communications between services of the kiosk because the communication between the services of the kiosk may be made in a synchronous way (just in time) while the message can be designed for asynchronous communications.

The payment service 214 can be configured to manage the various payment devices which are used by the plug-ins. It creates an abstraction layer which allows changing payment devices installed in the kiosk without having the obligation to modify the code of plug-ins. It can provide the interface between plug-ins and various devices of payment. For each of the devices, the service can manage the sequence and data exchange between the plug-in and the device. In order to optimize messages, in one embodiment, the service can use Google's “Protocol Buffer” data exchange format. It is a binary, flexible, effective exchange format, automated to serialize the transfer of structured data. This protocol allows data serialization, like XML, but in a faster and simpler way

The payment service 214 can provide management of various payment devices, such as a coin acceptor with cancellation and/or coin change and an electronic payment terminal. The communications between the electronic payment terminal and the servers can be made via the communication link to the external network, such as power line communications or WiMax and/or via GPRS/3G. In one embodiment, a GIE CB bridge is used (certified Double SSL). CB offers the ATM and EFTPOS networking infrastructure which can be used with smart cards, magnetic striped cards, debit cards and possibly NFC (Near Field Communication) payment or other types of electronic wallet protocols and hardware (e.g., hardware and protocols associated with Apple's iBeacon and PayPal's Beacon product which use Bluetooth LE).

The payment service can be configured to keep the payment devices running (e.g., calibration and software updates), monitor the availability of each of the devices, monitor the state of the devices and keep track the activation/deactivation of the devices according to the selected plug-in which has requested use of the device. For example, the parking fee plug-in can use a payment device to a pay for parking whereas an electric charger plug-in can use a payment device to pay for charging up a car. Further, the payment service can manage tilt events in case of hardware or software problems on one of these devices. Further, tilt events, such as a paper low, out of paper or paper jam events can be managed.

The UI (user interface service) can control the human-machine interface on the kiosk. In one embodiment, a Web server (HTTP, SMPT, FTP . . . ) can be installed locally in the kiosk to support web technologies. By accommodating web pages locally allow, “Offline” services which don't require requests via the network can be used. Thus, the kiosk can remain at least partially operation when the network is down. Further, network communications can be reduced. In one embodiment, the web server can be implemented using IIS of Microsoft or Apache. For the user interface, the use of the Web technologies, such as flash (Linux) or WPF (Windows) may be employed in various embodiments.

The device controller 210 can be a service which provides for the update and the settings of the kiosk including all the services, applications and devices. It can provide for the management of the software components and equipment of the kiosk. In particular embodiments, it can be configured to provide the communications between device manager of the “City Services” platform and the kiosk. Every xx seconds (some specified interval), the device controller 210 can send, via DDS, the state of the kiosk to the device manager module of the “City Service” platform (central server). The device manager module (not shown) can be in charge of monitoring and managing all systems deployed in the field (public road network) and scheduling the update of the various services, applications, plug-ins and devices installed in the kiosk.

The device controller service 210 can be configured to manage the versions of every application, plug-in, service and devices firmware installed in the kiosk. In addition, it can manage the settings of each of the components of the kiosk (plug-in, application, service and devices). The update of the configurations can be provided by a device manager at the level of the “City Services” platform (i.e., it can be coupled to the city manage bus 120 in FIG. 3.) Further, the service 210 can manage a software watchdog which can be used to ensure the restart of services in case of dysfunction (e.g., a kill of a dysfunctional service and restart of the service). During update operations, the “Device controller” can use the watchdog to remotely force the restart.

In various embodiments, the controller service 210 can manage the updates planned by the remote “Device Manager” via the scheduler including a) receiving the necessary files for the update, b) stopping of the services/applications (host applications and plug-ins requiring the update), c) execution of the update scripts (firmware, OS, application) and e) restart via the framework controller.

In additional embodiments, the controller service 210 can be configured to check all the system parameters of the kiosk via the “Health check” service. The health check service can check a state of memory use, state of CPU use, I/O use for the applications and services executing on the kiosk and provide alerts when certain thresholds are exceeded. Further, it can monitor a state of one or more hardware devices. For each of the hardware devices within the kiosk, besides monitoring its state of functioning, it may be able to monitor specific indicators associated with each device, such as a level of the paper for a printer, a fill level for a coin holder or a fill level for a bill acceptor.

Further, the health service can be configured to monitor a level of temperature and humidity in the kiosk. In addition, the kiosk can include security monitoring circuitry. For example, circuitry for detecting whether an interior of the kiosk has been accessed (e.g., an internal light sensor or circuitry for monitoring actuation of a lock). Further, when a coin box is removed and/or emptied this event can be detected and monitored. The health service can monitor the security circuitry and report when an event occurs, such as an unauthorized access to the interior of the kiosk. The information generated by the health check service can be published in the form of events sent to the city message bus via external communications 212.

The “Device Server” service can provide access to devices within the kiosk, such as the display (with the exception of those related to the payment managed by the “payment service”). The devices can be used by the various services and the applications of the kiosk. In some instances, a device can be locked when it is used by a particular application or service to prevent another application or service from using the device. Further, in some instances, devices can be shared by various services or applications. Thus, a mechanism may be needed to mediate situations where two services each require a shared device for different functions at the same time. The mechanism can determine which service is to be granted access to a device when two or more services seek to use the device at the same time.

Certain number of services or secondary software components can be used to provide the functions of the kiosk. A few examples include but are not limited to: an SQL server (database), an FTP Server, a scheduler, event logging and user management. In one embodiment, an SQL server can be deployed on the kiosk to allow the storage of data as follows: all the configurations of plug-ins, services and devices, data resulting from the activity of the different plug-ins deployed on the kiosk and log file. However, to support a degraded mode (configuration, log and protection of the most sensitive services), certain data can be stored in the form of XML file to be able to continue to supply a certain number of services in case of problem on the SQL server. As an example, a Microsoft SQL Server Compact Edition/express or MySQL can be utilized.

The FTP server (Line Transfer Protocol) can allow for transferring files by Internet or by a local computer network (intranet). It can be used for: the update of the “firmware” of the various devices, services and applications constituting the kiosk and the deployment of multimedia content associated with certain services or applications. The FTP server can be installed on the kiosk in support of the “transfer of file” service integrated into the external communications service using the properties of the DDS. Numerous freeware FTP servers are available on Linux or Windows.

The scheduler can be a centralized system used for the execution of tasks defined at the level of the applications. It can use mechanisms which applications to be notified when a task must be executed, to manage recurrence of execution and the history as well as the status of execution. The scheduler can be configured to: a) schedule a job to run based on date and time, events, etc., b) change the schedule for or turn off an existing job, customize how a job will run at its scheduled time, c) monitor job execution progress in real-time as well as forecast job start, d) organize logically related jobs into logical groups represented by folders, e) maintain list of exception dates such as holidays, f) send notification messages about job execution status, g) log job execution progress and status and h) generate detailed reports on the job definitions, dependencies, and execution status.

Further, the scheduler can be configured to allow scheduling a job to run at certain times. One or more conditions that will trigger the job start can be specified. As examples, the scheduler can watch for following trigger: a) time watch, b) process watch, c) e-mail watch and d) log-off/shutdown watch. This service can also be used to execute the updates of the sub-systems of the kiosk, to notify a service of the execution of a process (for example sending the statistics of car park or the income of the car park management plug-in).

The concept of “logging” can be related to the sequential recording in a file or a database of all the events affecting a particular process (application, activity of device or a computer network). The log file of events is the file containing these records. Generally dated and classified in chronological order, it allows for analyzing step by step the internal activity of the kiosk processes and its interactions with its environment. The “logging” can be useful for all the types of applications. In particular it can enable tracking of exceptions which can occur in each application and the various abnormal or normal events bound to the execution of the application.

In addition, the logging service can manage messages issued by an application during its execution. In response to the messages, an immediate or delayed response can be generated. These messages can be very useful during the development of an application either to understand its functioning or to resolve a bug. Every service, application, plug-in may have the potential of sending messages to be archived in log files.

In particular embodiments, the logging service can be configured to provide for the recording of the exceptions resulting from various services and application accommodated by the kiosk. The logging service can be configured to provide for the maintenance of the log file (size, lasted, purges . . . ). In one embodiment, the logs files can be organize can be organized as a hierarchy the files of the log (system, application). The use of the logging service can allow logging functions to be decoupled from each application, i.e., separate logging functions don't have to be integrated into every application. The publication of these log files via DDS, on request from the “City Service” platform can enable remote supervision of the kiosk, a facilitation of the kiosk maintenance and the facilitation of on-site intervention planning if required.

The user's management can be used to manage the maintenance interventions and specific services provided for the municipal agents. Since kiosks can be installed in public road network, it may be important to set up a mechanism of electronic authentication allowing accessing the maintenance menus and/or services for the qualified personnel. For that purpose, the kiosk can be equipped with an electronic key as Electronic Dallas Key or USB Key including electronic certificates. In one embodiment, the health check service can monitor the use of the electronic key and generate an event when an electronic key is utilized to gain access to the operator functions of the kiosk.

The Host application 206 can be a module “container” in charge of the execution of plug-ins. In one embodiment, all the plug-ins can be deployed in a directory. Host application can use a loader application (CLR in the case of .NET and JVM for Java) to insure their installation within the host application.

The host application 206 can enable the loading and the provisioning of plug-ins. During the start-up of the host application 206, it can be configured to scan the directory containing plug-ins and load them into memory. During the installation of a new plug-in by the device Controller 210, it can send a notification to the framework controller 208 to request the host application 206 to proceed to load the new-plug-in.

The host application 206 can allow for the dynamic creation of the user menu at the kiosk at the user interface level according to the plug-ins deployed in the kiosk. This interface can be developed in XAML (WPF) or flash depending of the platform selected for the kiosk (Linux or Windows). XAML is an extensible mark-up language developed by Microsoft. WPF (windows presentation foundation) is a presentation system for building Windows client application.

In one embodiment, the host application configuration can be stored in the SQL database deployed in the kiosk. As described above, the host application can be configured to manage the execution of plug-ins. In one embodiment, host application 206 can include a module license which manages license fees and associated pricing. According to the returned services and the features it can offer various modes of pricing (run time, traffic of data rising front, traffic of data downward front). This module can supply statistics of use of each service deployed on the kiosk and allow for the start-up of new services or the shutdown of certain services.

Services to users are expected to expand during the kiosk's deployment in the field. In this context, it is desirable to set up a dynamic architecture utilizing the technologies described previously (framework and host application). The development of services in the form of plug-in can provide the needed flexibility. A plug-in can be software which is utilized by a software host to provide new features. A few advantages of using plug-in within the framework of the multiservice kiosk are the following ones: a) use of common resources implemented in the kiosk (payment services, communication) which simplifies the development process and b) they can be developed by third party vendor having no relation with the authors of the main software. The supply of a software development kit can allow third party service companies to integrate their own features into the kiosk.

A Plug-in can be business-specific applications intended to provide particular functions to users of the kiosk. They can utilize all the features supplied by the kiosk, such as payment service, devices installed in the kiosk, external communication, etc. They may be provided in the form of dynamic libraries (lib*.dll on Windows, dynamic library lib*.so on Linux).

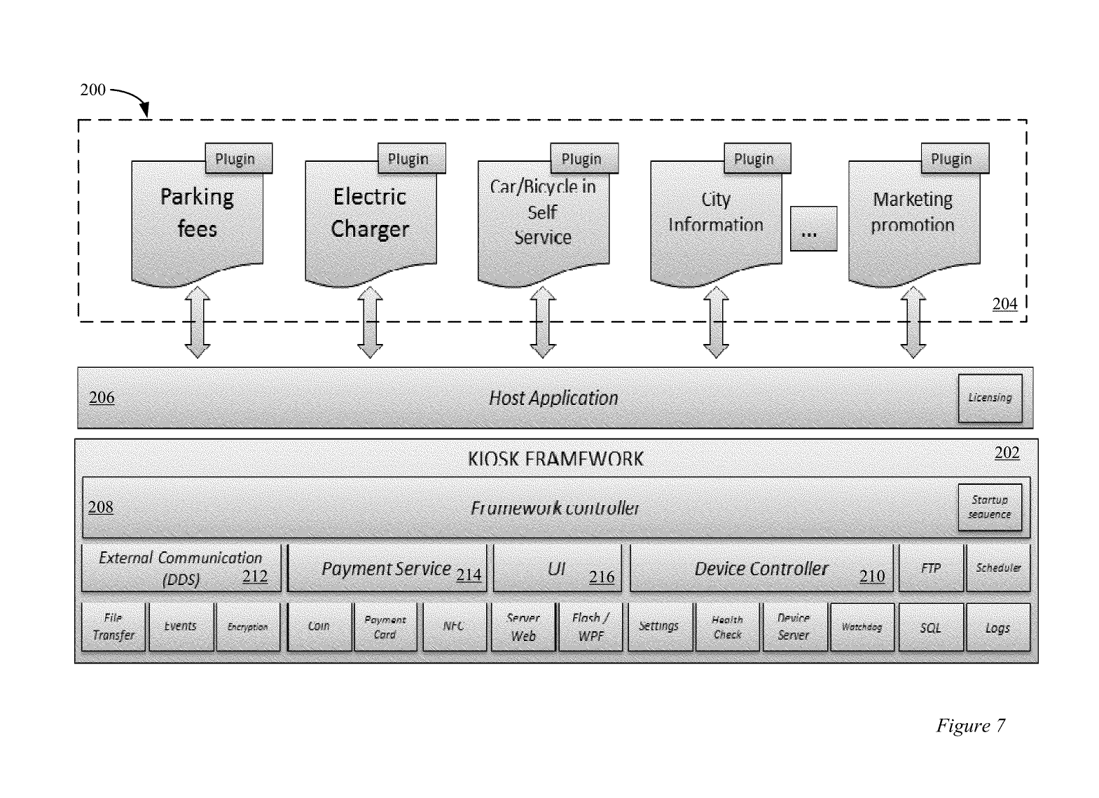

FIG. 8 is a block diagram of interactions between a host application 206, a kiosk framework 202 and a plug-in 218. As described above, a plug-in can be executed by a host application 206. The role of the host application 206 may be to determine and possibly generate a list of the plug-ins installed on the kiosk by examination of the present files in a dedicated plug-in directory, to supply an execution interface to the users and to execute plug-in according to the choices of the users.

In one embodiment, the communications with the various services of framework 202 can be directly made (without passing through the host application 206). The communications can use a typical request-reply communication using serialization/de-serialization, via use of Protocol Buffer by Google for the coding of the information or some other protocol. This mode of communication may be suitable because most communications are synchronous. During a request, the addressee may not send confirmation of reception, but the answer. If at the end of defined timeout the answer does not arrive, the transmitter may consider that the request failed.

### Kiosk Hardware Architecture

The multiservice kiosk can utilize modular material architecture to allow the integration of new services using new devices and\or external systems. A certain number of hardware features of the kiosk are described as follows for various embodiments. In one embodiment, the kiosk can include double hull to decouple the design aspect of the safety (e.g., weather and damage resistance) from internal structure of the kiosk. Internal specifications of the kiosk can include defining of a beam of cables (wiring harness) allowing the connection of the various devices with the mother board/back panel managing the kiosk and creation of a modular panel grouping together all the devices used for the HMI, Human Machine Interface (screen, RFID, coin acceptor . . . ). According to the configurations, when certain devices are not used the unused apertures in the modular panel can be covered. This solution may be necessary so that a kiosk already deployed in public road network can be easily upgraded.

A power supply can be configured to support one or more of the following voltages: a) +24 V DC, b) +12 V DC, c) +5V DC, d) −5V DC (optional), e) −12V DC (optional), f) 24V AC (optional) and combinations thereof. Signage on top of the kiosk can allow the users to locate easily the kiosk and can also be used for integrating the module of external communication (Bridge TCP/IP ZigBee or Gateway).

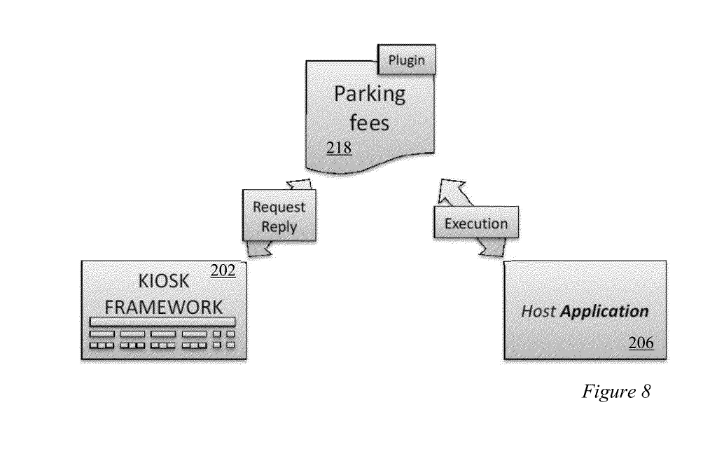

As described many different functions can be implemented in the kiosk. As described above, some the functions can be implemented via plug-ins. Each of the functions can utilize different combinations of hardware. FIGS. 9a and 9b show an example mapping of functions to different hardware devices on the kiosk. The hardware mapping, hardware devices and functions are provided for the purposes of illustration only and are not meant to be limiting.

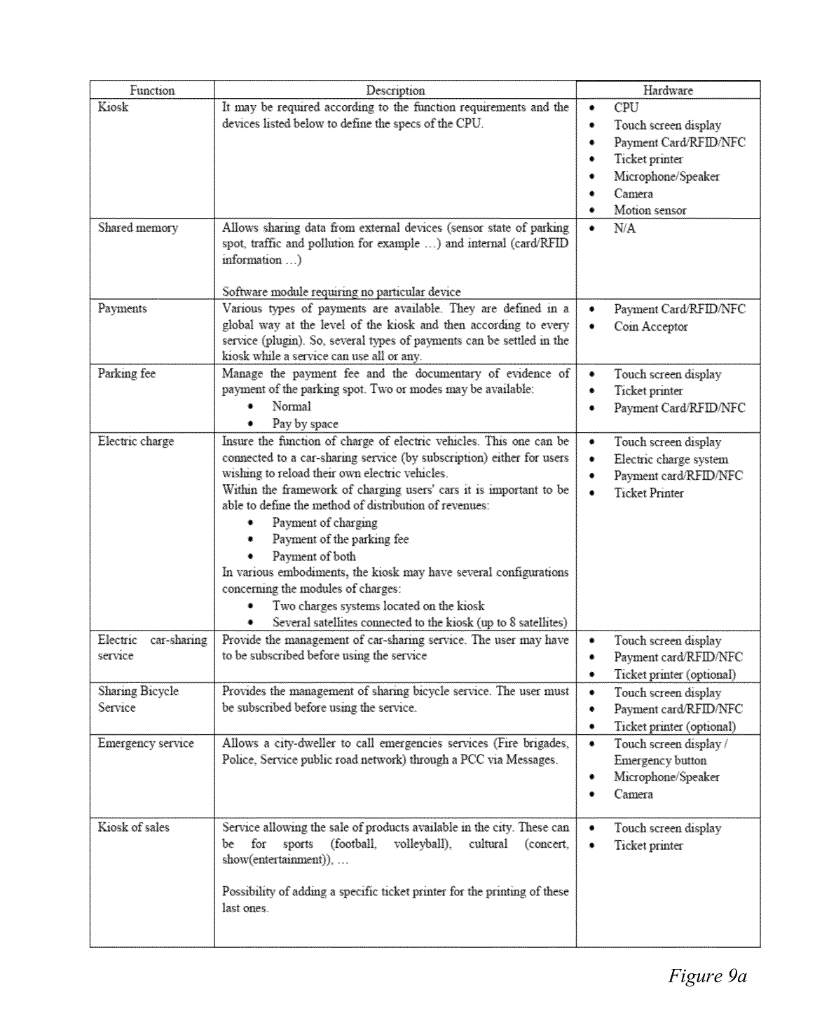

Next, some specific examples of hardware which can be used in a kiosk are described. These examples are provided for the purposes of illustration only and are not meant to be limiting. The kiosk can include one or more CPU's. When selecting a CPU one or more of the following constraints can be considered: a) size (smaller can be better), b) power of processing equivalent to a PC, c) connectors where numerous I/O formats, such as RS 232, RS 422, RS 485, USB, which allow a board to connect numerous devices may be desirable, d) network connectors, e.g. two Ethernet ports which can provide the connection to the information system and to a local area network may be desirable, e) multimedia capabilities, f) support of a hardware watchdog allowing the restart of the system in case of software problem, g) temperature/humidity sensitivity (deployed in an outdoor environment) and h) reliability. FIG. 10 shows an example specification of one embodiment of a CPU board.

A user interface, also referred to as the Human Machine Interface (HMI) is the system by which people (users) interact with a machine. Users can be customers and operation personnel. For a kiosk, the user interface can include hardware (physical) and software (logical) components. The user interface can be used for a) input, allowing the users to manipulate a system, b) output, allowing the system to indicate the effects of the users' manipulation, and/or c) combined Input/output such as a touch screen device. In one embodiment, the kiosk can include a display including a touch screen interface to provide input/out operations.

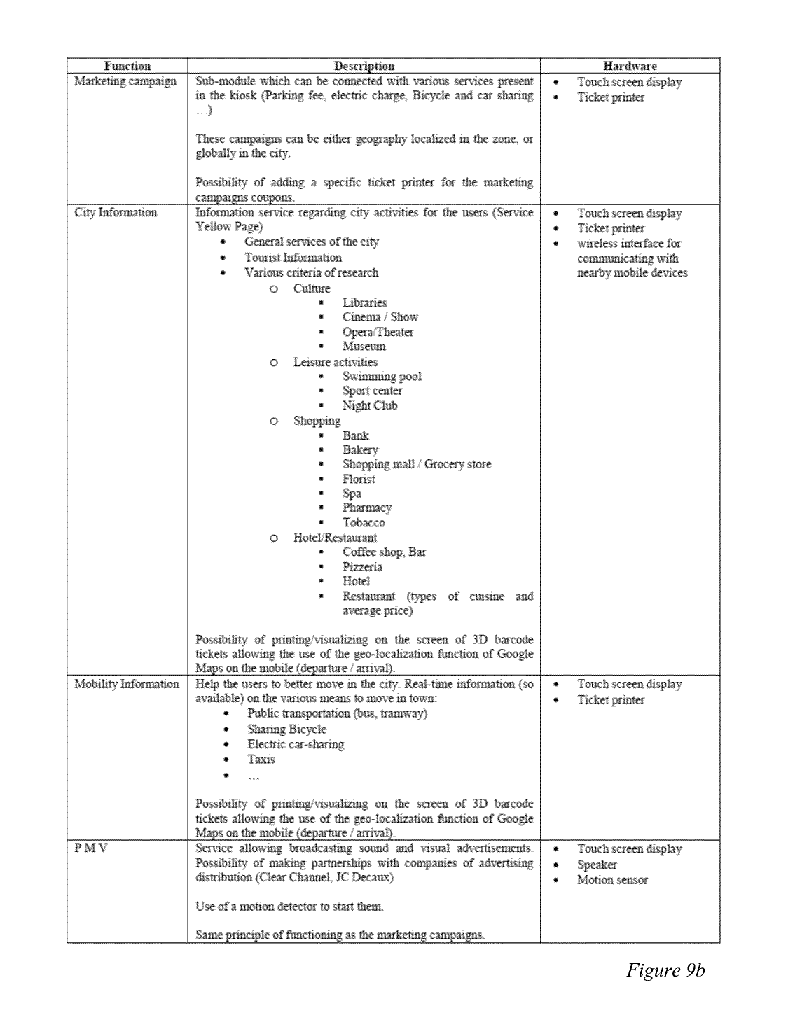

FIG. 11 shows specifications for a display and a touch screen interface for one embodiment of a kiosk. The display is 12.1 diagonal LED display. The touch screen interface used projected capacitive technology. Other display technologies (e.g., OLED) and touchscreen interface technologies can be utilized and these are provided for the purposes of illustration only.

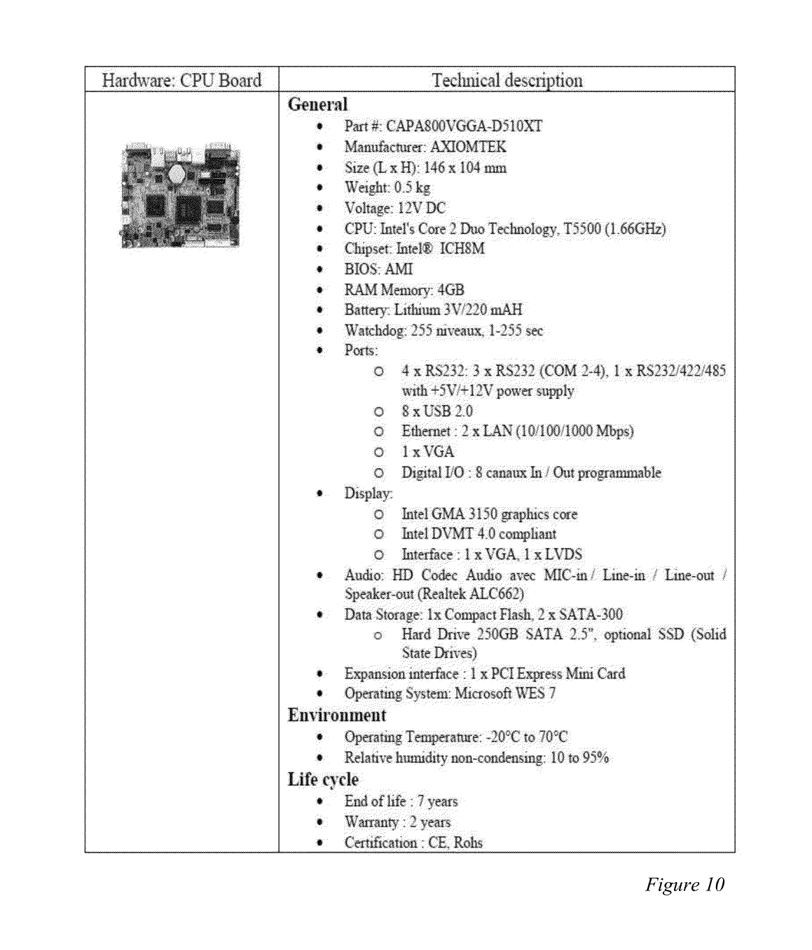

FIG. 12 shows a specification for a printer which can be used in a kiosk in accordance with the described embodiments. The ticket printer can be used to print documents, such as a receipt associated with payments for the various services as well as coupons associated with marketing campaigns. A printer may be selected for performance, reliability and maintenance costs and the ability to print text, bar codes as well as graphs. In one embodiment, a paper roll type printer can be used as shown in FIG. 12. On advantage of a paper roll ticket printers is that a large number of tickets can be printed before the paper roll needs to be replaced which reduces maintenance costs.

In one embodiment, the system can be configured to prioritize print jobs. In particular, the system can be configured to monitor the remaining paper in the paper roll. When the roll level is low, a maintenance event can be published. In addition, the system can be configured to prioritize print jobs such that some printing functions may not be carried out when the paper level is low. For example, when the paper level is low, the kiosk may stop printing paper coupons and reserve the remaining paper for receipts until the paper roll is replaced. In this instance, it may still be possible to dispense the coupons electronically but not via paper. Similarly, in the case of a paper jam or out of paper state, the kiosk can be configured to dispense receipts electronically.

Some services may require a printer, such as for a printed receipt. In the instances where the printer is malfunctioning, paper is not available or a paper jam has occurred, the system may be configure to suspend a service and publish an event of the suspended service until the printing functions are restored. Other services on the kiosk, which don't require a printer, can continue to be provided.

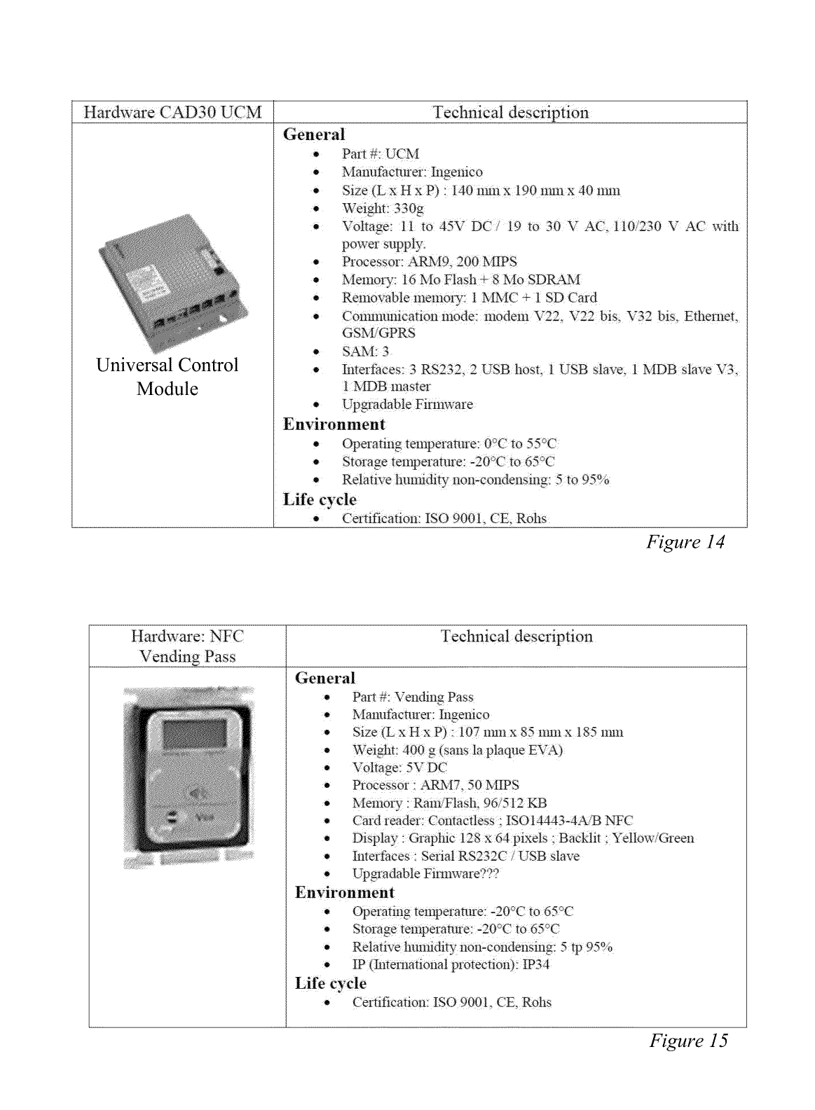

As shown in FIGS. 9A and 9B different services can use different combinations of devices. In the instance, in one embodiment, when a device used in a service becomes unavailable, the system may suspend service until the device is fixed and publish a message indicating the service has been suspended to the city message bus. In other embodiments, the system can be configured to use an alternate combination of devices if possible to provide the service. For example, if a service uses a keypad interface (see FIG. 16) and the keypad interface is malfunctioning, the kiosk can be configured to generate a keypad interface using the touch screen and the display to provide the service. The kiosk can publish on or more messages indicating the keypad interface is down and the service is being provided via an alternate configuration.

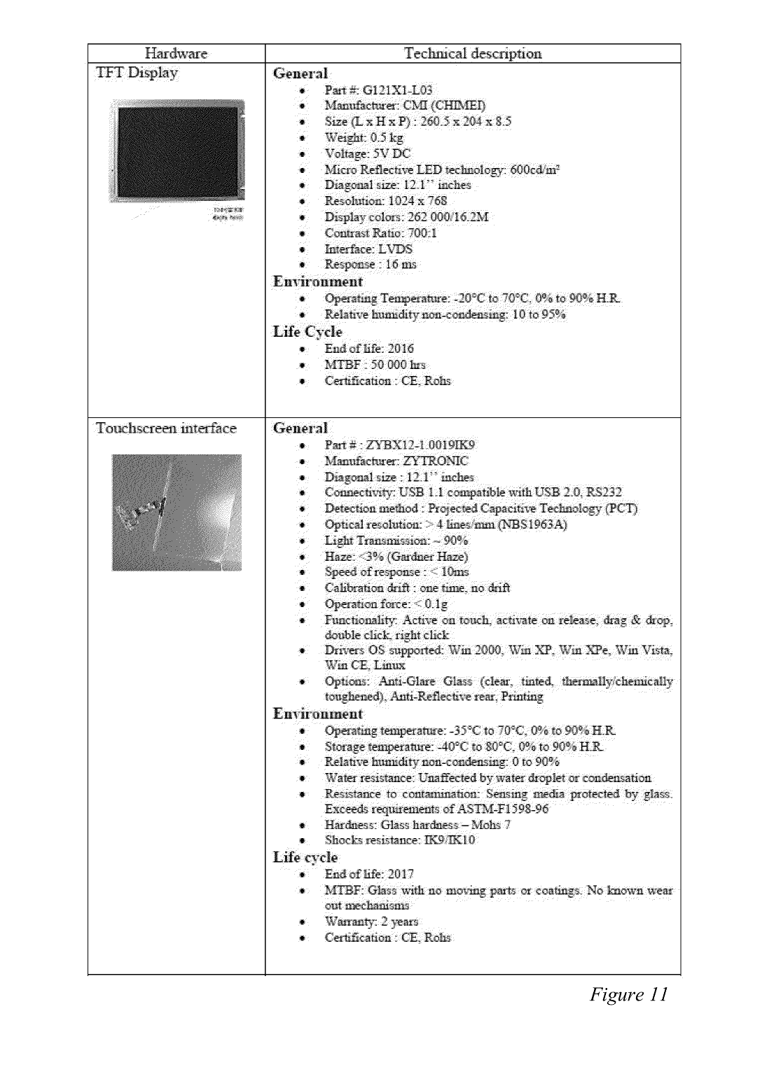

In another example, if a service uses a coin acceptor for payment (see FIG. 13) and the coin acceptor is malfunctioning, the kiosk can be configured to provide the service using other available payment methods, such as via card or NFC. A message indicating the coin acceptor is malfunctioning and that service is being provided without the coin acceptor can be published to the city message bus. Further, in the event of the coin acceptor malfunctions and the payment service being provided without the coin acceptor, like other published events, the event can also be logged on the kiosk.

A kiosk can accommodate various method of payment, such as but limited to combinations of the following: a) a coin acceptor, b) payment card (credit, debit), c) NFC <<vending pass>> and/or other mechanisms for initiating electronic payments using a mobile device, d) bill/ticket acceptors or e) combinations thereof. FIG. 13 shows specifications for a coin acceptor, escrow device and anti-pin system which can be used in a kiosk. The ES003 Anti Pin system can be used in conjunction with an electronic coin selector. The anti-pin unit can provide an extra level of security and deterrent to vandalism by preventing the acceptance of “foreign bodies,” such as paper. In addition, it can provide coin entry blocking for vending machines, in such instances as “sold out” or in response to other status reports which are generated by the controller.

The E101 escrow device provides a solution for pre-vend coin storage requirements. Any interruption of the vending process can result in all coins being rejected, reducing the likelihood of coin manipulation and attempts of money laundering. It can be used with battery, accumulator or solar power applications.

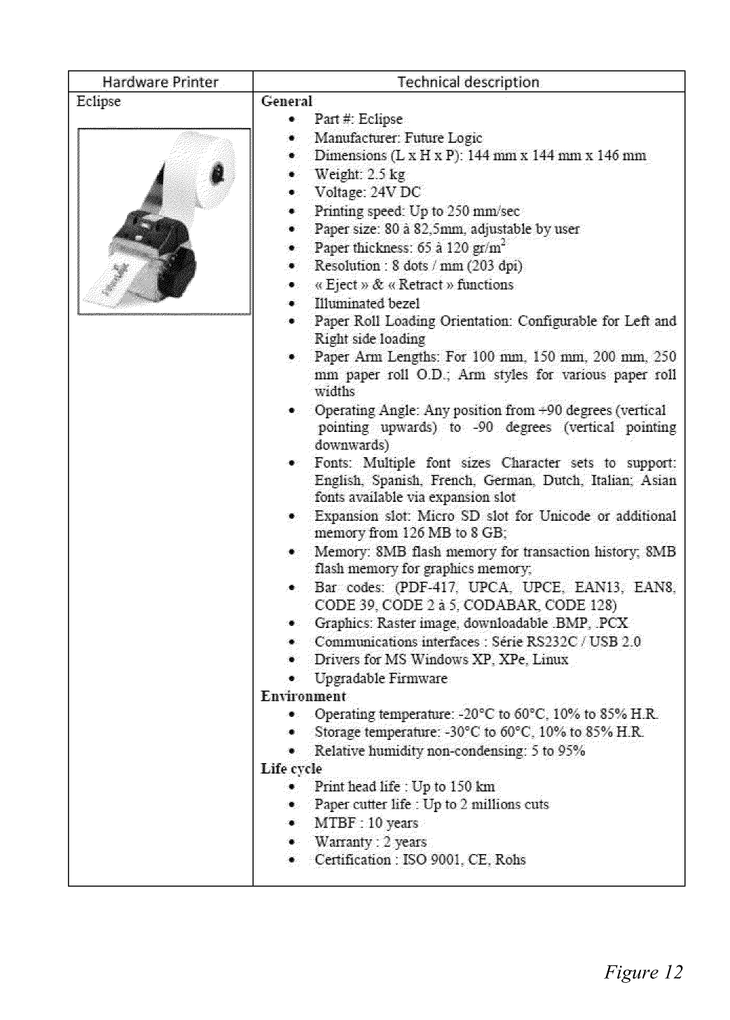

FIG. 14 shows a specification for a universal control module used to provide an unattended payment solution which can be used in a kiosk. Ingenico's CAD30 UCM universal controller module can be used for unattended payment solutions. Its integrated payment and teleprocessing modules support a host of applications including ticketing, parking systems, vending machines, kiosks and other self-pay applications.

The UCM can deliver cash and transaction checks, together with comprehensive monitoring capabilities that enable control and management of the installed base. It can be used in conjunction with a range of unattended payment peripherals, such as debit/credit card secure card readers, PCI PED approved PIN pad, contactless readers and back-lit graphic displays. In can enable an extensive range of payment schemes, including EMV, contact or contactless public or private e-purse, pre-paid card, NFC payment and mobile phone payments, as well as top-up and loyalty applications. It can work with a number of communication options, such as V32 fast modem, Ethernet or GPRS.

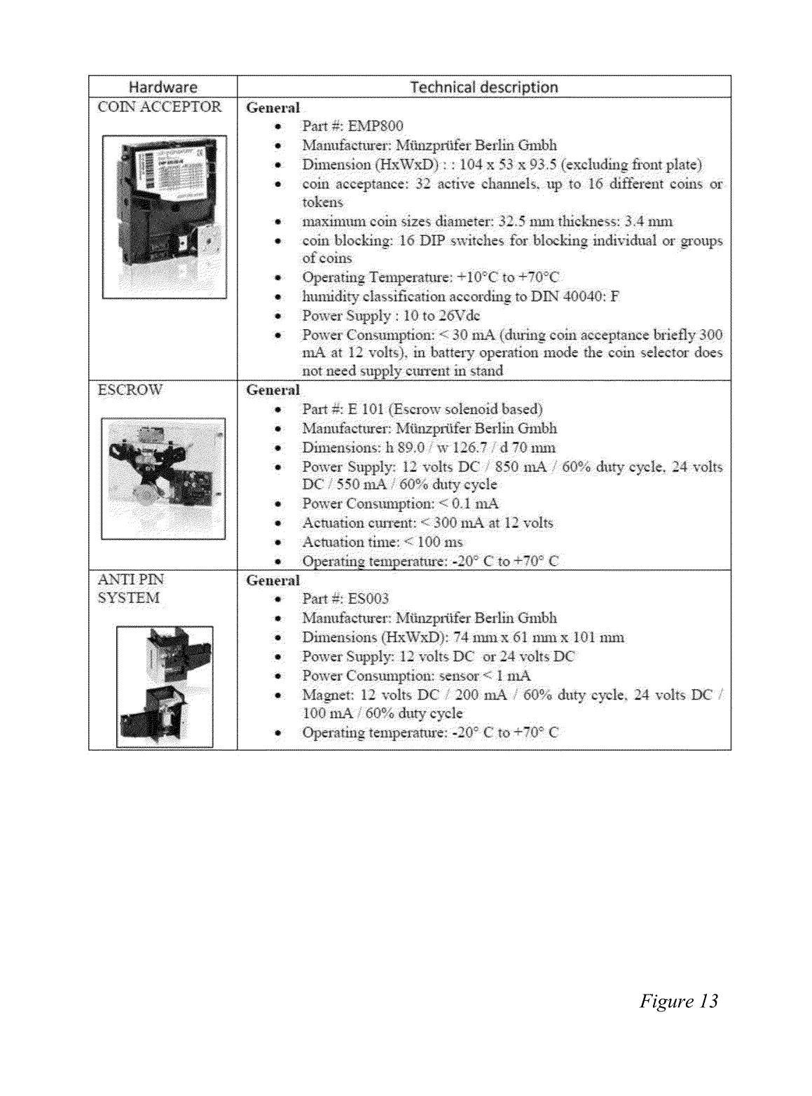

FIG. 15 shows a specification for an NFC vending pass which can be used in a kiosk. The Vending Pass contactless reader allow for cash-free payment functionality for unattended vending solutions. It is slim and can even be fixed to metallic front facings without any disruption to the electro-magnetic field. Supporting EMV contactless payment, customers simply tap their card or pass their NFC-enabled mobile phone in front of the reader. It is both MasterCard PayPass™ and Visa payWave™ certified and supports all EMV contactless cards in accordance with international regulations.

FIG. 16 shows specifications for a card reader and a keypad interface device which can be used in a kiosk. The card reader and keypad interface device can be coupled to the UCM described above. The card reader can read and interface with magnetic striped cards and smart cards. The keypad can be used to enter a PIN and includes a display.

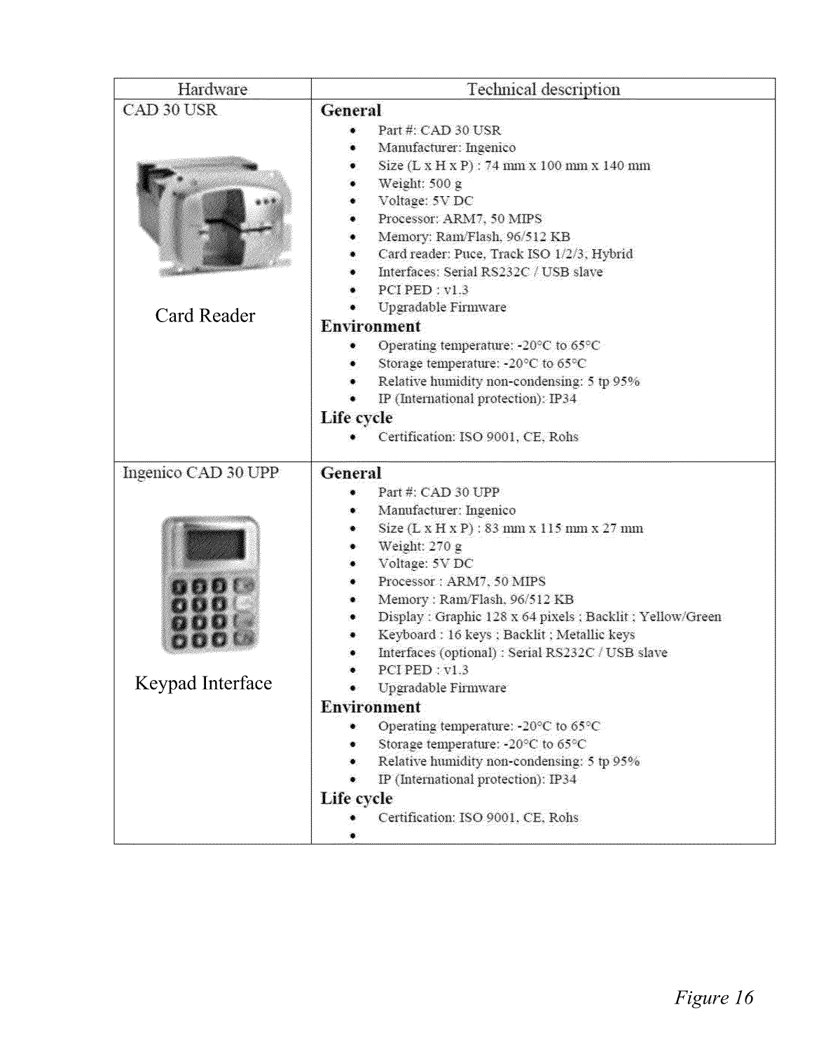

FIG. 17 shows specifications for a speaker and camera which can be used in a kiosk. In addition, the kiosk can utilize a microphone and a motion sensor. The speaker and microphone can be used for remote communications, such as with an operator during an emergency. The camera and microphone can be used for security purposes as well as assessing an emergency situation. In one embodiment, the camera and/or microphone can run continuously where all or some portion of the video and audio data can be stored locally and/or uploaded to a remote device. In another embodiment, the camera and/or microphone can be activated in response to activation of the motion sensor or a detection of activity on the kiosk. The motion sensor can also be used to trigger events on the kiosk and/or a satellite display, such as causing the kiosk to output video and/or audio content.

### Mobile Applications for Providing City Services

Next, mobile applications which utilize data gathered from the sensor network are described. In a particular, a city passport application associated with helping a user park, move around a city and receive general information a city is described. One objective of the city passport mobile application is to become the users' mobility portal in the city. The city passport application can be made available on various smartphones and tablet platforms available on the market, such as but not limited to: Apple™ (iPhone/iPad and iOS), Android, Windows Mobile, and RIM Blackberry. It can include content in different languages in order to provide help and support for tourist. Main languages that can be supported include but are not limited to English, French, German, Italian, Russian, Spanish, Japanese and Chinese.

As described above, the passport application can include a set of features for allowing users to park and move efficiently in a city. Further, it can help a user get information regarding city, activities. In one embodiment, the city passport application may have three modules: 1) EzPark—a module for helping users find the best way to park their vehicles in the city, EzMove—a module helping users to move inside the city and EzCity—a module providing general information of the city.

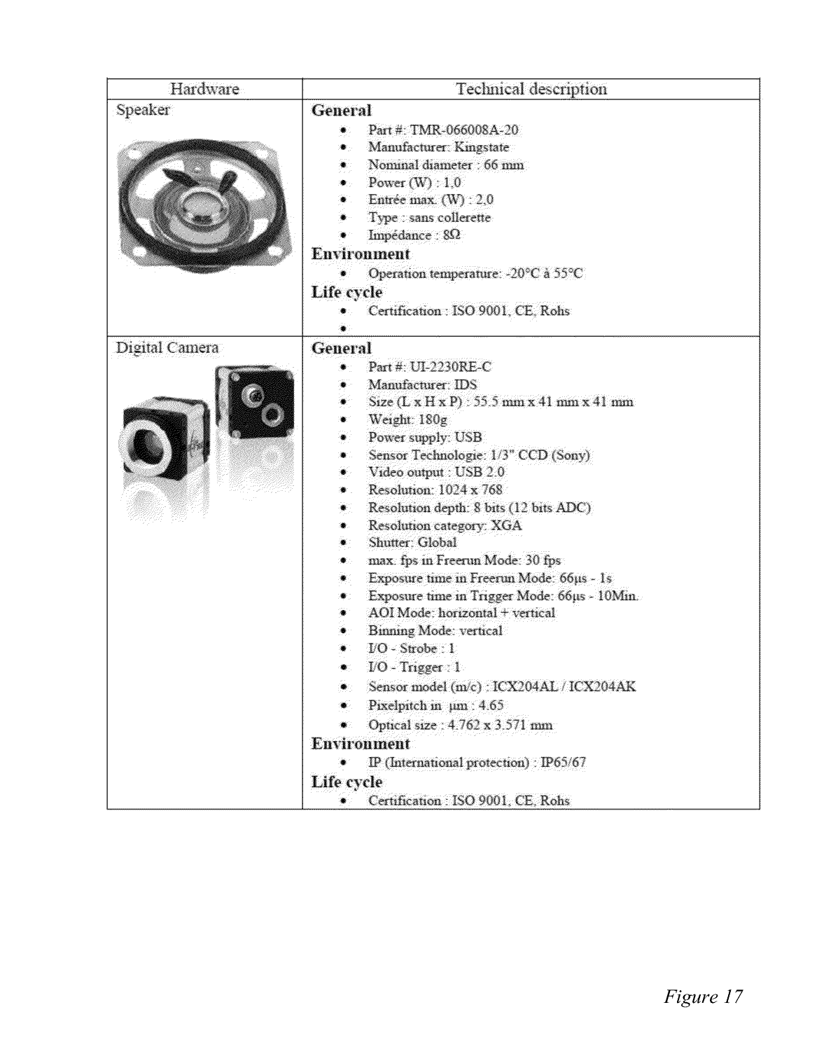

FIG. 18 shows a few initial display screens 300 associated with a mobile application executed and output to a mobile device 302. The mobile application may have been downloaded to the device from an application store. In one embodiment, the application may be downloaded via an interaction one of the kiosks described above.

The application can be used with a touch screen device, such as 302, and be configured to accept touch inputs. It can also be configured to work with a voice interface and accept voice commands or use other input mechanisms associated with a device, such as but not limited to a camera, finger printer sensor, tilt sensor or movement sensor.

Button 304 can be selected to configure parameters for the three modules. The configuration options are described in the specific sections related to each module. To access a particular module, the user clicks on the module button he wants to access, such as 306, 308 and 310 on the home screen. More or less modules can be used and this example is provided for the purposes of illustration on

The EzPark module, accessed via a selection of button 310, can help users to find the best way to park their vehicles when going to into an urban area. The parking module can provide parking solutions for different parking venues, such as but not limited to on street parking (unmarked spots), parking garages (marked spots) and parking relay lots (e.g., commuter lots) installed in the suburbs of the city. The commuter lots can be connected with public transportation in order to facilitate user's movement into the city.

Additional services that can be provided on this module can include but are not limited to 1) traffic information-providing information regarding traffic inside the city and alert regarding car park rules, 2) promotional parking-providing geo-localized coupons based on car parking and 3) PayByPhone-using mobile wallet applications. In one embodiment, the parking module can enable users to pay by phone for on street parking.

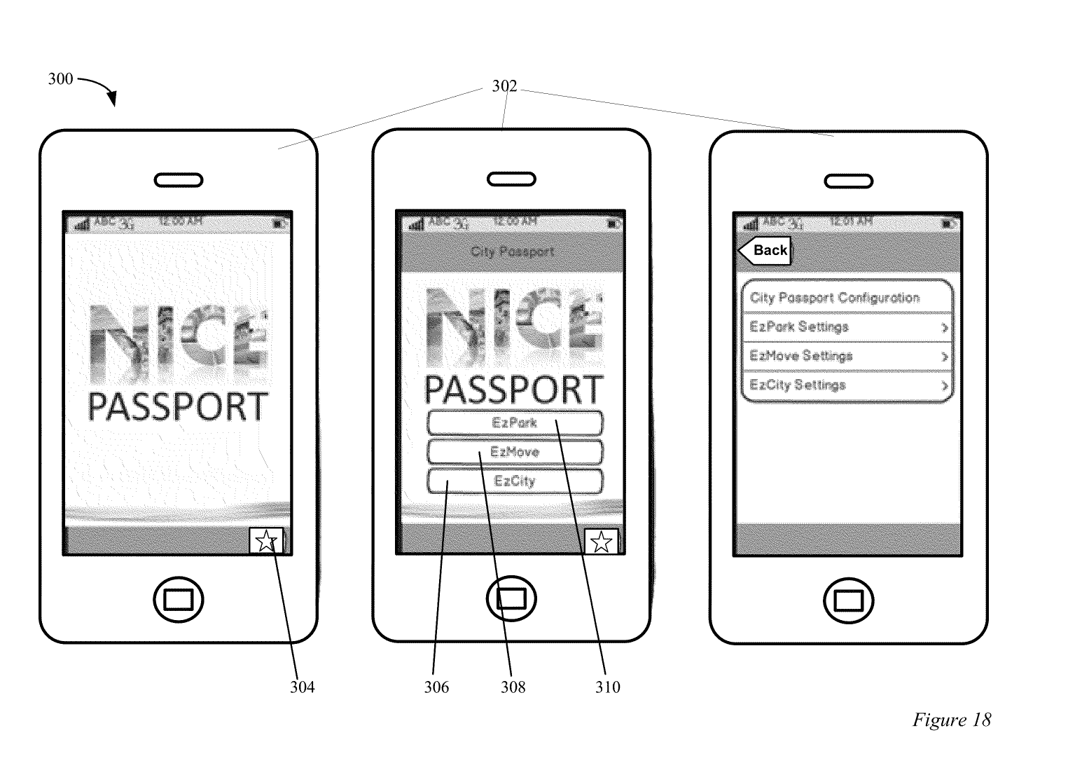

FIG. 19 shows example display screens 312 indicating settings associated with a mobile application executed and output to a mobile device. The settings can allow the user to selection options that allow available information that can be obtained and displayed on the device, such as configuring parking spot availability parameters, parking garage availability parameters and park and ride availability.

Some filters related to on-street parking that can be selected to filter parking information that may be displayed or not displayed can include but are not limited to a) Free (optional if sensors are deployed on Free parking spot), b) payable, c) parking rate thresholds (e.g., above or below some hourly rate, d) resident (sub-category of payable parking spot), e) Handicap, f) electric charge (charge station at spot), g) Kiss & Fly (passenger drop off), h) delivery and i) maximum time (e.g., one or more of V2 hours, 2 hours, 4 hours, overnight, etc.). Each type of on street parking spot, parking garage, park and ride can have its own marker (icon/color) on a mapping application, such as Google Maps™, for identification. In one embodiment, the user can specify how long that they need parking, which can be used to filter available parking options.

Additional options can include routing guidance and traffic information. In addition, the user may be able to define default priority of parking rules for the user (cheapest, nearest, etc.). For example, parking on street, which is less expensive and closer to final destination, can be the first priority, parking in the garage, which can be more expensive but closer to final destination can be the second priority, and park and ride, can be the third priority. Another option can alert notifications, such as alerts concerning traffic, parking rules changes (pollution, traffic . . . ), etc. The alerts can be managed by the application, not by the phone, in order to send alerts only when the application is in use.

Yet another option can be “pay by phone,” which enables pay by phone functions. A further option can be a car park alert notification which allows users to be notified ‘x’ minutes before the end of the parking duration. An additional feature can be “promopark” which allows the user to obtain parking promotions. In one embodiment, this feature may only be available if the pay by phone option is enabled (by default, it can be managed by a local kiosk).

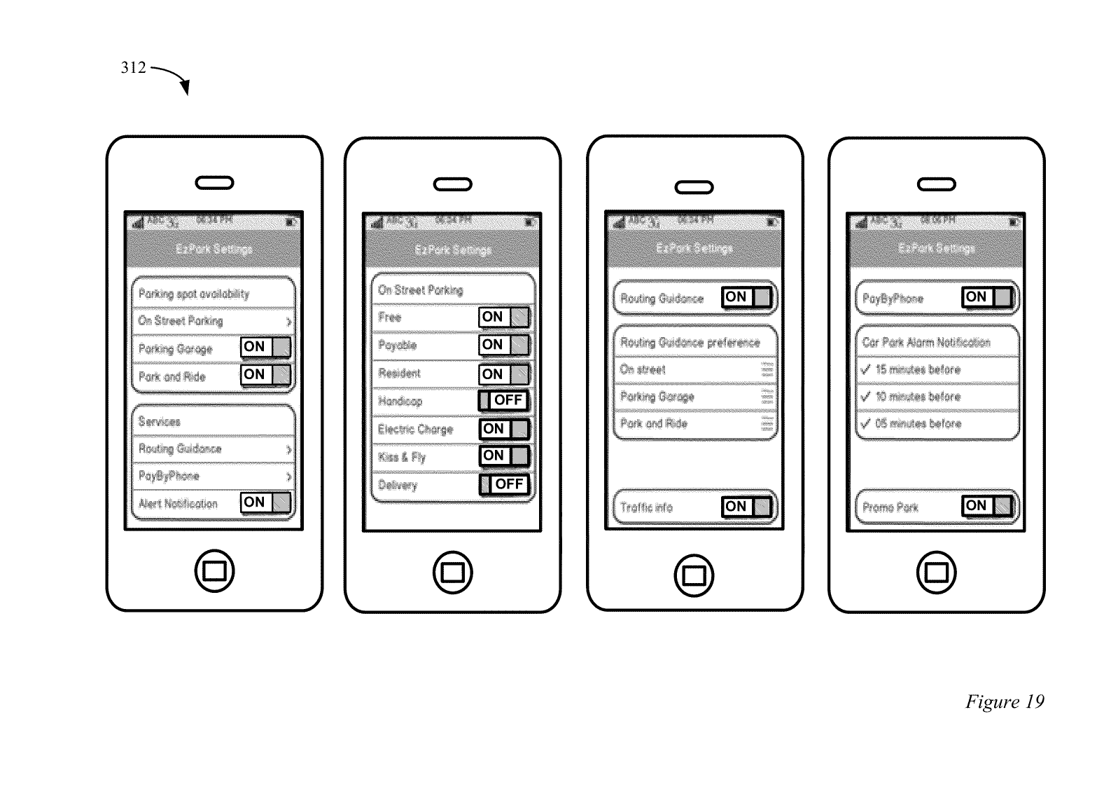

FIG. 20 shows an example display screen 320 for a parking module in a mobile application executed and output to a mobile device. Different information is displayed on the display (on street parking, parking garage, park and ride, traffic information . . . ) according the configuration defined on the parking module setting screen (e.g., see FIG. 19). Different functionalities described below are available on this screen: a) a selection of button 322 causes a return to the main screen of the mobile application (e.g., see FIG. 18) and b) a selection of the button 324 causes the data displayed on map to be refreshed. Depending on the position of the vehicle (the position can be determined using GPS capability of the mobile device and/or wireless data, such as cellular or Wi-Fi data), the application refreshes data automatically at different rates. For example, data can be refreshed every five minutes when the car is far from a selected destination, such as over three km, every thirty seconds when the car is near the destination, such as less than three km and in real-time, as data is available, when the user is actively seeking parking close to the indicated destination.

A selection of button 326 allows for destination selection and configuring of how the parking module will work during the trip. The slider 328 shows an average time necessary to find a parking spot (for the default type) at the selected destination. In one embodiment, a user can use the slider 328 to change the parking spot type.

A central system can be configured to determine the average time necessary to find a spot. In one embodiment, a time to find parking can be determined based upon a time when the user reaches some distance from the first parking spot that satisfies a specified criteria selected by the user and when the user purchases parking. Multiple parking spots can be available at the selected destination.

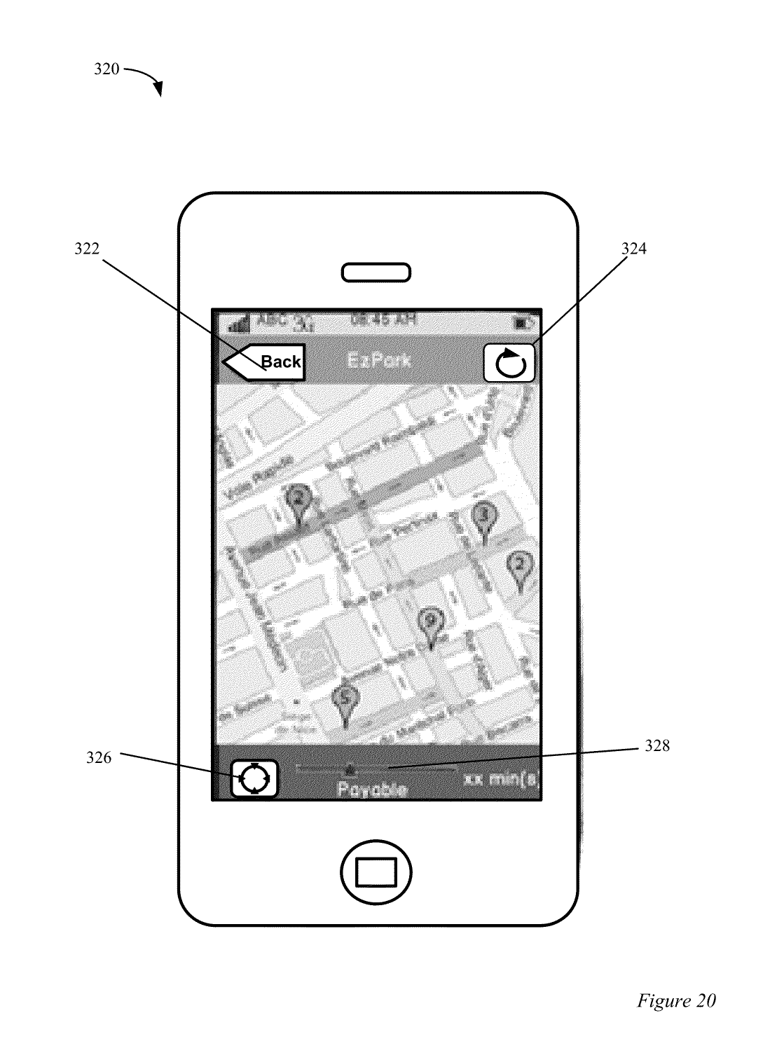

When the user clicks on button 324, trip configuration screens can be displayed in the mobile application. FIG. 21 shows example display screens 330 associated with trip configuration for a parking module in a mobile application executed and output to a mobile device in accordance with the described embodiments. When the user selects destination address such as by clicking on button 332, the destination screen 338 can be displayed.

The parking module may allow a user to select the mode of search (e.g., address, public places and public transportation stops). Then, the user can focus the search by inputting characters. The parking module can automatically search for the matching string(s) from a list. If the user selects the desired destination (If address is the selected mode, the application can ask for the number of the street) and the application can automatically return to the “Trip setting” screen. Area 334 can be configured to allow a user to select type of on street parking used for this trip (e.g., a check by one or more of free, resident, payable, electric charge and kiss and fly) with a sorted by preference option 336.

The parking module can be configured to access a database that includes lists of streets, public places and public transportation stops that are available in the mobile application. Various lists can be generated for different destinations. In the examples described herein, a list of locations for NICE France has been assembled and is utilized.

Once the destination is configured, the system can be configured to update information displayed on the map portion of the application. As described above, the application can be configured to provide updates that become more frequent when the user gets closer to its destination. For that purpose, the application may use the GPS functions embedded on the phone to determination the mobile devices locations or other methods if available, such as estimating distances from multiple cellphone towers or wireless access points to pinpoint the device locations.

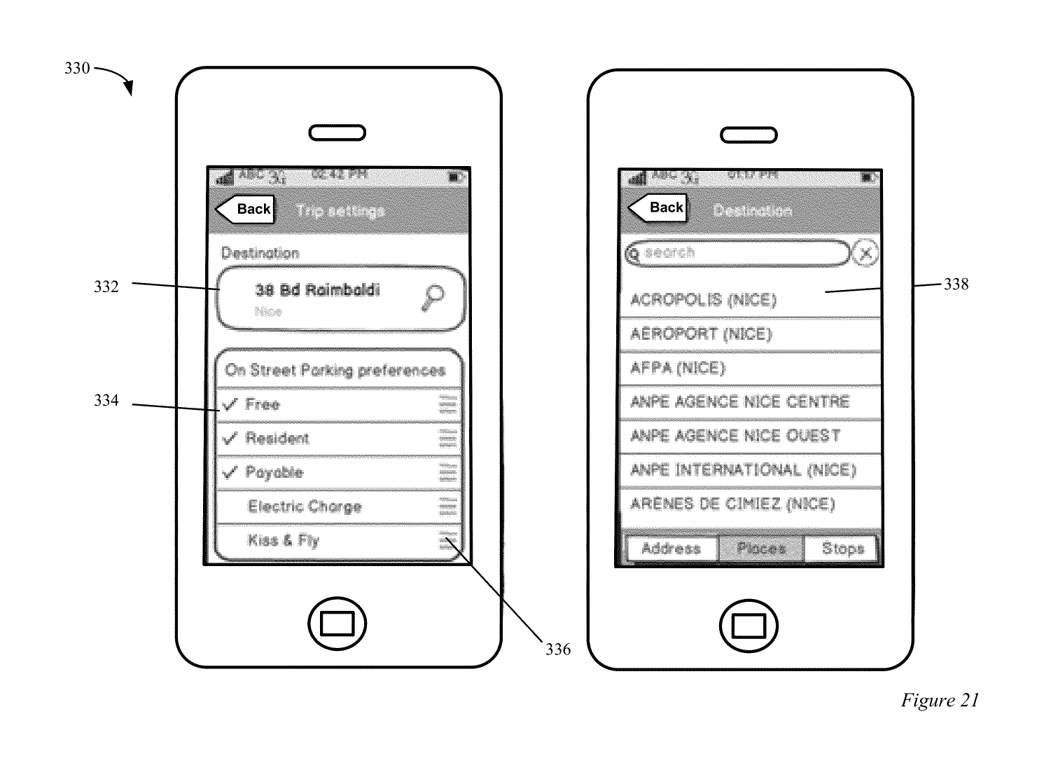

FIG. 22 shows example display screens 340 associated with marker details for a parking module in a mobile application executed and output to a mobile device. Depending on the type of information displayed based upon on the selected settings (e.g., on street parking, parking garage, park and ride, traffic information . . . ), extra information may be available by clicking on a chosen marker or providing a voice command. Information about each location can also be output in an audio format in response to voice queries by the user.

As an example, details of a marker associated with parking garage availability can include but are not limited to a) a parking garage name, b) address and phone number, c) number of spots available, d) number of handicap spots available, e) electric charge spots available and pricing (e.g., hourly rates). In one embodiment, the spots available can be determined from sensor data available to the system. Thus, the number of spots available may change over time. In another embodiment, the number of spots available can be just a total number available at the garage without any indication of how many are currently unoccupied. As another example, details of a marker associated with a park and ride can include but are not limited to parking garage name, number of spots available, number of handicap spots available, electric charge sports available and a price rate.

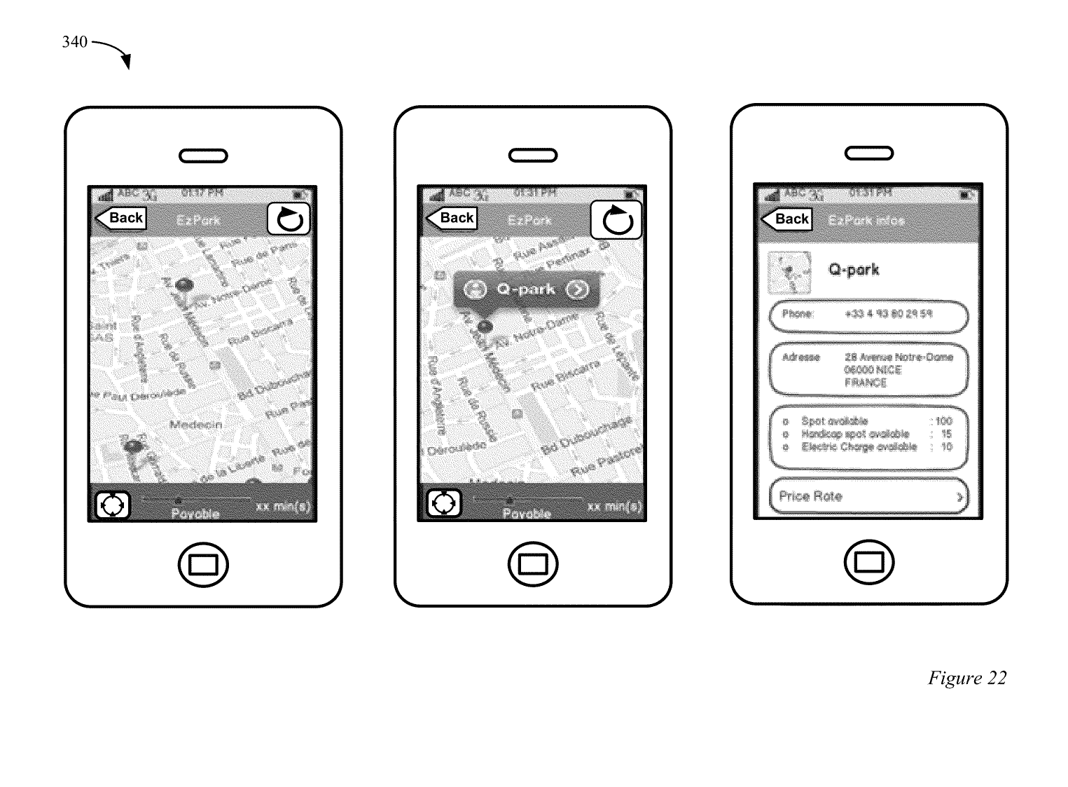

FIG. 23 shows an example display screen 345 associated with routing guidance for a parking module in a mobile application executed and output to a mobile device. The routing guide portion of the parking module can be configured to send notifications to help users to make decisions associated with parking vehicles based on the preference configured on parking module settings >routing guide >routing guide preference. Two example scenarios are as follows.

In a first example, a first preference selected is on street parking. If the waiting time to get a parking spot is 10 min or more (in general, exceeds some threshold value which can be user configurable) then the system can be configured to notify to go to “parking garage” or “park and ride” depending the preferences selected by the user or the default settings. Routing guide alert 346 shows such a notice. In a second example, a first preference selected is “parking garage” or “park and ride”. The system notifies the closest available parking spot to the final destination. This notification can change depending availability updates that occur as the user is traveling to their destination, such as spots available in the parking garage or at the park and ride.

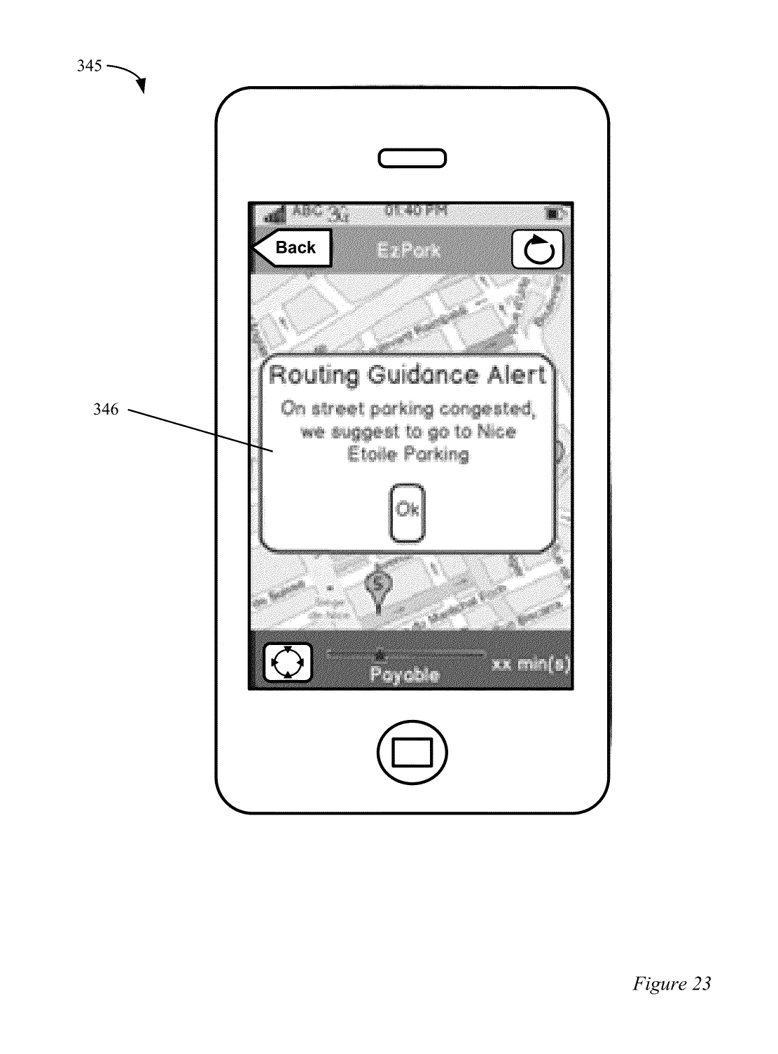

FIG. 24 shows an example display screen 350 associated with traffic alerts, such as 352, for a parking module including example notifications 354. In order to help users to navigate within the city to their final destination, the parking module can be configured to provide various alerts regarding traffic. Examples of alerts can be generated from one or more of a) information coming directly from sensors (traffic, pollution, . . . ), b) information input manually by municipal agents, c) generated by the complex event processing from different inputs (traffic, pollution, Parking spot occupancy, . . . ) received over the city message bus, d) crowd sourced from system users providing traffic information, such as information about accident and e) based upon location information from devices travelling to their destinations (e.g., speed of devices can be estimated from GPS data to determine traffic conditions. In one embodiment, the parking module can be configured to receive inputs indicating an accident or some other traffic related event at a location including verifying the accuracy of the information, such as a false report or the accident has been cleared.

In particular embodiments, the system can be configured to provide incentives to users to provide location information whether they are actively using the application or not. The location information can be provided from an application running in the background. The changes in position of a device so enabled can be used to determine local traffic conditions.

In one embodiment, a loyalty program can be associated with the application where a user can earn points that are redeemed for rewards, such as discounted parking. One incentive for a user to allow its device to report its location for tracking purposes, such as traffic tracking, can be a reward of loyalty points in the rewards program. The loyalty points can be redeemable for awards, such as reduced parking fees. When a user's device is tracked, the system can be configured to provide location specific information, such as advertising for merchants in an area proximate to the device. The application can include an option, such as a slider switch, that allows this feature to be enabled or disabled.

Traffic notifications can be sent out from a central system via publication services depending pre-defined rules setup on the system. A publication service, which uses DDS, is described in more detail below. The central system can be monitoring the trips of many different users and can provide appropriate alerts based upon local conditions associated with each user, such as conditions approximate to their current locations. In addition, the system can provide alerts on conditions that a user is likely to encounter based upon their selected final destination and/or their current location.

Alerts can be initiated when the user is within some threshold distance, such as in a radius of five km of their destination. To gain an overview of traffic, user may be able to consult traffic information directly on the map. Alerts can be generated via publication services. A few different types of notification 354 are shown in FIG. 24.

The “Pay by Phone” feature allows user to pay for parking and other transportation services with their mobile device, such as parking, renting bikes, charging their car, etc. Two examples of parking payment options that may be available include payment of time spent and ticket machine mode. In payment of time spent, to encourage payment by phone, a user is only charged for the time spent on the parking spot. In this embodiment, the system is configured to determine when a parking spot is occupied and then subsequently vacated and then charge accordingly. For example, sensors can be used to determine when a spot is occupied and then subsequently vacated. In ticket machine mode (traditional), a user has to choose the duration of stay and pay accordingly. The use of the different functions can be decided by the city/operator in charge of managing on-street parking, such as whether payment by phone is available and whether the billing for the time occupied is only available.

In one embodiment a micro-payment platform can be utilized for mobile payments when an NFC terminal (or related technology such as Bluetooth) is not available since no NFC solution is currently available to pay with a mobile without NFC terminal. In one embodiment, an NFC terminal can be made available in a kiosk that provides parking payment services. In this case, an NFC solution can be utilized to enable mobile payments.

Several Micro-Payment platform solutions are available on the market. To reduce commissions that can be associated with micro-payment services (up to 15%), an electronic purse which the user can reload by Internet or from his mobile device, can be utilized. The pay by phone portion of the application can be configured to debit automatically the amount of a transaction for parking from this account. One advantage of this solution is that a generic mobile application can be configured to work in a large number of countries throughout world.

A few technologies that can be used to credit the electronic purse are PayPal, Buyster and 3-D Secure. PayPal is an e-commerce business allowing payments and money transfers to be made through the Internet. Online money transfers serve as electronic alternatives to paying with traditional paper methods, such as checks and money orders. A PayPal account can be funded with an electronic debit from a bank account or by a credit card. The Authority of prudential control of the Bank of France has designated Buyster for the establishment of payments. This approval allows Buyster to acquire and to execute orders of payment for e-business, in accordance with the current regulatory framework in France. 3-D Secure is an XML-based protocol used as an added layer of security for online credit and debit card transactions. It was developed by Visa to improve the security of Internet payments and offered to customers as the Verified by Visa service. Services based on the protocol have also been adopted by MasterCard, under the name MasterCard SecureCode.

The implementation of a management of account can require the implementation of a secure server. The users can have the option of reaching their account via Internet or their mobile phone for such functions, as displaying balances of their account, displaying the list of the transactions made for given period and transferring money towards the account or re-transfer it towards their bank account.

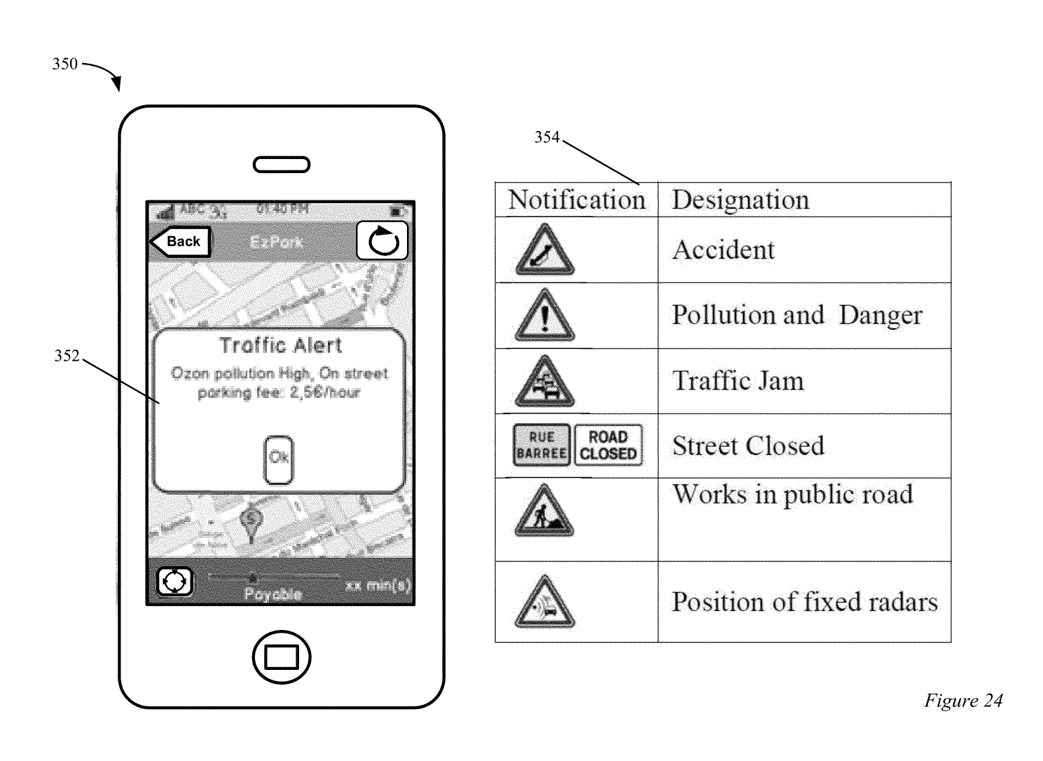

FIG. 25 shows example display screens 355 associated with pay by phone option for only the time the parking spot is occupied. An example of a method for paying for time spent can be as follows. In this mode, the user can follow all or a portion of the steps as below and in a different order than listed below. First, a user can select the desired type of parking spot. Resident mode may be available only if the user is subscribed for resident card and parks on the zone of his residency. Second, the parking module can be configured to can show parking rules associated with spot (minimum and maximum duration of stay, price rate). The rules can vary depending on whether the user is a resident or not or in some other defined category, such as handicapped.

Third, a user can input the plate number of his vehicle (In one embodiment, the module can keep this information available for future usage). Fourth, a user can input the Parking spot number. One can input it manually or use geo-localization feature in order to select from a built-in list. In each case if user inputs it manually, the module can verify the entered location using available location information, such as available from GPS information. Thus, the user's device may have to be within some distance threshold of the spot for which parking is being purchased.

Fifth, if “promo park” is enabled, a user can select and/or input a promo code if they have received a promotion previously. The promotion code can reduce the price of parking which charged. Sixth, a user starts the time clock or it starts automatically once the parking purchase has been verified. The verification of the parking purchase can require that the user has sufficient funds to purchase some minimum amount of parking, such as 15 minutes, an hour, the maximum time allowed at a particular spot, etc.

Seventh, if the promo park service is enabled, the system may provide promotions that are localized to the area where the vehicle is parked. These promotions may have been defined as part of a marketing campaign previously described. Eighth, if the user leaves the parking spot before the maximum time limit, the application may require the user to click on the stop button in order to stop the accumulation payment. Thus, allowing the user to pay for only time spent. In one embodiment, whether the user has left the spot can be verified via nearby sensor of some type, such as an embedded parking sensor or camera.

When the maximum time is almost over, the mobile application can be configured to notify the user that the maximum time will be reached in ‘x’ minutes. The alert can involve the use of a display, an audio device, a vibration device and/or combinations thereof. The maximum time can be the time which a user has purchased.

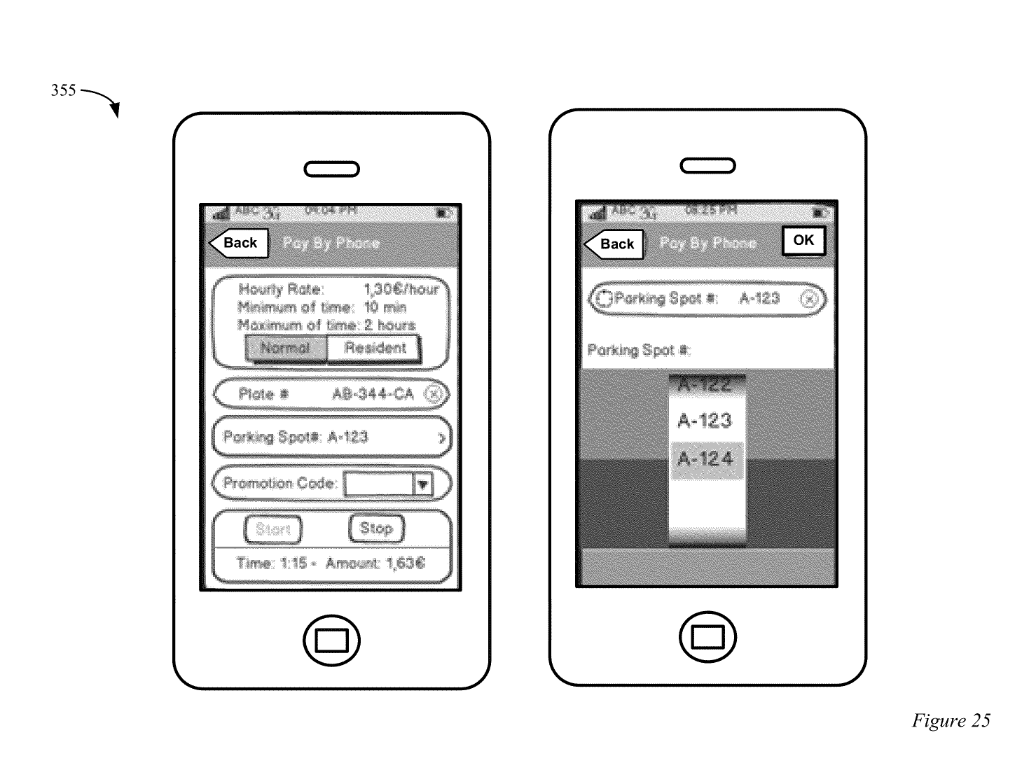

FIG. 26 shows example display screens 360 associated with pay by phone option for purchasing a pre-selected amount of parking. In this mode, the user can follow all or a portion of the steps as follows. First, a user can select the desired type of parking spot. Resident mode may be available only if the user is subscribed for resident card and parks within the zone of his residency. Thus, the module can be configured to compare a location associated with the parking spot with location associated with a residence of the user. Verifying a user's residence may require input from the user.

If the resident mode is not available, the resident option may not be displayed, the application may not allow its selection or may query the user for additional information. For instance, the application might ask the user for additional information associated with a resident card. In one embodiment, the use of a resident card can require a user to register particular vehicles. If the license plate number is not consistent with the vehicles associated with the resident card, then the system may not allow permit the user to access the resident mode.

In alternate embodiment, a car share mode can be provided. In the car share mode, a user might be offered special rates for sharing a car. Further, in a car share, when a user is finished using the car, they may desire to leave it at a particular location. Then, another user can access the car from this location. Special rules can be provided for car shares, such as allowing the car to stay at a location longer than other types of cars. Further, parking payment can be the responsibility of the entity providing the car share as opposed to the user.

Second, the module can display rules associated with the parking purchase (minimum and maximum duration of stay, price rate, etc.) Third, a user can input the plate number of a vehicle or other identifier, such as all or a portion of the vehicle identification number (by default the application can be configured to keep this information available for future usage including multiple vehicles if the user owns/shares multiple vehicles).

Fourth, a user can input the parking spot number or some other identifier associated with the spot. The spot number can input it manually or use geo-localization feature in order to select from an obtained list of nearby parking spots. As described above, the system can display nearby spots which are determined to be unoccupied or have been recently vacated. If the user inputs the spot number manually, the application can verify using GPS tools whether the input spot is actually near the determined location of the user. If the spot number is a valid spot number but determined not to be near the user, then the system can request the user to reenter the spot number.

Fifth, a user can select the anticipated duration needed to stay in the car park and the module can calculate the amount to be paid. If “Promo Park” is enabled, a user can select a promo code if a promotion has been previously received. In one embodiment, the anticipated duration can be in fixed increments, such as 15 minutes, ½ hours, 1 hour etc. In other embodiments, the user may be able to select an exact increment, such as 37 minutes or 63 minutes, up to the maximum allowable time.

Sixth, when the parking configuration is done, the user can click on the pay button to initiate processing of the transaction. The application can notify the user whether the transaction was successfully processed and provide a transaction receipt. The transaction receipt can be an electronic receipt which can be displayed on the users' mobile device.

Seventh, when the promo park service is enabled, the system may provide promotion information localized on the area where the car is parked. The steps don't necessarily have to be performed in the order listed above. For example, the user can enter their parking spot number before their plate number. When the time is almost over, the App can be configured to notify the user; a choice to extend to the limit if no maximum time was chosen.

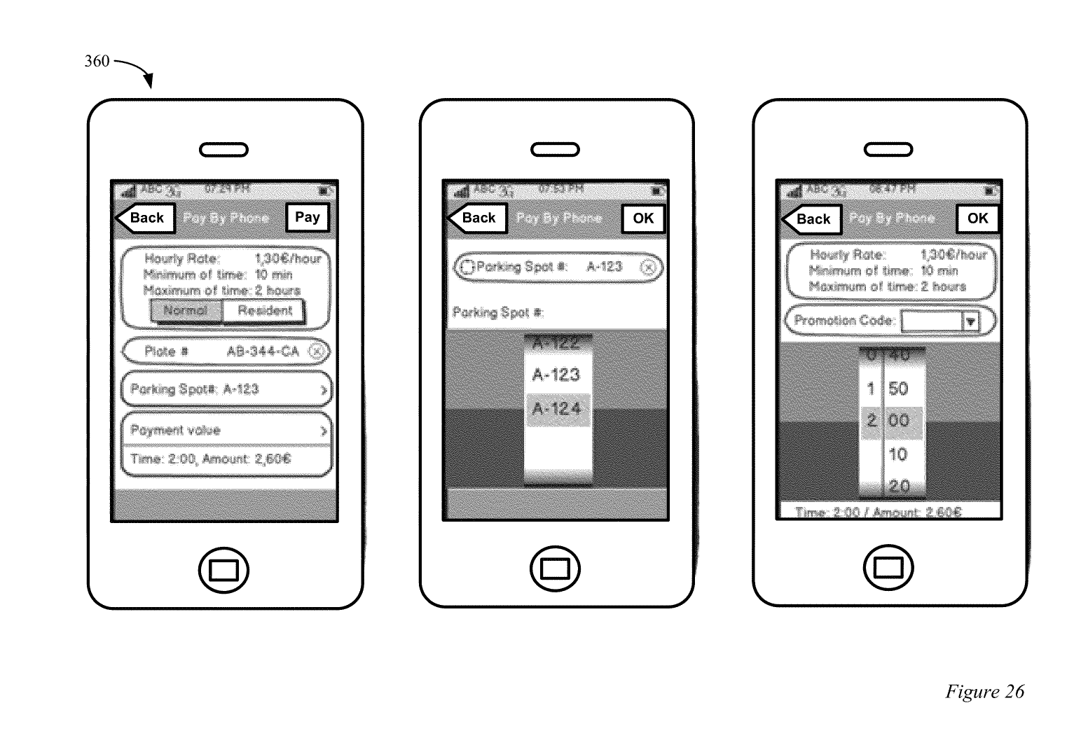

FIG. 27 shows an example display screen 365 on a mobile device associated with a geo-localized promotional offer in accordance with the described embodiments. The “Promo Park” feature of the application can provide promotional offers based upon nearness and/or time (other parameters are possible, such as offers personalized for a particular user). As examples, the advertising/offers can be in the form of electronic voucher in connection with one or more of: i) a discount on services provided on a street network (electric charge, car-sharing and sharing bike, parking fee . . . ) ii) businesses situated near where a purchase of a service was made (or even remote business, such as Internet businesses or businesses situated in another part of the city), iii) institutional brands sponsoring local events, iv) marketing actions managed by local authorities (city, community of municipality/metropolis, department, region), v) offers personalized to a particular user based upon information known about the user, such as gender, age, residence, type of car, previous purchases made etc., and v) combinations thereof. In one embodiment, the marketing applications can include public services announcements.

The application may allow a user to enable all or a portion of these features via an adjustment of setting in the application. For example, the user may opt to receive only offers related to discount on services and nearby businesses but not marketing actions managed by local authorities or institutional brands. In another embodiment, the user can receive information related to all of these categories. In yet another embodiment, none of the categories may be enabled.

Promo Park mechanism can be initiated automatically by the application if promo park feature is enabled. Some steps are one or more of the following. First, the application can send a request to the marketing campaign service to check if the user is eligible for a promotion. As described above, the marking campaign service may be providing one or more active marking campaigns. The request can include categories that a user has enabled, such as promotions related to local businesses and promotions related to local services, such as car charging. Second, based on criteria defined on the marketing campaign service, the service can send a positive or a negative answer. A positive answer can include information needed to generate an electronic voucher for the offer. As described above, at a kiosk or some other device enabled with a printer, these vouchers can be printed to a printing media, such as pap

Promotional coupons, such as 366, may include optically formatted image data, such as 368. The image data 368 is a Flashcode's barcode which allows follow-up to ensure validity of the coupon. Flashcode is the brand of the 2D bar codes developed by the French Association of mobile multimedia. These pictograms consist of patterned squares and can be decoded in particular by mobile phones having the Flashcode reader. Many mobile phones are already equipped with this software, for the others, its installation is simple. Other examples of optical formatted image data that can be used are bar-codes and QR codes.

For a commerce related promotion, the user can go to an identified merchant to benefit from the promotion. The map function can provide directions, such as walking directions to one or more different nearby merchants from which offers are available. In one embodiment, the storekeeper can use their mobile phone to register the promotion. The photography of Flashcode with the mobile device can initiate the sending of e-mail acknowledgment towards the service “Promo Park” in the central system to validate the authenticity of the coupon.

Flashcode uses standard norm of matrix codes Datamatrix and a “grammar” which allows defining action activated by the scan of Flashcode. One benefit of this solution is that it requires no investment in equipment from the storekeeper. The coupon can also contain a coupon number to allow the storekeeper to make a manual data entry via internet.

In various embodiments, the store keeper can be charged based upon the sending of an electronic voucher, based upon the redemption of the vouchers or combinations thereof. For instance, the store keeper may only be charged with the voucher is initially sent, the store keeper may only be charged when the voucher is redeemed or the storekeeper can be charged when the offer is sent and when the offer is redeemed.

Next, the EzMove module is described. EzMove can help a user to optimize their navigation inside city center by having choices between different means of transportation. EzMove can provide various transportation options and information. These can include but are not limited to: a) traffic information, b) public transportation (Bus, train, boat, etc.), c) taxi, d) alternative transportation, e) bicycle sharing services, f) car sharing services (e.g., electric), g) car rental and h) walking Walking can include various options, such as most direct, minimize hills and scenic, minimize walking distance.

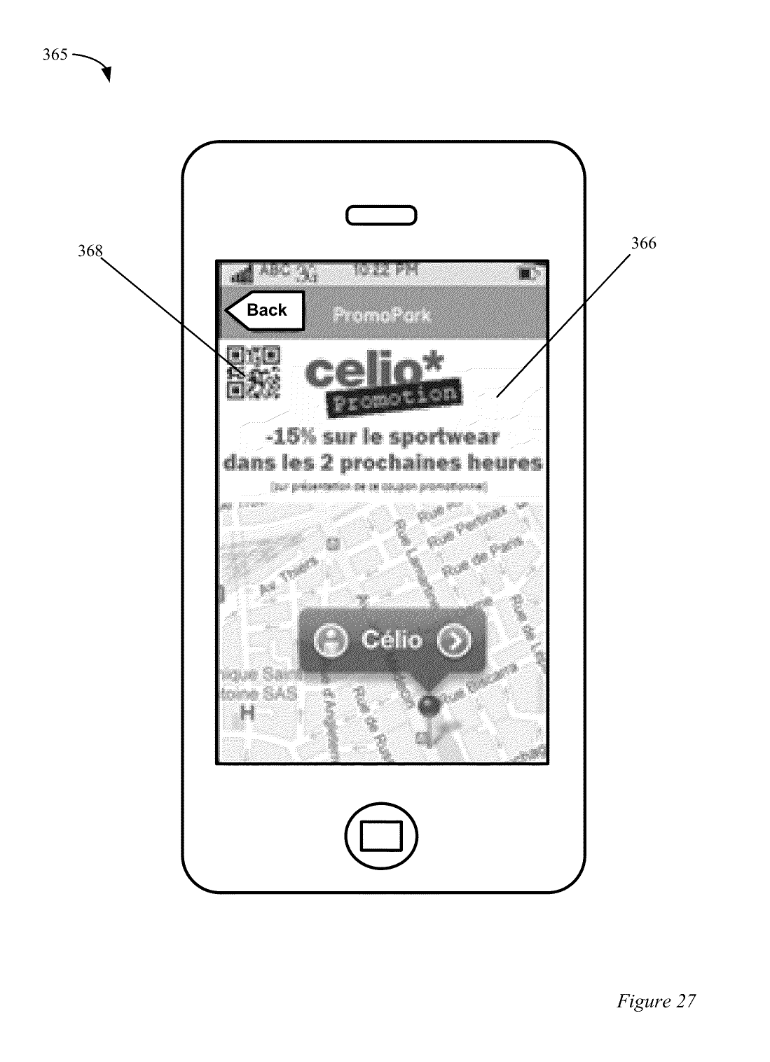

FIG. 28 shows example display screens 370 associated with an EzMove module of a mobility application. The EzMove main screen can give access to the different information/modes of movement available in the city (Traffic information, Public transportation, Taxi . . . ) according the configuration defined on “EzPark setting” screen. Different functionalities described below can be made available on these screens.

A selection of the button 372 allows a user to access EzMove settings 378. EzMove settings can be managed also from the main screen of the city passport application. EzMove settings may allow a user to configure as well as prioritize mobility options related to traffic information, public transportation, taxi, car sharing, bicycle sharing, car rental in which a user can select the desired type of rental information (car, motorcycle, . . . ) and which brand (for car, Ada, Avis, Europcar, Hertz . . . ), walking and combinations thereof. The cover flow 374 allows a user to select between the types of transportation configured via EzMove settings where selecting one of the covers presents a different category to be output. Display section 376 provides general information of the features in the application associated with each type of transportation.

Traffic information can inform users about the disturbances they could face during their movement in the city (construction delays, demonstrations, accidents) and allows users to anticipate obstacles and modify their route. The traffic information service may be complementary to the parking services. Some benefits of providing this information can be a reduction of traffic jams, reduction of pollution and gas consumption and a reduction of stress of residents within the city.

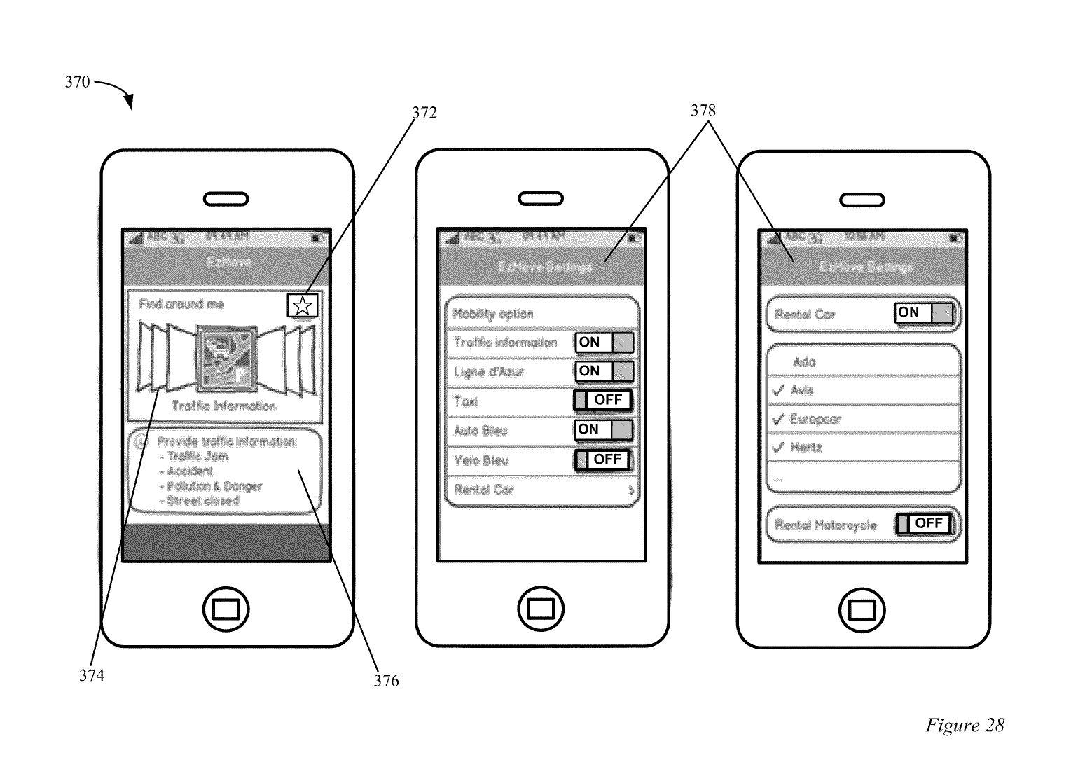

FIG. 29 shows example display screens 380 associated with traffic information within a mobility application. When a user selects traffic information on the cover flow of the main screen in FIG. 28, the application can display a map centered on the destination or the itinerary. The map and its centering can be updated as a user's position and hence the device position changes.

The map can display information associated with one or more of i) accidents, which may be manually entered into the system, ii) pollution and danger, which may be manually entered and/or obtained from pollution sensors, iii) traffic jams, which can be obtained from traffic sensors, cameras and users' mobile devices, iv) street closures, which can be manually input, construction projects including road work, which can be manually input and a position of fixed radars, which can be manually input, v) event information, such as a sporting event, a parade or a marathon expected to create traffic, and vi) combinations thereof. Example symbols associated with this information are shown in FIG. 24. Other types of information can be displayed and these are examples are provided for the purposes of illustration only.

Different functionalities described below may be available on the screens 380. Different combinations of functions are possible that include more or less than options pictured above are possible and are not limited to these examples. The functions can include but are not limited to: i) an election of the button 382 allows a user to refresh the data that is displayed in the mapping application, such as on Google Maps, ii) a selection of button 384 or 394 cause the map to be automatically geo-localized using GPS capabilities of the phone, iii) a selection of the button 386 causes a screen to be output which allows searching on an address and iv) a selection of the button 388 causes a screen to be output which allows searching on an itinerary to be displayed.

When button 386 is selected, address screen 390 can be displayed. In this mode, the user can focus the search area and input information, such as characters, that guide the search. The application may automatically search for the matching string from a list or focus the search in some other manner according to the information that is input. Via the interface, a user can select or input the desired address. After the selection, the application automatically returns to the “Traffic information” screen. Traffic information can be displayed on the map around the selected address and/or along a path from the user's current location to the selected address.

When button 388 is selected, itinerary screen 392 can be displayed. A selection of button 396 allows the user to select a start and an end address. Different options may be available. For example, a selection of button 394 causes the application to automatically geo-localize by using GPS capabilities of the phone. In one embodiment, it may be available only on start address.

A selection of the button 398 enables searching for a particular destination. By clicking on it, the destination screen 395 to be displayed. Within screen 395, a user can select the mode of search (Address, Public places). Further, a user can focus the search area and input characters. Using the characters, the application can automatically search for the matching string from a maintained list of strings associated with the application.

Further, a user can select the desired destination. If Address mode is the selected mode in 395, the application may ask for the number of the street or may use a nearby number when a location on a map is identified. A user can click on ‘get directions’ in 392 and the application can be configured to automatically return to the previous screen.

Traffic Information can be displayed on the map based on the calculated itinerary. In one embodiment, the itinerary function may use ceparou06 itinerary search engine. A module can be provided that allows a user to input manual information. This module can be available with a regular PC and/or Pocket PCs that are provided to municipal agents (police).

A “Public transportation” option may inform users about public transportation stop locations, timetables and general information regarding public transportation. The information can include walking distances to a selected destination location from a public transportation stop location. When a user selects “public transportation” on the cover flow of the main screen (item 374 in FIG. 28), the application can be configured to display a map visualization of the public transportation centered on where user is located and/or on the destination user selects.

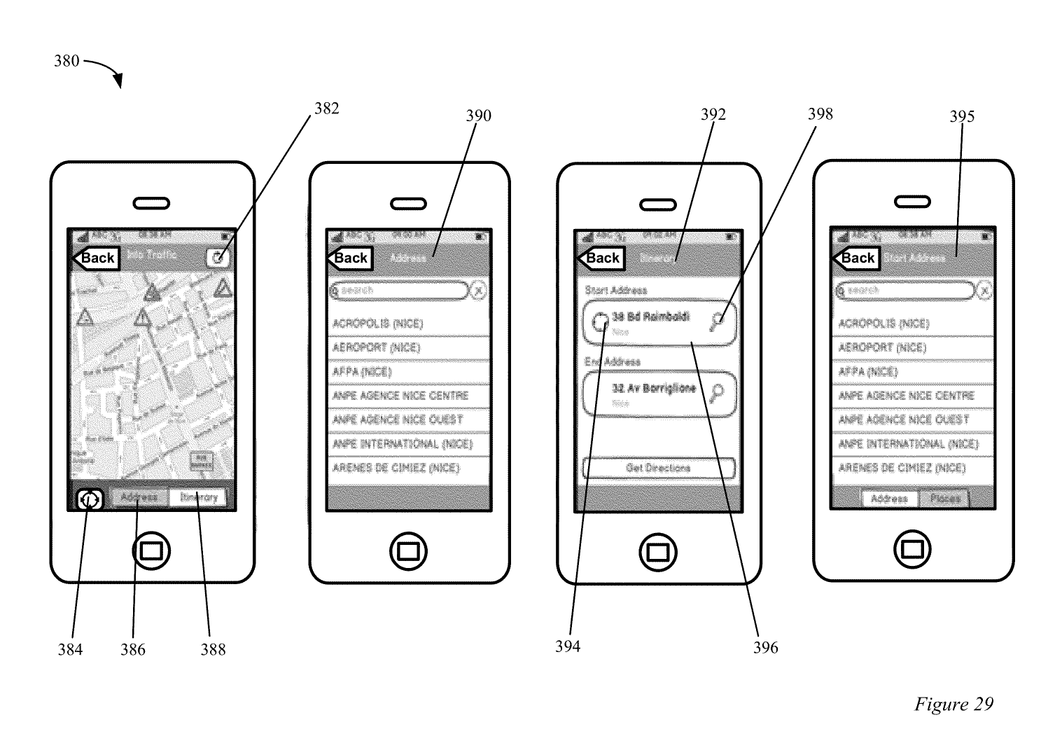

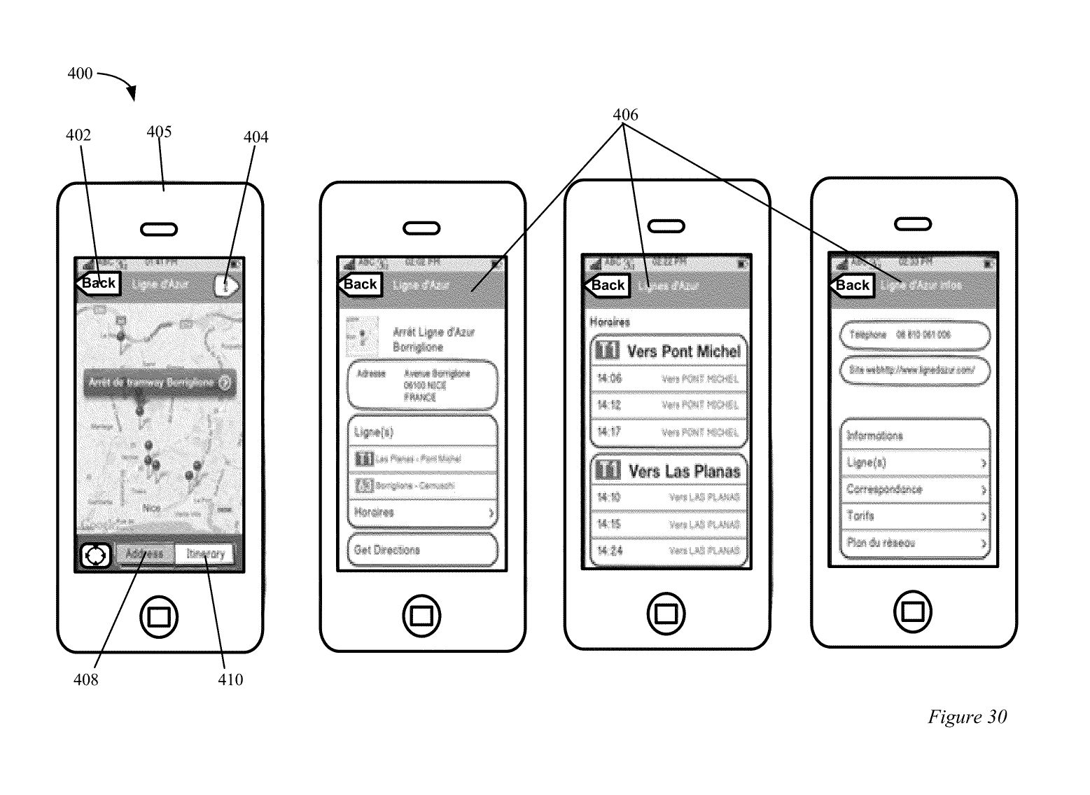

FIG. 30 shows example display screens 400 associated with public transportation within a mobility application. Different functionalities described below can be made available on this screen and/or related screens. In 400, a selection of the button 402 can cause a return to main screen in FIG. 28. A selection of the button 404 causes general information to be displayed, such as but not limited to: telephone number, web site, information, bus/tramways line, connection, price/rate and a public transportation network map (e.g., subway). A selection of the address button 408 or the itinerary button 410 enables searching for an address or an itinerary. In addition transportation mode options can be selected, such as bus, tram, car, etc. These options are described as follows with respect to FIG. 31.

FIG. 31 shows example display screens, 412, 414, 416, 418 and 420 associated with selecting options for public transportation within a mobility application. When button 408 is selected, address screen 412 is displayed. In 412, the user can select the mode of search (address, place and stop). The user can focus the search area and input characters. The application may automatically search for the matching string from the list addresses, places and stops maintained in a database associated with the application. This approach differs from a general search of the Internet and can allow the application to run in an off-line mode without network connectivity.

When a user selects or inputs the desired address, application can ask for the block number. Then, the application can automatically returns to the “Public transportation” screen in FIG. 30. Bus/tramway/train stop information can be displayed on the map around the selected address in the public transportation screen.

When Itinerary button 410 is selected, the itinerary screen 414 can be displayed. A selection of the section 422 can enable a selection of a start and end address. Different options may be available. A selection of 424 can cause the application to automatically geo-localize using GPS capabilities of the mobile device or other location services which are available, such as triangulation using wireless access point or cellular towers. In one embodiment, this function may be available only with the start address.

A selection of the button 426 allows searching for the destination. By clicking on it, the destination screen can be displayed (similar to 412). A user can select the mode of search, such as address, public places, stop. A user can focus the search area via inputs of characters. The application automatically searches for the matching string from a list of addresses, public places and stop maintained in a database associated with the application. Then, a user can selects the desired destination (If address is the selected mode, the application can asks for the number on the street).

In 418, a user can select the date & time of travel. In 416, a user can select itinerary research criteria (mode of transportation, best Route, fewer transfers, least walking, fastest time, etc.).

Then, a user clicks on get directions and the application can automatically returns to previous screen. Station Information can be displayed on the map based on the calculated itinerary (see 405 in FIG. 30). A detailed itinerary is shown in 420. By clicking on a bus/tramway stop marker in 405, the application can display one or more of the following information: bus/tramway stop name: i) address, ii) bus/tramway line available at this stop and the next hours of passage at this stop and iii) get directions to help user to go from current location to the bus/tramway stop.

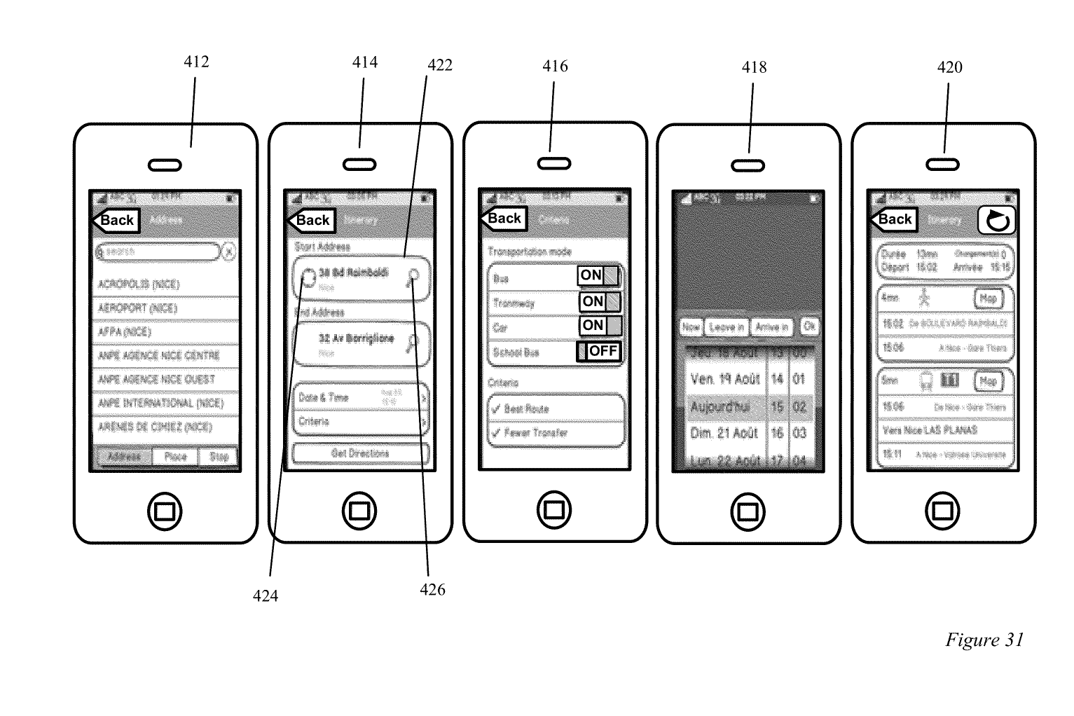

“Taxi” can be used to inform users about taxi stations location and provides general information regarding taxi services. When user selects taxi information on the cover flow of the main screen (item 374 in FIG. 28), in one embodiment, the application can displays a map visualization of the taxi station centered on where user is located and/or the destination user selects. FIG. 32 shows example display screens, 422, 424, 426, 428 and 430, associated with selecting options for obtaining a taxi within a mobility application.

Different functionalities described below may be available on screens, 422, 424, 426, 428 and 430, respectively. A selection of the button 432 allows returning to main screen. A selection of button 434 can cause general information to be displayed in 424, such names and phone numbers of taxi companies. Prices and rates can also be accessed in 424.

A selection of button 436 causes the application to automatically geo-localize by using possibly the GPS capabilities of the phone. A selection of button 438 allows for selecting an address. In 426, n address screen can be displayed. In 426, a user can focus the search area and inputs character. The application can automatically search for the matching string from the lists maintained in the application. In one embodiment, a company may have to pay a subscription fee to be listed in the database associated with the mobile application.

As part of selecting the desired address, the application can ask for the block number. After input of the address, the application automatically returns to the “Taxi station” screen 422. Taxi station information can be displayed on the map around the selected address. By clicking on a taxi station marker, the application can cause all or a portion of the following information to be displayed: a) station name (see 430), b) address, c) number of taxi available (if sensor(s) deployed at the station, on the taxis and/or if this system allows this information to be input manually.

Within the application, it may be possible to get directions to help the user to go from current location to the taxi station. Also, using the itinerary function it may be possible to calculate an approximate price (e.g., using locations when prices are location dependent, time of the journey, distance and duration). Further, an option can be provided to display free taxi located near the position and cause taxis to call him. Further, a location and/or communication link to the user can be provided via the system. In one embodiment, a voice over IP connection can be established using system capabilities.

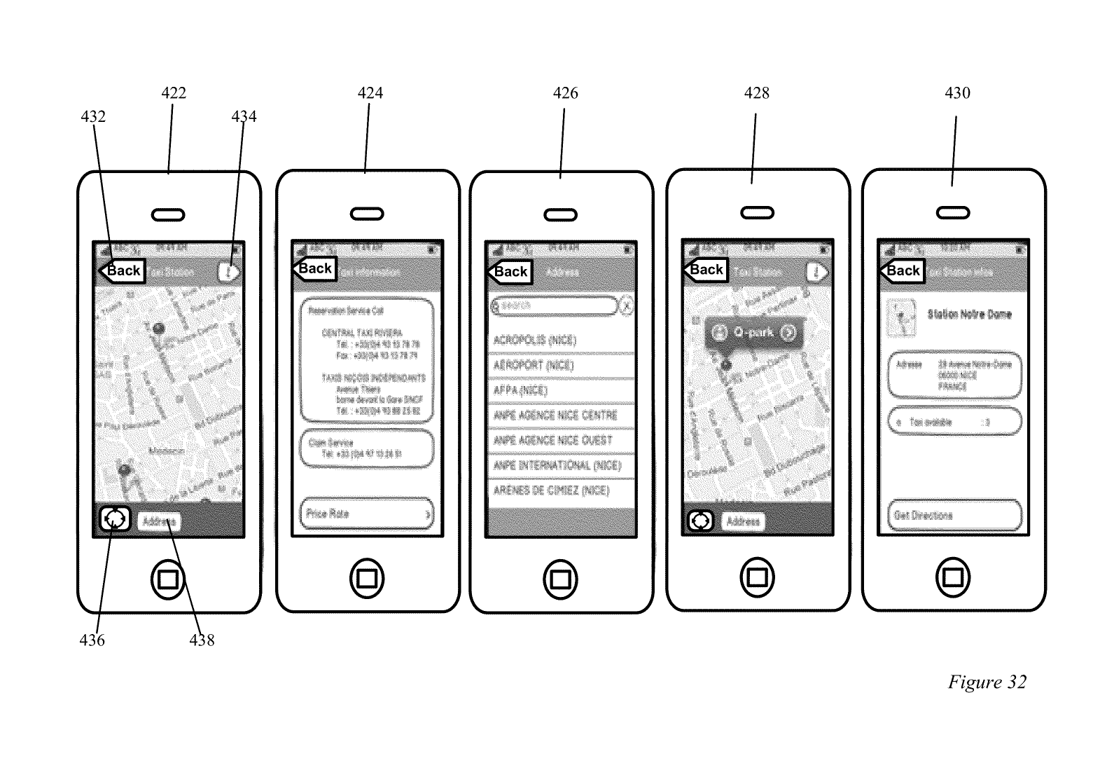

FIG. 33 shows example display screens, 440, 442 and 444 associated with selecting options for car and bicycle sharing within a mobility application in accordance with the described embodiments. “Car & Bicycle sharing” can inform users about stations location and provides general information regarding sharing services. In one embodiment, a similar interface is used for both systems. As an example, the bicycle sharing system is illustrated as follows. When a user selects car or bicycle sharing on the cover flow of the main screen, the application can be configured to display map visualization 440 of the stations centered on where user is located and/or the destination user selects.

Different functionalities described below may be available on the screens, 440, 442 and 444 which are for the purpose of illustration only. A selection of the button 446 can cause a return to the main screen. A selection of the button 448 causes general information to be displayed, such as: general information, “how it works?”, subscription and price/rate (e.g., see 442 and 444).

A geo-location button can be provided which causes the application to geo-localize the user on the map by using location detection, such as using GPS capabilities of the phone. A selection of the address or itinerary button enables searching for an address or generating an itinerary in one of the manners previously described above. In response to clicking on a station marker, the application can be configured to display all or a portion of the following information: station Name, address, number of bicycle(s) or car(s) available and whether free emplacement available. Further, the application can generate directions to help the user to go from current location to the station

In one embodiment, if a bicycle or car is available, the user may be available to make a reservation to hold the car or bicycle. In one embodiment, the user may have to pay first to reserve a bicycle or a car. In another embodiment, the user may be able to request a hold of the bicycle or the car for a short period of time. After the hold period expires without the user initiating a transaction, then the bicycle or car can be released for use by other users.

In one embodiment, the system can keep track of how the user uses the hold feature. If too many holds are initiated without the user actually completing a transaction, then the system can be configured to block this feature for the user. In another embodiment, this feature may only be granted to users which regularly use the system. For example, after purchasing five car shares, a user may be granted the ability to hold/reserve cars for use.

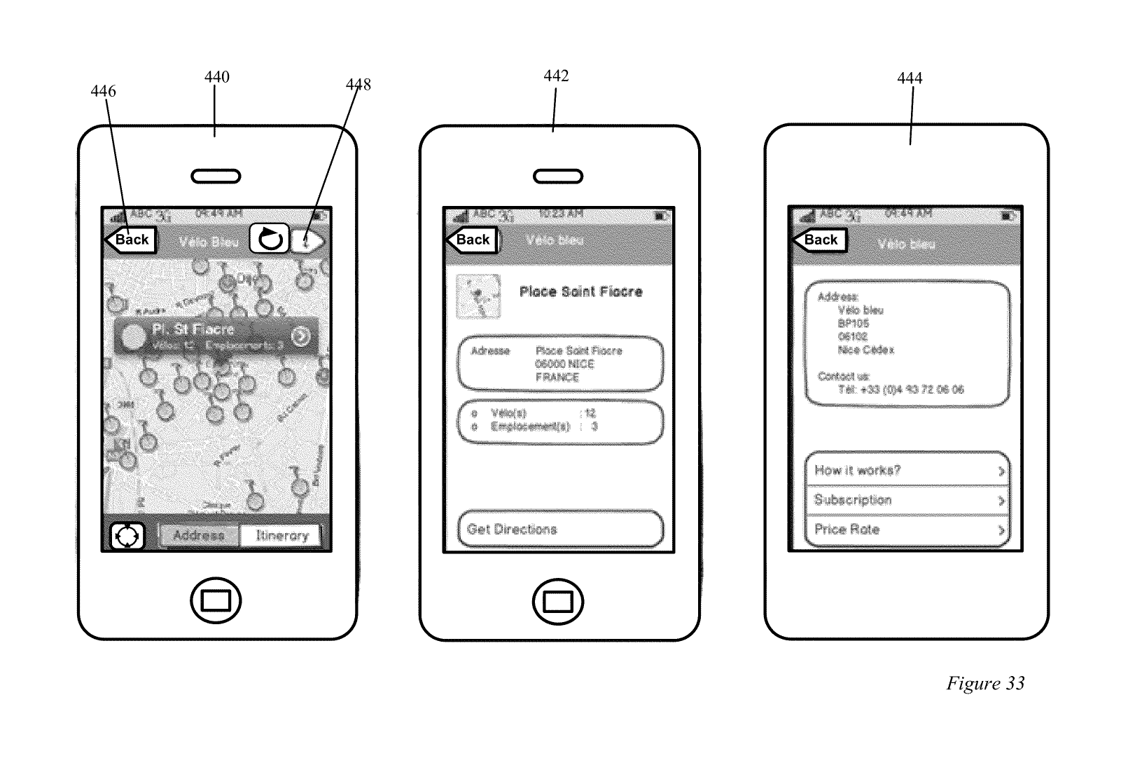

FIG. 34 shows example display screens, 450, 452 and 454 associated with selecting options for renting cars or motor bikes within a mobility application in accordance with the described embodiments. “Rental” portion of the application interface can inform users about rental car & motorcycle shops and provide general information. When a user selects rental on the cover flow of the main screen, the application (see FIG. 28) can display a map visualization as an example of the rental car & motorcycle shops (based on preference configured on EzMove setting>Rental). The map can be centered on where the user is located and/or the destination user selects.

Different functionalities described below are available on these screens. A selection of the back button can cause a return to the main screen. A selection of the button 456 can cause an interface page that allows reconfiguring preference defined on EzMove settings>rental. A selection of the geo-localize button can cause the application to automatically geo-localize the position of the map by using GPS capabilities of the phone or other location capabilities.

When the address button is selected, screen 452 can be displayed. A user can focus the search area. For instance, the user can input a character string. The application may automatically search for the matching string or strings from the list.

A user can select the desired address, the application can be configured to ask for the block number and the application can automatically return to the “Rental” screen. Rentals can be filtered by preferences selected by the user. The rental information can be displayed on the map around the selected address. By clicking on a rental shop marker, the application can be configured to display additional information as shown in 454, such as but not limited to: name, phone number, address, number of vehicle available for rental. Further, the user can get directions to help user to go from current location to the shop.

EzCity portion of the application can provide a city phonebook. The city phonebook can be a directory grouped by category where information about services, administrations, associations, facilities, etc. can be found. The information can be geo-localized in a map. The geo-location can be based on a current position of the user or some other selected location. This module can include feeds showing news and agenda of the city.

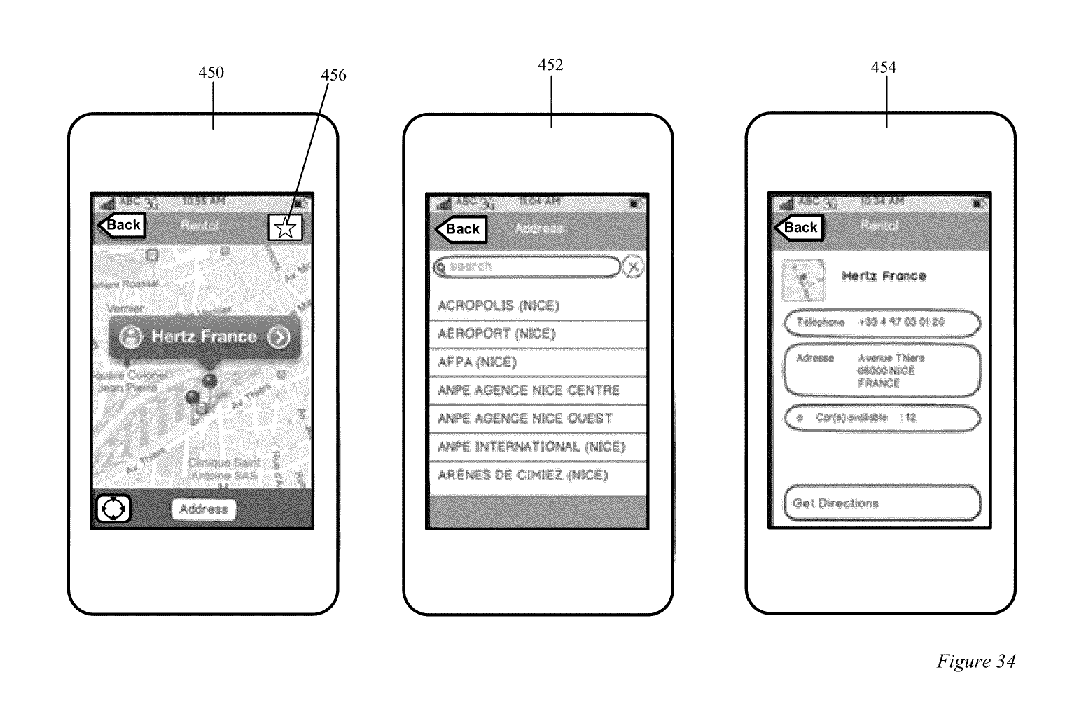

FIG. 35 shows example display screens, 460, 462, 464, 466, 468, associated with a city phone book module within a mobility application. The City Phonebook can provide information, such as phone numbers for one or more of the following topics: emergency services (police, fire station, etc.), public Services, health, lost & found, social emergency, car pound and animals. Screen 460 shows categories, screen 462 shows details of an emergency services category, screen 464 shows details of a health category, screen 466 shows a listing of pharmacies and screen 468 shows the location of a selected item on a map. A user can directly call the number displayed by clicking on it. For numbers that contain information and addresses, the application can be configured to suggest and display a direction via a mapping application, such as Google Maps, by clicking on the button 470.

To facilitate searches for services, the city directory can group services into different categories, such as the following categories: administrative procedures, culture, environment, handicap, health, leisure, security, senior, social, sport, tourism & shopping, transportation and urban waste management. Each category can possess sub-categories which are defined in an application database that allows refining of the search. For each sub-category, all addresses of services, administration, associations, facilities, etc. can be displayed in a map by using a marker.

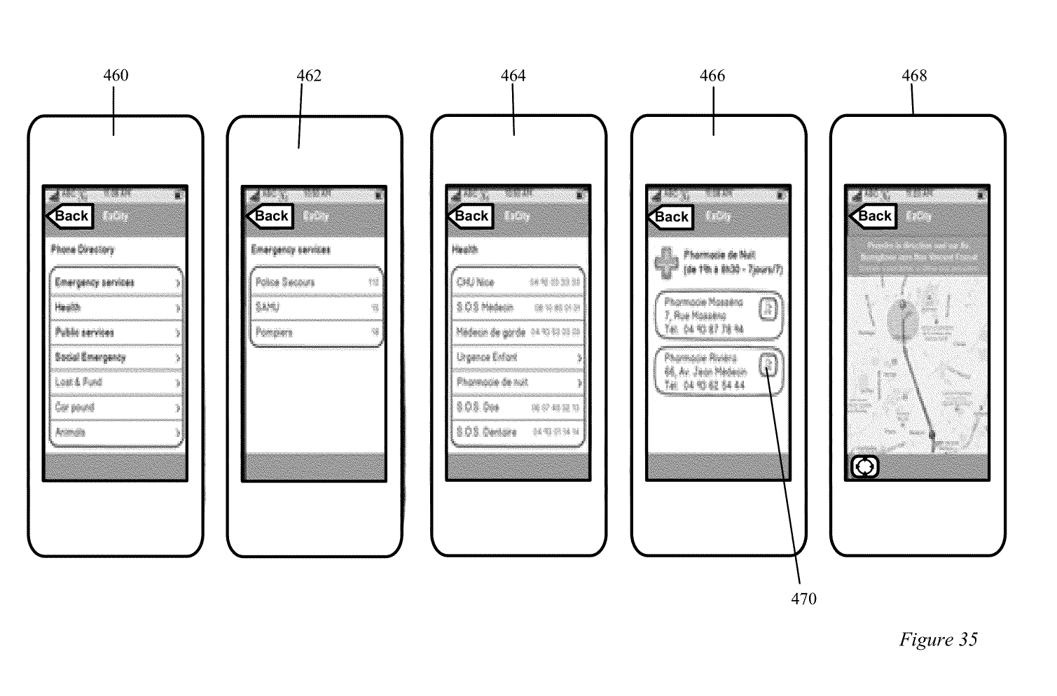

FIG. 36 shows example display screens, 480, 482, 484, 486 associated with a city phone book module within a mobility application. When user selects a category on the cover flow of the main screen in 480, the application can display the list of sub-categories. A selection of the back button can cause a return to the main screen. A selection of the star button can allow a user to access EzCity settings. EzCity settings can also be managed from the main screen (see FIG. 28) of the city passport application.

EzCity settings may allow a user to configure one or more of the following options: a) city directory in which categories and sub-categories can be selected by the user, b) city news and agenda in which types of news and other information of interest to the user can be selected. Cover flow 488 allows selection from the different of categories configured within EzCity settings. Section 490 allows a user to select the sub-category (check or uncheck) that are to be displayed on the map or provided as information to the user in some other format. A selection of the “ok” button causes the system to process and display user selections on the map (e.g., 482) or in some other format.

A selection of the back button can cause a return to the main screen. A selection of the list button in 482 can cause information related administration, services or facilities to be displayed in a list format as shown in 486. In response to a selection of a map marker, the application can be configured to display one or more of the following types of information to be displayed as shown in 484: name of service/administration/association/facility, address, phone number, web site to get more information (if available), opening and closing hours, price rate (if applicable), public transportation nearby and direction services (walking, car, biking, public transportation or combinations thereof). A selection of a geo-location button can allow a user to automatically geo-localize map the by using GPS capabilities of the phone or other location detection capabilities.

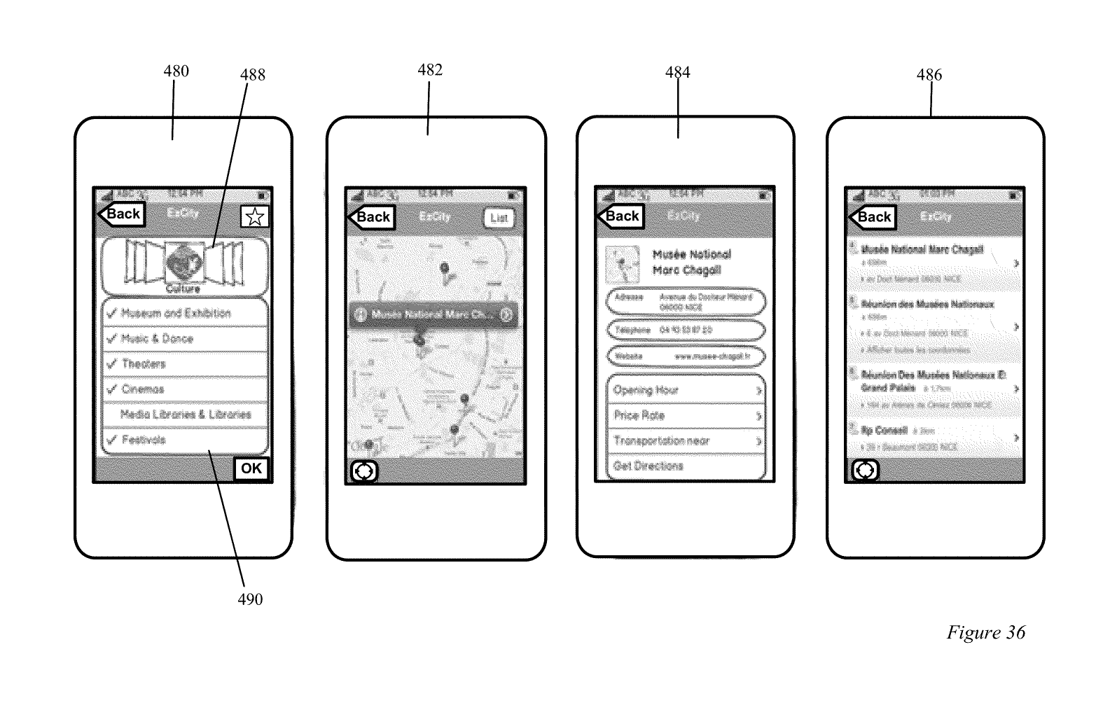

FIG. 37 shows an example display screen associated within a city news feed module within a mobility application in accordance with the described embodiments. A selection of the back button causes a return to a main screen. The news button 502 or agenda button 504 allows a user to select news or agenda items by clicking on the respective button. Depending on the selected button, application shows an associated RSS form feed. A selection of the pull down menu 506 can allow a filtering feeds by category/sub-category, such as but not limited to: news, culture, economy, environment, health, politics, security, social, sports, tourism, transportation, and urbanism, etc. Similarly a selection of the agenda button 505 allows information to be selected according to different categories, such as but not limited to conferences, exhibitions, lounge/bars, shows, animations, movies, concerts, theaters, operas, festivals, sports and dances. A selection of the button 508 can cause the interface to move up and down with a list of the feeds.

### Asset Management Services

In this section an asset management services are described. One objective of the asset management service can be to manage the inventory of all public places and/or equipment's installed in public road network (which can be referred to as a “Monitored City Object” (MCO)), which are monitored by the deployed sensors in the sensor network (e.g., parking, garbage, street lights and watering sensors).

This service can perform one or more of the following: manage the inventory of all the public places and/or the installed equipment associated with each place, establish the link between the sensor and the MCO and manage the system maintenance.

Defining an MCO can involve one or more of i) specifying an address that provides a unique identifier where the format of the addresses can vary from country, ii) specifying a type of sensor and/or its functions, iii) specifying rules for the sensor including thresholds to monitor, iv) specifying rules associated with the MCO, such as parking rules and v) specifying priorities for a group of related rules. The system can be configured to provide an interface for instantiating and subsequently modifying MCO's, such as initialing specifying and the subsequently modifying a rule. In one embodiment, a number of XML documents can be generated when an MCO is instantiated within the system.

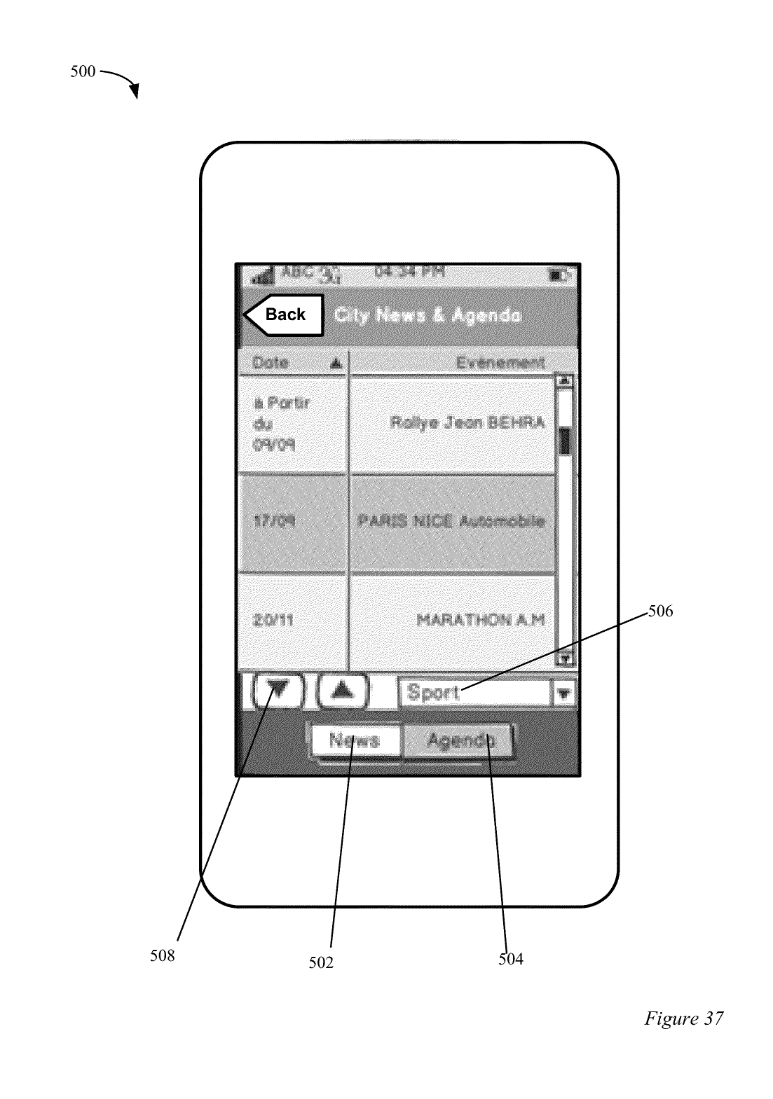

The MCO's can be combined to perform a number of different services. One MCO can be used in multiple services. The different services can be implemented as different modular applications on the system. A few example applications include parking management, traffic management, green area management, waste management and street light management. Other applications are possible and these examples are provided for the purposes of illustration only and are not meant to be limiting. FIG. 38 shows attributes which can be associated with a monitored city object.

In order to manage an international solution (applicable to multiple countries), it may important to be able to define all elements included in the composition of an international address on the base of collected types in all countries member of the UPU (Universal Postal Union). The UPU mission is to develop social, cultural and commercial communication between different populations as a result of efficient inter-governmental efforts. The UPU will have to play a key role in the continuous improvement of these services. Other types of addressing can be and the UPU is provided for illustrative purpose only. In general, an addressing system that uniquely addresses a location can be utilized.

A postal address can be considered as complete when it includes all necessary elements to establish a unique identification. It may be composed of one or more of the following five elements: country code, zip code, region, city and address. In one embodiment, the address can be formatted as an XML document where the address elements can represent a hierarchical tree.

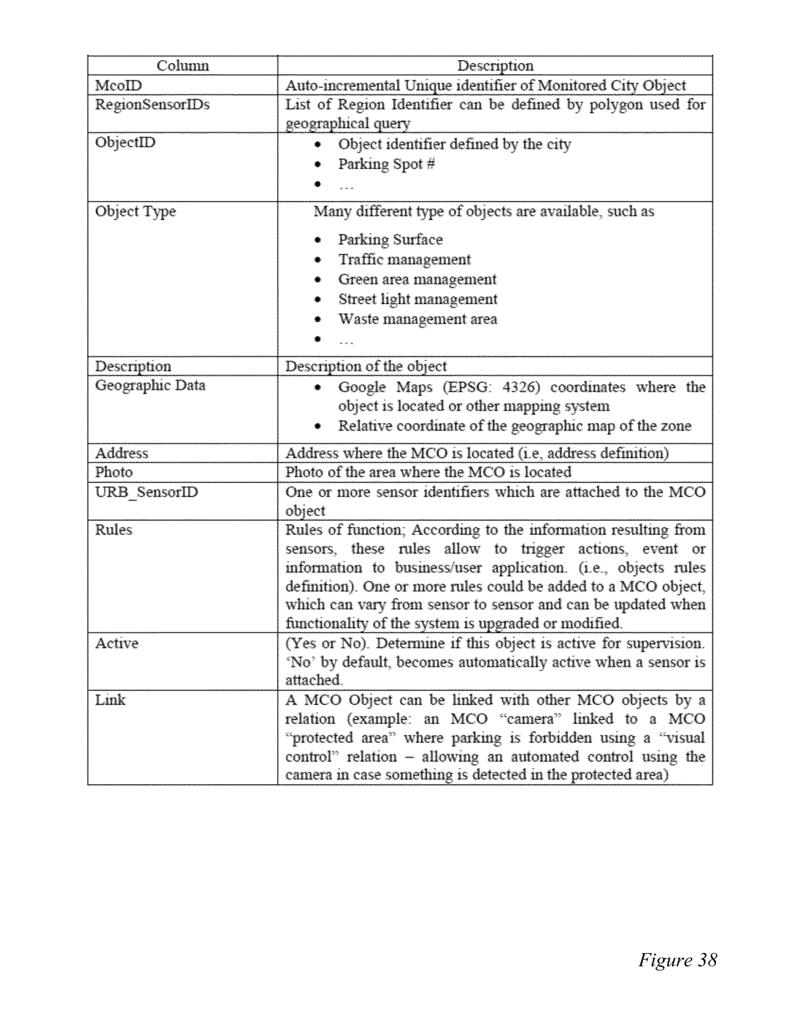

FIG. 39 illustrates the relationship between parents and children of different elements of the address vocabulary. The CountryCode element can use the ISO3166 norm to define the country code of the mailing address. It can be a mandatory element. ZipCode can define the location of the addressee and can be used to facilitate dispatching. The postal code may be composed only of numbers or alphabetical characters and numbers. Region can represent a state, province, a region and/or a department. City can represent a city, a village, a hamlet or a known place.

The McoAddress, addressLine can be used for delivery by postal service. It can contain the name and/or the number of the building, the house, and/or the street. It can contain additional information of identification of the delivery point. (ex: at Mrs. Martin) If the address is split into streetname & blocknumber, the addressLine may not be used to store the address. An example is 44 rue de Cheux; Residence Berlioz; Suite 200; Boîte postale 26.

McoAddress, StreetName, can contain the name and/or the street number. If the address is split into StreetName & BlockNumber, the AddressLine may not be used to store the address. An example is rue de Cheux; 33 rue de Beaulieu. McoAddress, BlockNumber can contain the name and/or the building number. This element can be defined as a chain to manipulate <<numbers>> as 9A or 18/III. The term, ‘BlockNumber’ may be used in order to represent all buildings types, such as house, building, residence, warehouse, tour, industrial zone, etc. If the address is split into StreetName & BlockNumber, AddressLine may not be used to store the address. An example is Residence Berlioz; 5270. McoAddress, suite can contain the apartment, the suite, the unity, the piece, the floor, the level, etc. If the address is split into StreetName & BlockNumber, AddressLine may not be used to store the address. An example us Apartment 120; Suite 18; Etage A.

By producing a dispatching tag, the country code can be translated in the country name. The formatting characters may be left outside postal codes. In particular embodiments, systems which identify StreetName, BlockNumber & Suite may use these elements separately and use only the AddressLine for the additional information. A reception system may use these elements separately for validation to establish the address entirely or to fill in the corresponding fields to its database. The systems which don't recognize separate elements may use the AddressLine.

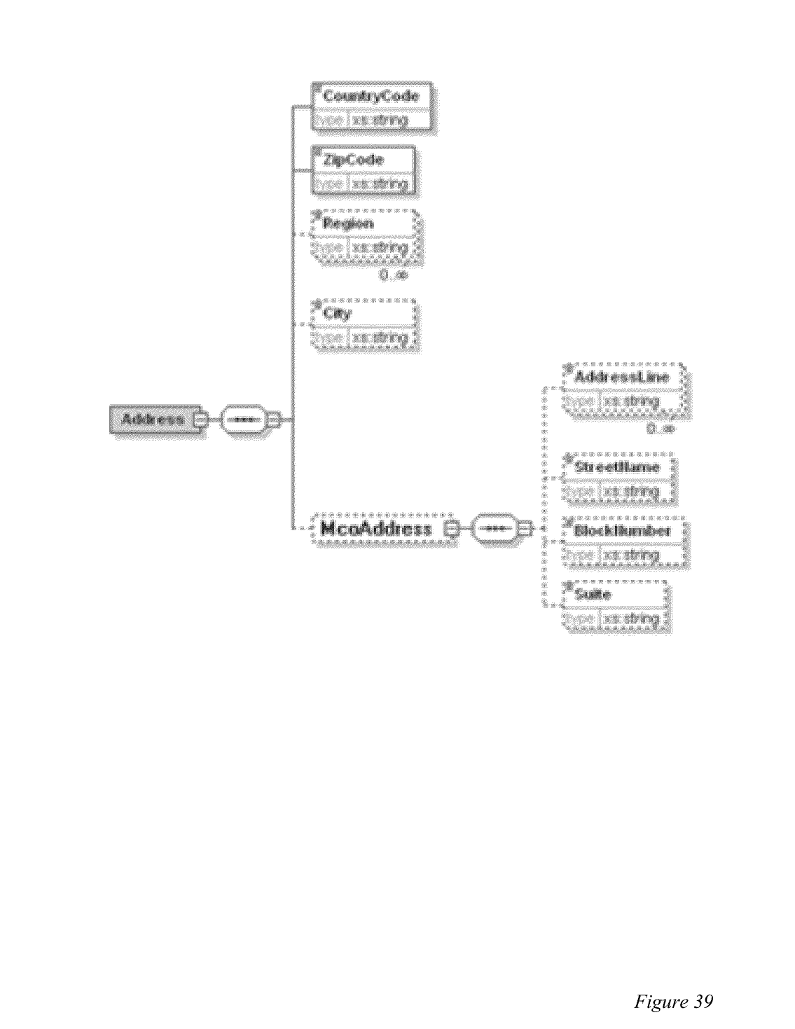

The addresses which are split into StreetName, BlockNumber, and Suite can be stored in addition in AddressLine. If both methods are simultaneously used the information may be complementary or redundant. Such a system may be more efficient than a sophisticated treatment relying on one among them. Moreover, by using redundancy, we authorize the use of both in terms of comparison. A few examples of the implementation of addressing in an XML format are shown in FIG. 40.

In order to cover different address configurations, templates can be used that allows for defining the input mask. In one embodiment, the XML tag can describe the content rather than the presentation. A template can be created for each country in order to define precisely the input mask. An editor can be used to define the template configuration. It will allow for selecting and putting into order the elements defined by the scheme address.

Rules may be an important part of MCO Objects management. They can be used to define threshold(s) of monitoring of MCO objects. According to the type of MCO Objects, rules can different. They can be used through CEP (Complex Event Processing) inside a business application associated with the system.

In particular embodiment, a number of parameters for managing rules can be defined. RulesID can be a unique identifier for a rule. “Object type” can be the type of object to which the rule is associated. “Description” can be a description of a rule. “Rules schema” can XML schema defining the rule for a specific object. Other formats are possible and XML is provided for the purposes of illustration only. “Active” can be yes or no and is used determine whether a rule is active. It can be yes by default.

“Period” can be a period of time when the rule is to be applied. A rule may be applied when it is active and the time is within the defined time period. “Family” can define a rule family. “Priority” can define a priority of a rule inside its family. In one embodiment, when an MCO object has multiple active rules within its family, only the rule having the maximum priority is applied. The priorities can be defined as a range.

Different methods to can be provided to manage MCO objects, attach/detach sensor from an MCO object and define rules for an MCO object. The methods may only be implemented by a validated user. Details related to using the methods are described below.

A first method can be used to create an MCO object. The parameters of the method can include, user_id (name of user which is an identifier), pwd (user password, can be encrypted on SHA1) and MCO_def (XML descriptor including the MCO definition). In one embodiment, the MCO_def can include the following data: Object_ID (string), Object_Type (integer), Description (string), Address (complex type), Photo (binary), SensorlD (list of sensors attached to MCO) and Rules (list of RuleIDs).

A second method can update data from an MCO Object. The parameters of the method can include user_id, pwd, MCO_def (XML descriptor including the MCO definition). The MCO definition can be the same as above.

A third method can return one or more MCO Object descriptions depending on the type of request. The method can include the following parameters user_id, pwd, MCO_Objects (list of MCO Object(s) requested by the user). The MCO_Objects can include the following data: Mco_ID (string), Object_ID (string), GPS_Area (complex type), ZipCode (list of strings). This function returns a list of MCO Object descriptions.

A fourth method can be used to attach a sensor to a MCO Object. The method parameters can include user_id, pwd, MCO_ID (MCO identifier), sensors (list of sensors to attach to specified MCO Object) and Overwrite (determine if this new list overwrites the previous one or just adds to it).

A fifth method can be used to detach a sensor from a MCO Object. The parameters can include user_id, pwd, MCO_ID (MCO identifier), sensors (list of SensorIDs to detach from identified MCO Object). A null value may detach all sensors.

A sixth method can be used to return Rules from one MCO object depending on the pattern used. The parameters of the method can be user_id, pwd, MCO_Objects=list of MCO Object(s) requested by the user. MCO Objects can include the following data: MCO_ID (string), Object_ID (string), GPS_Area (complex type) and ZipCode (list of strings).

A seventh method can be to be used to add rules to an MCO object. The method can include the following parameters user_id, pwd, MCO_ID (MCO identifier), Rules_ID (list of rule IDs) to attach to identified MCO Object and Overwrite (used to determine if this new list overwrites the previous one or just adds to it).

An application allowing the creation of MCO objects can be made available on a portable electronic device, such as PDA. For some applications, such as outdoor installation of a sensor, the portable electronic device may have one or more of the following characteristics: semi-hardened to allow operation in an outside environment, an operating system such as WES, Windows Embedded Handheld 6.5, iOS, android or appropriate operating systems, wireless communication, GSM/UMTS, Wi-Fi, geo localization capability, a bar code reader (or other optical image data reader) and a camera.

It may be connected to Internet via GPRS/3G, Wi-Fi or some other wireless communication protocol. It can allow inventory on site of all MCO objects during the installation of the sensors, such as Urbiotica sensors of Barcelona, Spain. To allow on-site inventories, the application may be configured to implement one or more of the following features: creation of MCO objects, attach/detach sensor(s) to an MCO object, application of predefined rules to the MCO object and change sensor. Some methods that can be used to manipulate MCO objects are described above.

The following method can be implemented in a Graphical User Interface (GUI) that is generated by an application executing on the portable electronic device. In one embodiment, it can be implemented when a new MCO is added to the system. The method can involve all or a portion of the following steps in various orders.

First, a user can select the option “Creation of MCO object” to initiate the method. Second, a user can select/specify the type of MCO object, such as MCO object types listed in a drop-down list (McoType). Third, a user can enter the reference city of the object (ObjectlD). In one embodiment, it can be selected or specified in a free form text box.

Fourth, a user can enter a description of the object (Description, optional). In one embodiment, the interface can provide some common descriptions which a user may select where the user can add additional information to the description to customize it if desired. Fifth, a user can select the address on a combo-box where the MCO object is located or via some other mechanism within the GUI. A database containing all streets, place, etc. can be made available to facilitate the input (Address).

Sixth, a user can take a photo of the zone where the MCO object is located (Photo, optional). Seventh, a user can enter the geographical coordinate of the MCO object. In one embodiment, a button can be available in the application that allows the coordinates to be obtained automatically in GPS coordinates or some other format.

Eighth, a user can have the option of specifying the sensor(s) associated with the object. In one embodiment, sensor devices can include multiple sensors that can be made inactive/active in a given implementation. In addition, different combinations of sensors can be utilized with the system which can vary from sensor device to sensor device, such as different models of sensor devices from different manufacturers.

When a sensor is electronically attached to the system as well as physically attached to some type of local infrastructure, the user may specify the sensors that are available on the sensor device and an initial configuration of the sensor, such as which sensors are active/inactive. In one embodiment, the system can include a database of sensor devices. The system can be configured to accept information that allows information on a particular sensor device to be retrieved from the sensor device database, such as a model number of the sensor. Information retrieved from the sensor device database can be added to a database record associated with the MCO that is being generated.

In addition, if desired, the user can be provided the option to select predefined rules he wants to apply for this MCO. In one embodiment, the predefined rules can be selected from a list box or some other type of graphical user interface. The rules can include parameters that can be specified by the user as well as a set of default parameters, such as sensor sensitivity settings. In one embodiment, the predefined rules that are provided to the user can depend on the type of MCO that has been specified and/or the type/model number/capabilities of a particular sensor device associated with the MCO. Once the installation operation has ended, the user can click on the “save” button to record the information in a system database. During the insertion of the object in the database, a McoID can be automatically generated by the system.

The following method can be implemented when a previously created MCO in the system is modified. The method can be made available for a GUI. The method can involve all or a portion of the following steps. First, a user can select the option “Edit MCO object.” Second, a user can selects the type of MCO Object (Object type).

Third, a user can locate the MCO object in an MCO database using different criteria. A few examples of information that can be provided that allow information about an MCO to be retrieved from an MCO database can include one or more of: the “city reference” of the MCO objects (ObjectID), the McoID, the geographic data and the address.

In one embodiment, a user can click on a button “GPS” to automatically acquire the geographic data, such as a current location. The application can displays all MCO objects of the selected type located around the current location. The can then select one of the returned nearby MCO objects. For the address, a user can select the address on the combo-box. The application can displays MCO objects of the selected type located near the address.

After a particular MCO has been selected, the application can be configured to display all data related to the selected MCO object including but not limited to MCO object data, attached sensor(s) and rules. Then, the user can make the desired changes. After the modifications are made, the user can click on the “save” button to update the information in the database.

When a MCO object is updated, the new configuration can be automatically sent to the application using this object. In one embodiment, the system may allow a user to select a group of MCO objects and modify the properties of the selected MCOs as a group. For example, to configure zones in a parking system where the rules vary from zone to zone, the system might allow the user to identify all the parking MCO's in a zone. For example, the user might specify the geographic boundaries of the zone and then the system can be configured to identify all the MCO's of a particular type in the zone. Then, the system may allow the user to modify rules or other properties of the MCO's in the identified zone as a group.

Next, the following method can be implemented when a previously created MCO in the system is modified. In this example, the modification can involve changing a sensor configuration associated with the MCO. The method can be made available via a GUI. The method can involve all or a portion of the following steps.

First, a user can select the option “attach/detach sensor(s) to MCO object.” Second, a user can select the type of MCO Object (Object type). Third, a user can locate the MCO object in the MCO database using different parameters, such as the “city reference” of the MCO objects (ObjectID), the McoID, geographic data (e.g., the users' current location) and address.

In one embodiment, a user can click on a button “GPS” to automatically acquire the geographic data associated with their current location. The application can displays all MCO objects of the selected type located around the returned geographic data. The user can select from among the returned object. For address, a user can select the address on the combo-box. The application can display all MCO objects of the selected type located near the selected or specified address.

Fourth, the application can be configured to display all data related to the selected MCO object including but not limited to: MCO object data, attached sensor(s), rules, description and sensor status (e.g., operational/non-operation). Fifth, if the user wants to attach sensor(s), the user can click on the button “attach sensor(s).” The list of non-attached sensor(s) compatible with the type of MCO object located around it can be displayed. Then, a user can select from the list the sensor(s). The user can click on the “attach” button to attach sensor(s). All selected sensor(s) can be attached to the MCO object.

If the user wants to detach sensor(s), user selects from the list of the attached sensor(s) then clicks on the “detach Sensor(s)” button. The sensor(s) being detached are removed from the list. When a sensor is Attached/Detached from a MCO object, the new configuration can be automatically sent to applications using this object.

The following method can be implemented when a previously created MCO in the system is modified. The following method can involve specifying modifying rules associated with an MCO object. The method can involve all or a portion of the following steps.

First, a user can select the option “Rules for MCO object.” Second, user can select the type of MCO Object (Object type). Third, a user can locate in MCO object(s) in an MCO database by different search criteria, such as but not limited to the “city reference” of the MCO objects (ObjectID), the McoID, geographic data and address data. The address data and geographic data may be implemented in the manner described above.

Fourth, the application can display data related to the identified one or more MCO object(s) meeting a particular search criteria including but not limited to MCO object data, attached sensor(s) and rules. If the user wants to add rule(s), an “add rules” can be selected. The list of rules(s) not already used that are compatible with the type of MCO object can be displayed by the system. Fifth, a user can select on the list the rule(s) he wants to be associated with a particular MCO. A user can click on the “Add” button to add. All selected rule(s) can be attached to the MCO object.

Sixth, if the user wants to remove rules(s), user selects the rules to be removed from the list of rules(s) and then clicks on the “Remove Rules” button. The rules being removed are removed from the list.

Next, the following method can be provided when a sensor has to be changed. First, a user can select the option “Switch Sensors.” Second, a user can select the sensor to change using its SensorID (the ID can be scanned or manually entered). Third, a user can select the new sensor by its SensorID. Fourth, a user can validate changes using “Save” button and a system validation can be performed before applying changes.

### Publication Services

In order to facilitate information access, the city services platform can utilizes a Pub/Sub mechanism through Web services. This solution can reduce database accesses and speed-up queries and processes. Setting up a standard data publication service offers numerous advantages, such as standardization of the communication sources for the applications “users,” publication of the data for third-party systems and a possibility of setting up an economic model based information broadcasting. Because of the urban context, multiple publication services can be made available, such as but not limited to RSS, GeoRSS, VoiceXML, SMS and Email. The publication services might get back events for parking spot availability (specific topic over DDS) and generate RSS feed, GeoRSS, Voice XML which will be available for access directly by Web and/or mobile applications. Other types of events, such as pollution or traffic information can be published as a specific topic over DDS.

In one embodiment, data can be updated in a shared memory that is DDS managed and are automatically published for all customers subscribing to particular data—in DDS, data can be grouped by topics. DDS is a data-centric publication/subscription communication framework. Data can be organized inside a domain by partitions and defined by topics.

Data exchange and storage may defined by different QOS (Quality of Service) parameters. Data published over DDS in a topic is called an instance. A topic can store hundreds of living instances, each one having an ID (equivalent to a SQL primary key). QOS can allow for tweaking for the reliability and persistence of the data exchange.

In regards to reliability, data can be exchanged without delivery control and in a reliable way, ensuring important data delivery. In regards to persistency, this feature may be optional. As any other communication framework, data can be lost as soon as its publisher is down, but DDS can keep it in memory the time the workstation is up, which can ensure reception any other software subscribing to the data. The data can even be hardware reboot persistent. It may not use a central DB in order to avoid weak point creation in the communication system.

Built-in data persistency can allow any workstation lately connecting an existing DDS domain to receive change notifications of topics it's subscribing as long as a single workstation stays up on the network (data can be shared and stored among all domain participants). Another kind of persistency is the history management. A topic can include histories and previous values of an instance (same ID). Moreover, developers can subscribe (filter) data to receive using wildcards (generic characters replacing any other character or suit of character).

One function of this service is to publish information concerning urban space activity in a standard format. The information can be made available for the attention of the users or agents working directly/indirectly for the city. It aims at supplying pre-formatted information to application editors and companies needing information without requiring a specific software interface.

In more detail, the service can manage information distribution channels (DIC) using topics available on DDS bus, extra information related to the topic (defined in Asset Management Service as Address, Zone, etc.), and formatting rules based on selected publication channels (RSS, SMS . . . ) to route the information to the publisher.

It may be desirable to utilize more than one distribution channel. Towards this end, in one embodiment, four main distribution channels can be utilized: 1) a data syndication using feed (RSS, GeoRSS), 2) VoiceXML, 3) Instant messaging including SMS, Email, live messenger, Facebook, Twitter and 4) a mobile notification service provided by mobile manufacturers via mobile applications platforms.

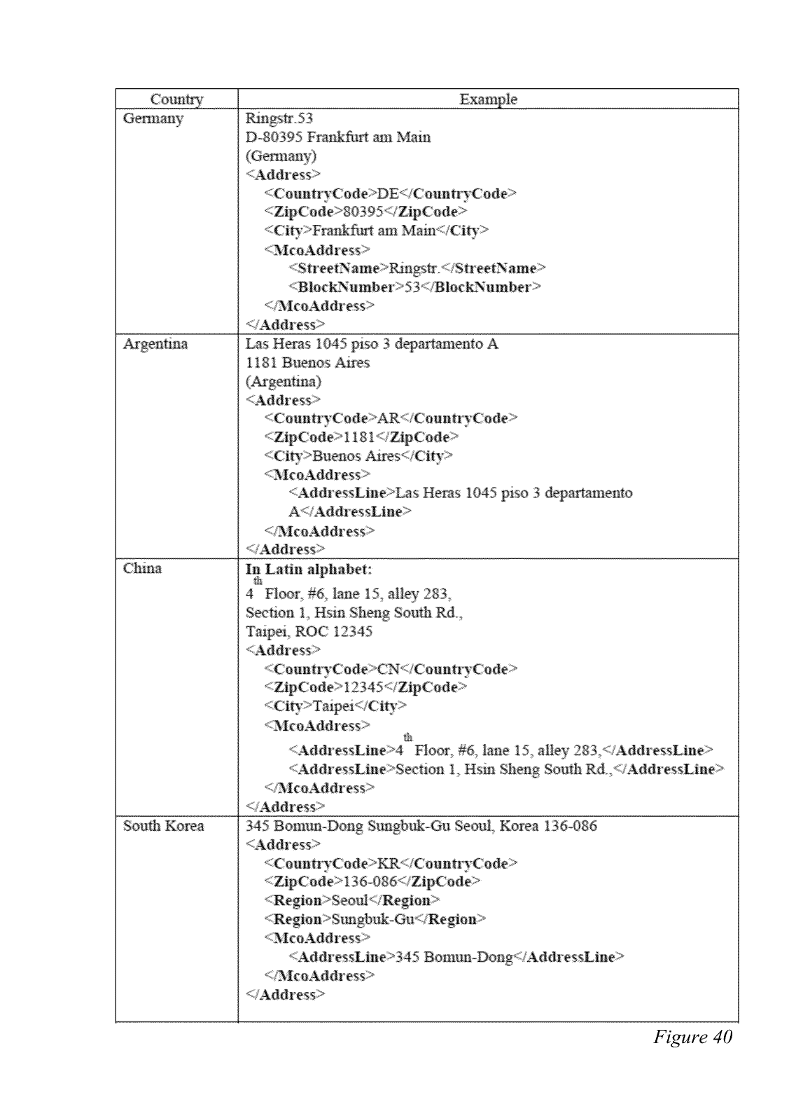

FIG. 41 is a block diagram of publication service architecture 550. The data formatting layer 554 can be in charge of i) merging data from topics, ii) geographic information related to the topic (Address, Zone), iii) text and iv) format depending the channel into a specific output format file. In one embodiment, XML, feed data, instance messaging and mobile data formatting can be provided. The XML data formatting can be for RSS, GeoRSS and VoiceXML. The instant messaging formatting can include Email, SMS, Live Messenger, etc.

The publisher layer 560 can route data by type to different distribution channels 560. For example, the distribution channels can include data syndication using Feed (RSS, GeoRSS), VoiceXML, instant messaging including SMS, Email, live messenger, Facebook, Twitter and a mobile notification service provide by mobile manufacturer via a mobile application platform. VoiceXML is the W3C's standard XML format for specifying interactive voice dialogues between a human and a computer. Just as HTML documents are interpreted by a visual web browser, VoiceXML documents are interpreted by a voice browser. A common architecture is to deploy banks of voice browsers attached to the Public Switched Telephone Network (PSTN) to allow users to interact with voice applications over the telephone.

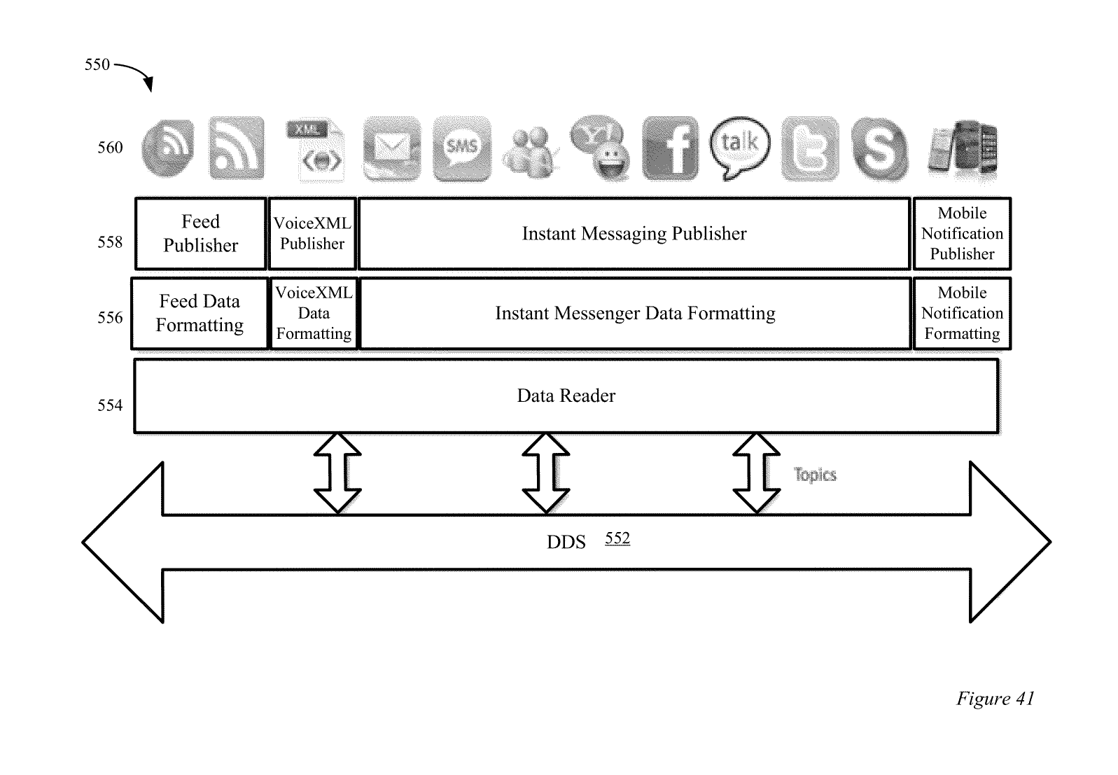

FIG. 42 is a block diagram illustrating a flow of a publication service process 570. As described above, the publication service may be organized in different layers, such as a common data reader subscribing to topics published on DDS 552. The publication service can create a Distribution Information Channel (DIC) Object service that processes topics coming from the bus 552 through the data reader layer 554. It can add extra data, and format it according to a targeted format for a specific channel in layer 556 and then route it through publication services (data publication layer 558).

In step one, DIC object service can creates a DIC Object, such as 572 or 574. The DIC object can have one Queue by type of topics used. In step two, the service can subscribe to all types of the topics used by the different DIC Objects. For example, DIC object 572, uses topic “A” and DCI object 574 uses topics “A” and “E.” Each time the data reader layer 554 receives a notification from a topic, it can enrich the data with external information (address, zone . . . ) and put it on the queues of the DIC Objects subscribing to this specific topic. For example, DIC objects 572 and 574 subscribe to topic “A.” In step three, the DIC objects, such as 572 and 574, can apply formatting by calling the data formatting layer 556.

In step four, the DIC objects can send formatted information to the data publisher layer 558 in accordance with specified types of channels within channels 560. For example, one specified channel for DIC object 572 is SMS while one specified channel for DIC object 574 is email. The number and specified channels can vary from DIC object to DIC object. Further, the system can provide tools for modifying the number and type of channel, such as a adding or removing a channel. Further, the system can provide tools for adding or removing a DIC object.

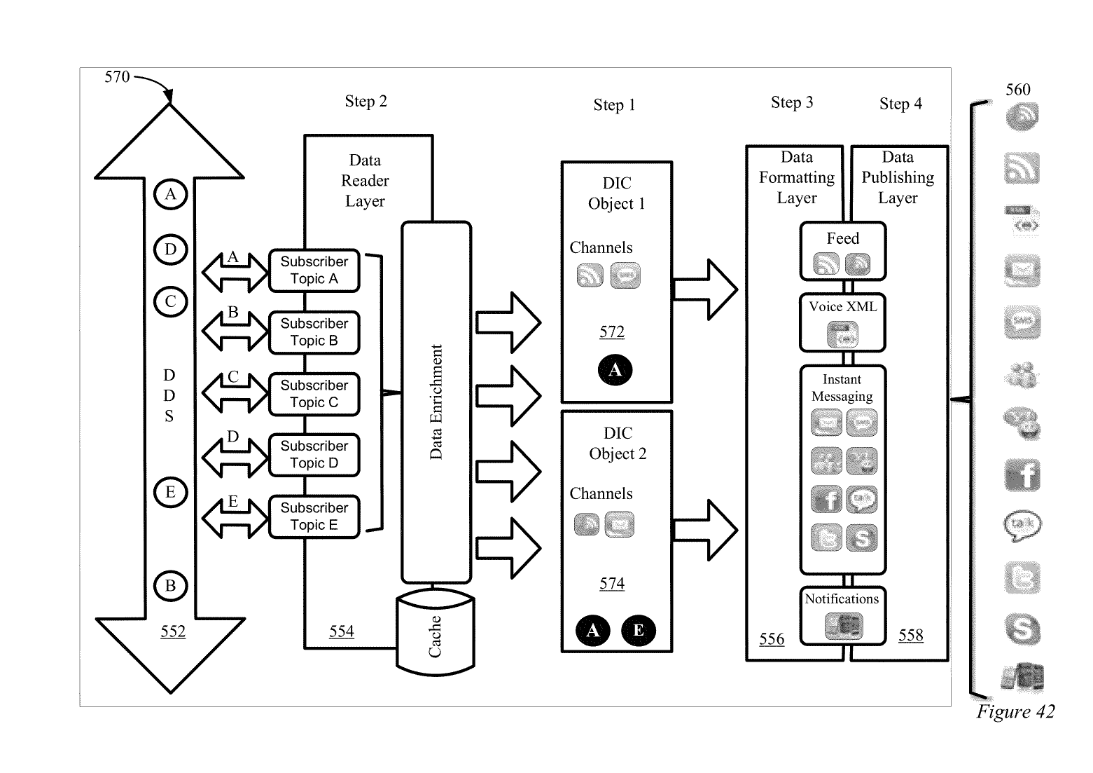

Next, one embodiment of a DIC object definition is described. FIG. 43 shows a data information channel configuration including a specification for topics associated with the channel. As described above, each Information Distribution Channel (DIC) can have one or many topics and one or many publication channels. The publication services can use a DDS Topic Registry Discovery Service to get the list of topics available on the DDS Domain. This service can provide for each topic the Name, Structure, QoS parameters, etc.

Next, a method associated with the data reader layer and the DIC configurations is described. As described above, the data reader layer 554 can be in charge of subscribing topics available on DDS bus coming from sensors and sub-systems and enrich it with external data. First, the data reader layer can scan all the DIC configurations, such as 572 and 574, to determine the list of topics required in order to guarantee an optimization of traffic. Second, it can subscribe on DDS 552 to the list of topics previously defined. It can maintain the list of DIC objects associated with each related topic. Third, when a topic is received by the data reader, it can enrich the topic with different information (address, zone . . . ) and store it on a cache memory. Fourth, this information can put in the queue of each of the different DICs to be managed by the formatting layer.

Next, some details associated with data formatting are described. Depending on the type of distribution channel, the data formatting may vary. Thus, data formatting layer can be split in different sub components including but not limited to a) feed formatting managing RSS, GeoRSS, b) VoiceXML, c) instant messaging and mobile notification.

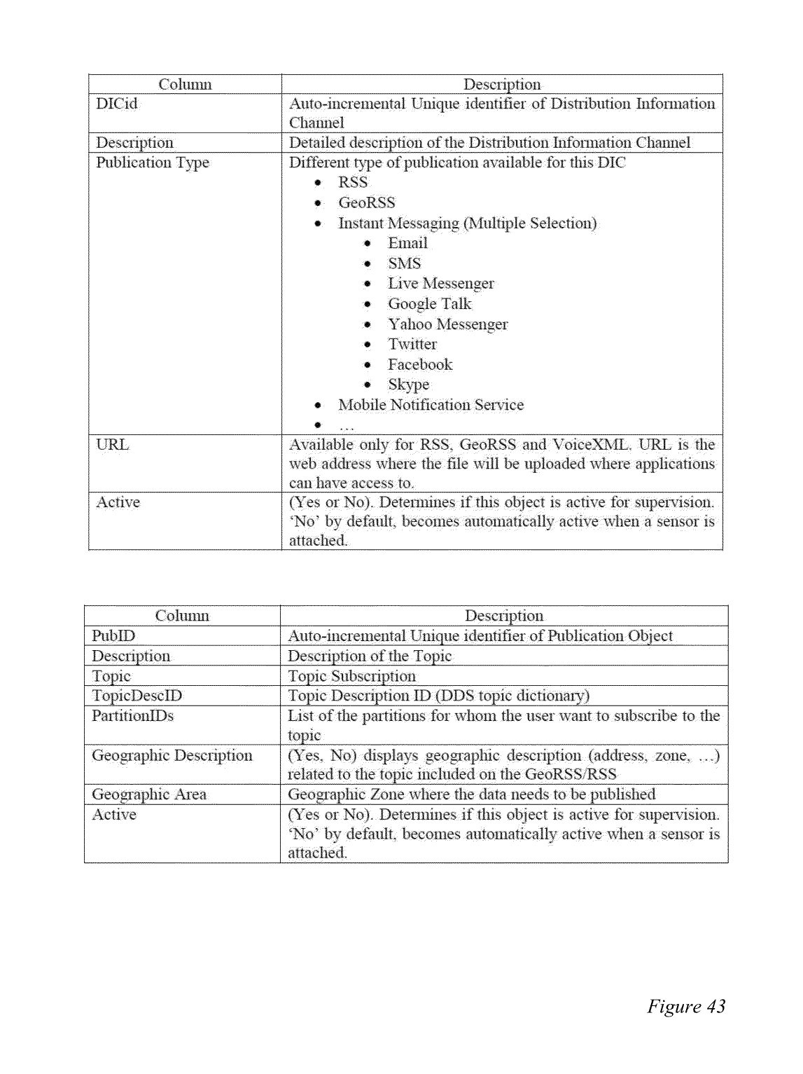

FIG. 44 shows a RSS, GEORSS configuration. RSS and GeoRSS can require the same kind of configuration except GeoRSS can manage Geo-localized information in order to be displayed on a Map (e.g., Google Maps). For both, channel element is used to define data type that is to be displayed, parking spot available, traffic, accident, etc. Information regarding these events can be reported from sensors deployed in the field using DDS or from other services which interpret the sensor data to generate events (e.g., see 115 in FIG. 3).

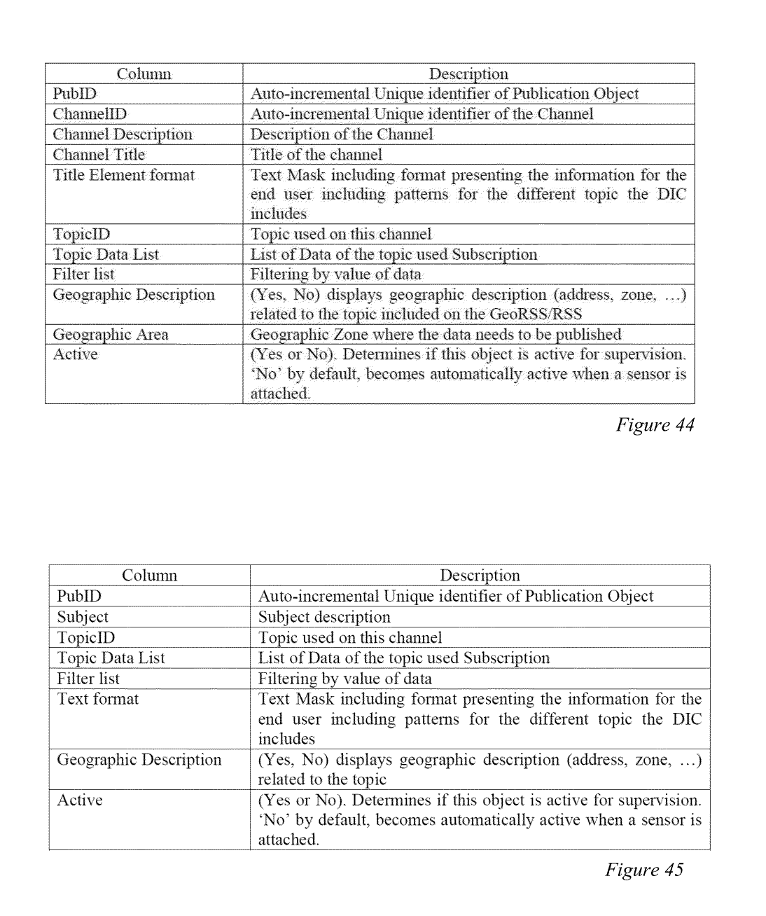

Next, a configuration for Email, SMS and instant messaging is described. The configuration for Email, SMS and Instant messaging channel involves pushing information to users. The configuration can require the same parameters. In one embodiment, the configuration can be split in two parts: 1) information published by the system and 2) mailing list of the users subscribing to the information. FIG. 45 shows an Email, SMS and instant messaging associated with publishing the information.

Since the information is pushed to the users, it may be necessary to manage a mailing list where users/agents working directly/indirectly for the city can subscribe to the published information. This subscription could be done in different ways, such as but not limited to an Internet web site and a mobile application. An example of how a user might subscribe to information generated by the system is described as follows.

The user can select the information to receive from the system from a list box which can be a list of information configured previously. Next, the user can select which type notifications to receive, such as Email, SMS, live messenger, etc.). Then, the user can select from among different geographic to receive notifications, such as parking in particular area. As described above, the system can attach geographic data to the data in the incoming topics. Thus, the data can be filtered in this manner.

In addition, the user can select a period of time to be notified (e.g., Permanently, From date to date). After the parameters are input, the user can applies for the notification and the system can reply with a confirmation message for each channel selected.

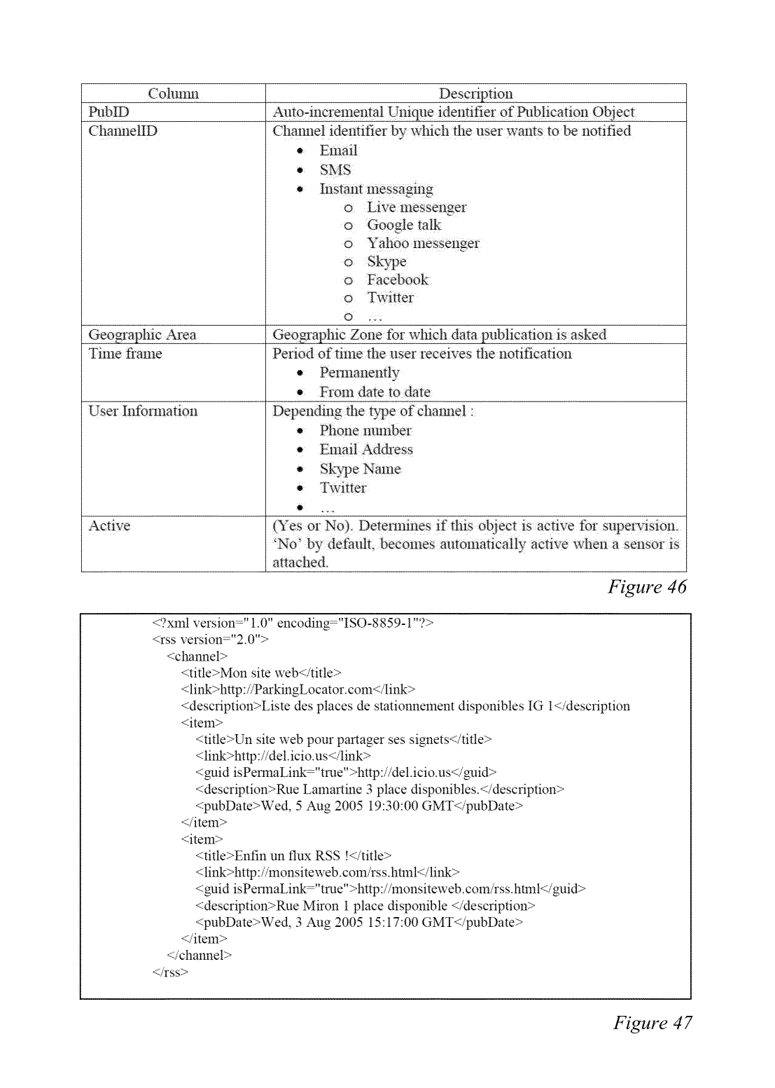

Via this example, a user can receive information pertaining to a group of sensors, kiosks, etc. For a first type of user, the information can be used for obtaining a service, associated with the sensor network, such as a parking space or bike sharing. For a second type of user, such as a municipal agent, the information can be used to maintaining the system, such as performing maintenance on sensors or kiosks determined to need attention. FIG. 46 shows a configuration associated with a user's subscription to different topics.

Next, RSS associated information publishing is described. RSS (originally RDF Site Summary, often dubbed Really Simple Syndication) is a family of web feed formats used to publish frequently updated works—such as blog entries, news headlines, audio, and video—in a standardized format. An RSS document (which is called a “feed”, “web feed”, or “channel”) includes full or summarized text, plus metadata such as publishing dates and authorship.

RSS feeds benefit publishers by letting them syndicate content automatically. A standardized XML file format allows the information to be published once and viewed by many different programs (i.e. RSS specification 2.0 http://cyber.law.harvard.edu/rss/rss/html). It benefits readers who want to subscribe to timely updates from favored websites or to aggregate feeds from many sites into one place.

An RSS service can allow an object to generate RSS feed from data flows resulting from the DDS bus. To execute, the RSS service can subscribes to a type of event (topic), generate a RSS file every time a new event is received and deploy it for use by the application.

RSS feeds can be read using software called an “RSS reader”, “feed reader”, or “aggregator”, which can be web-based, desktop-based, or mobile-device-based. The user can subscribe to a feed by entering into the reader the feed's URI or by clicking a feed icon in a web browser that initiates the subscription process. The RSS reader checks the user's subscribed feeds regularly for new work, downloads any updates that it finds, and provides a user interface to monitor and read the feeds. RSS can allows user to avoid manual inspection of all websites they are interested in, and instead subscribe to websites such that all new content is pushed onto their browsers when it becomes available.

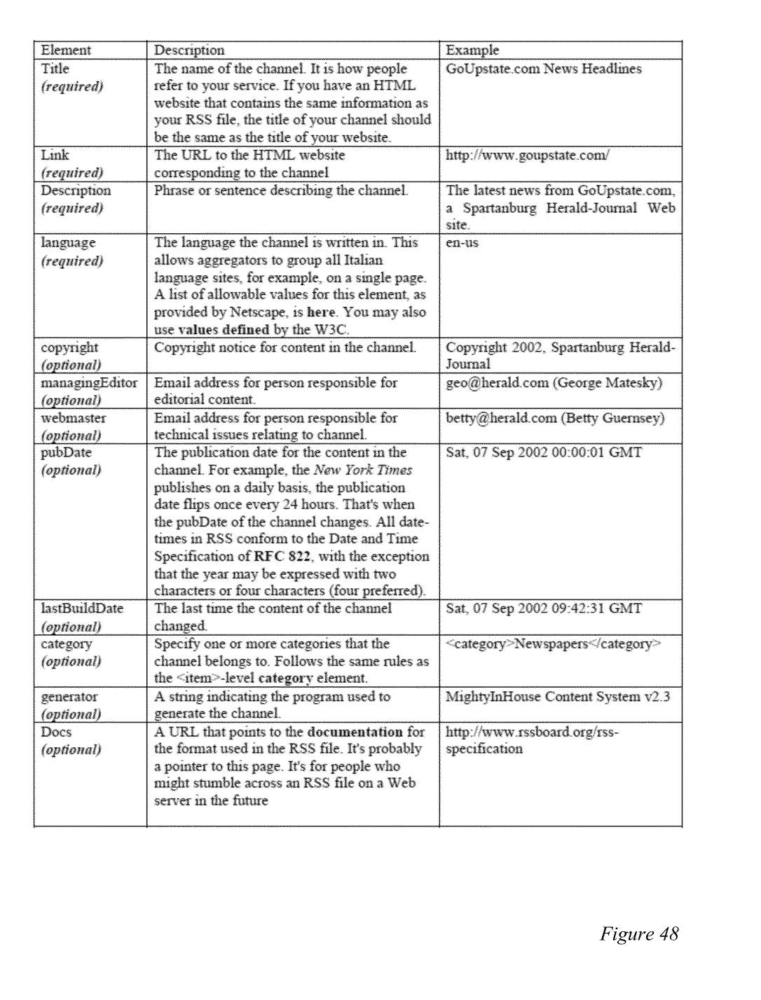

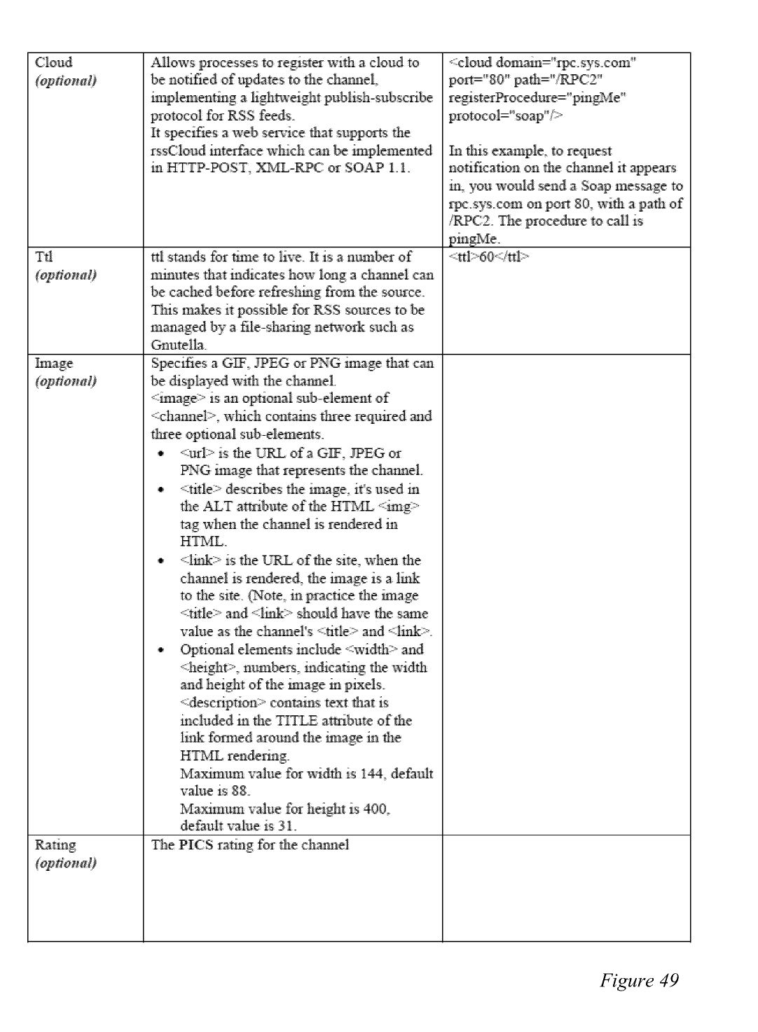

As RSS files can be essentially XML formatted plain text, the RSS file itself can be relatively easily read both by automated processes and by humans alike. Subordinate to the <rss> element can be a single <channel> element, which contains information about the channel (metadata) and its contents. FIG. 47 shows one embodiment of an example RSS file. The file could be placed on any appropriate communication protocol for file retrieval, such as http or ftp, and reading software would use the information to present a neat display to the end user. FIGS. 48-50 show a list and description of channel elements.

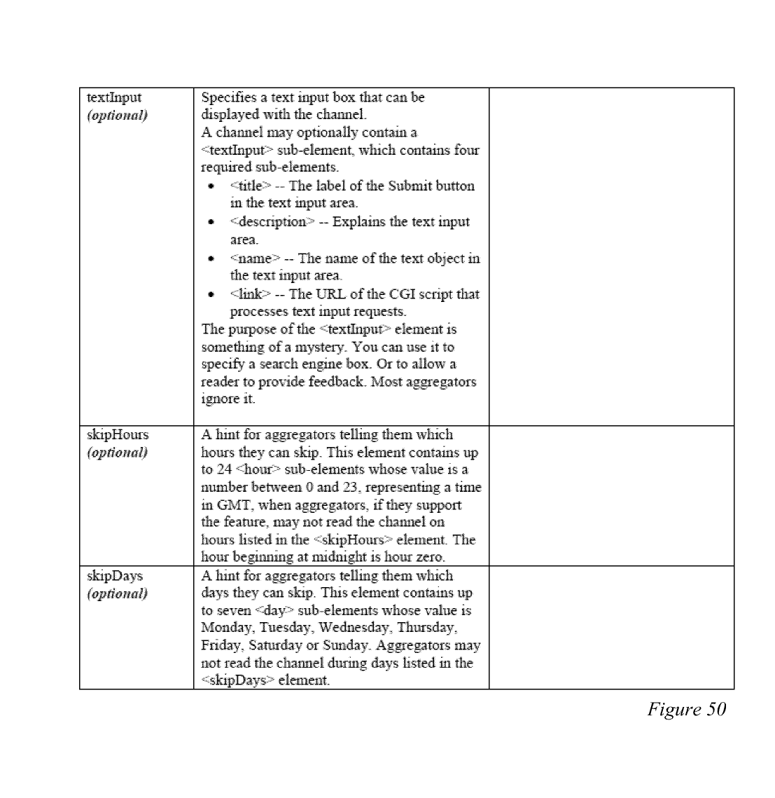

FIG. 51 shows items which can be in a channel. A channel may contain any number of <item>s. An item may represent a “story”—much like a story in a newspaper or magazine. If so, its description can be a synopsis of the story, and the link points to the full story. An item may also be complete in itself. If so, the description can contain the text (entity-encoded HTML can allowed), and the link and title may be omitted. All elements of an item can be optional. However, at least one title or description may need to be present. It can be important to indicate which encoding is used in the file text. Under Windows, the most common encoding used is the 150-8859-1. It may then necessary to indicate it in the file (see encoding=in the <?xml>tag).

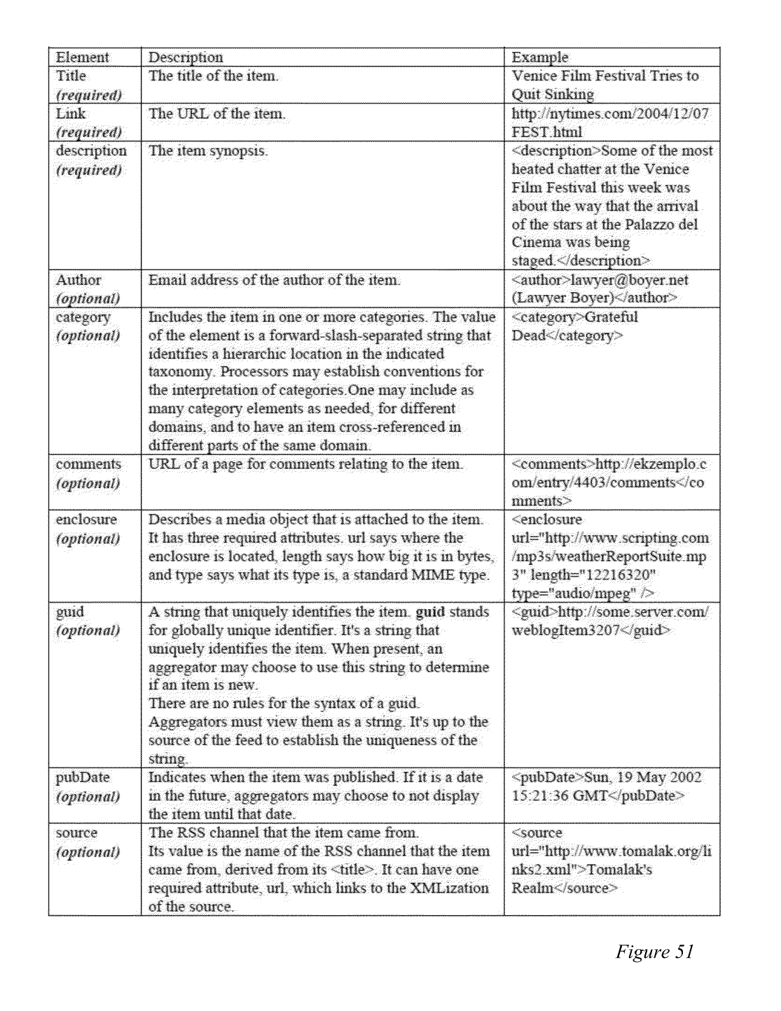

To publish an RSS feed on a web-site, the deployment process can involve saving the document XML in a text file with the extension.xml. The file can be downloaded to a web-site, such as via FTP. Then, the URL of the file can be distributed. FIG. 52 is an example of an XML file where a new item 580 is added to an RSS feed.

Next, GeoRSS is described. Similar to the RSS service, the GeoRSS service allows insuring the syndication of the geo-localized information. For example, the GeoRSS service can get back events associated with the availability of parking spots from the sensors via the DDS bus and generate GeoRSS files for web applications and mobile device applications.

GeoRSS is way to share and build maps. GeoRSS is supported by Google Maps, Microsoft Virtual Maps, Yahoo! maps, worldKit and many others. Map annotations can be specified in the RSS XML format. RSS is a widely supported format for syndication of news and weblogs, and is extendable to publish any sort of itemized data. Publishing geographic annotations in RSS has several advantages: there are a large number of tools available to write RSS, and other services, can make use of the geographic metadata. Most important for the basics, RSS is a simple format and easy to edit by hand.

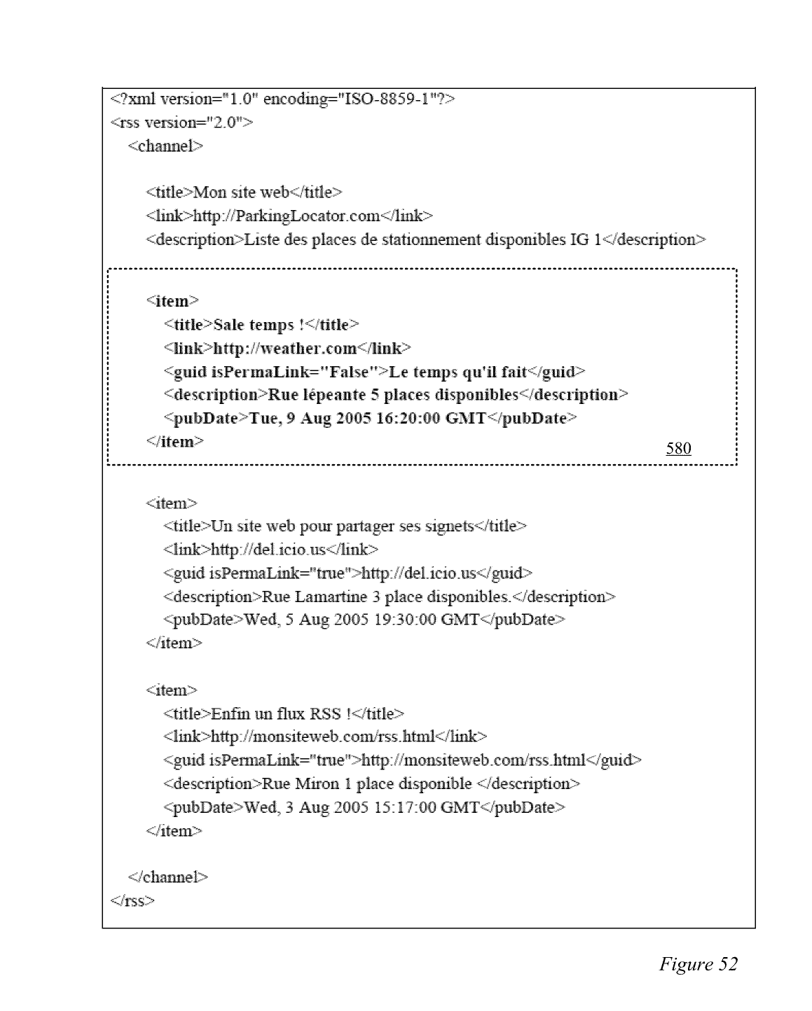

Within the <channel>, there are multiple <item>'s each specifying an annotation. The <title> and <description> are displayed in the annotation's textbox, and the <link> is loaded on mouse clicks. The point can be plotted at the latitude/longitude specified by <georss:point>. There are currently two encodings of GeoRSS, a) simple and b) GML. GeoRSS-Simple is a lightweight format that developers and users can quickly and easily add to their existing feeds. It can support basic geometries (point, line, box, and polygon) and covers some of the typical use cases when encoding locations. FIG. 53 shows an item of an XML file in GeoRSS-Simple which can be used for marking a location on a map in a GeoRSS feed.

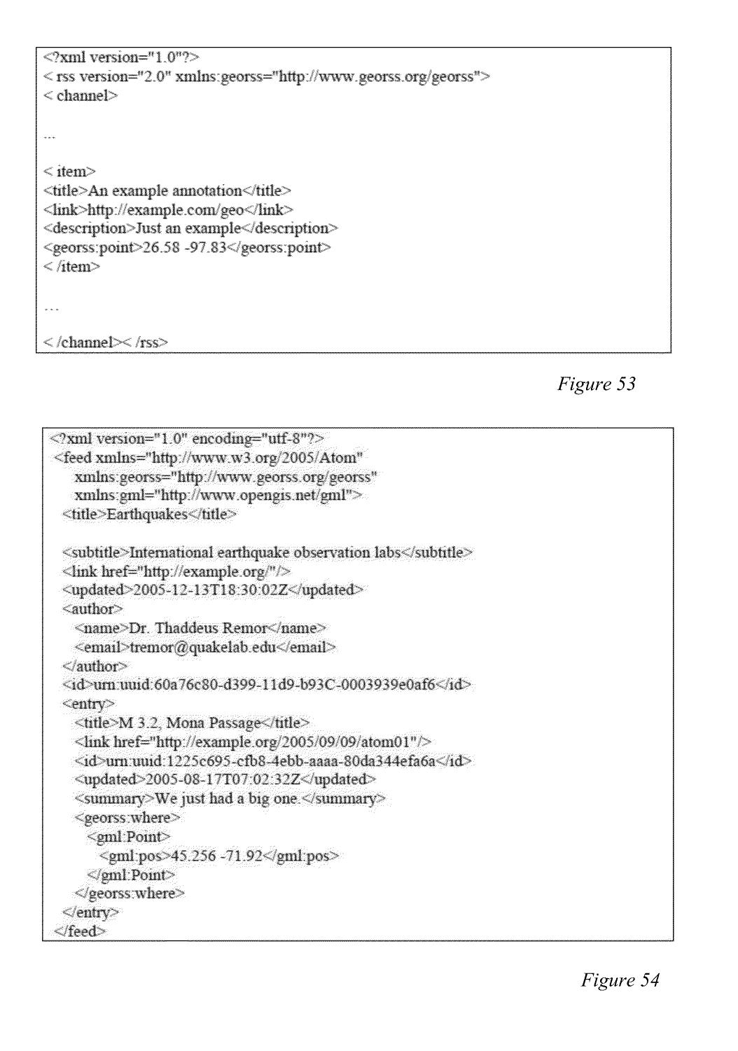

FIG. 54 shows an item of an XML file in a second protocol for marking a location on a map in a GeoRSS feed in accordance with the described embodiments. GeoRSS GML is a formal GML application profile, and supports a greater range of features, notably coordinate reference systems other than WGS-84 latitude/longitude. Both formats are designed for use with Atom 1.0, RSS 2.0 and RSS 1.0, although it can be used just as easily in non-RSS XML encodings.

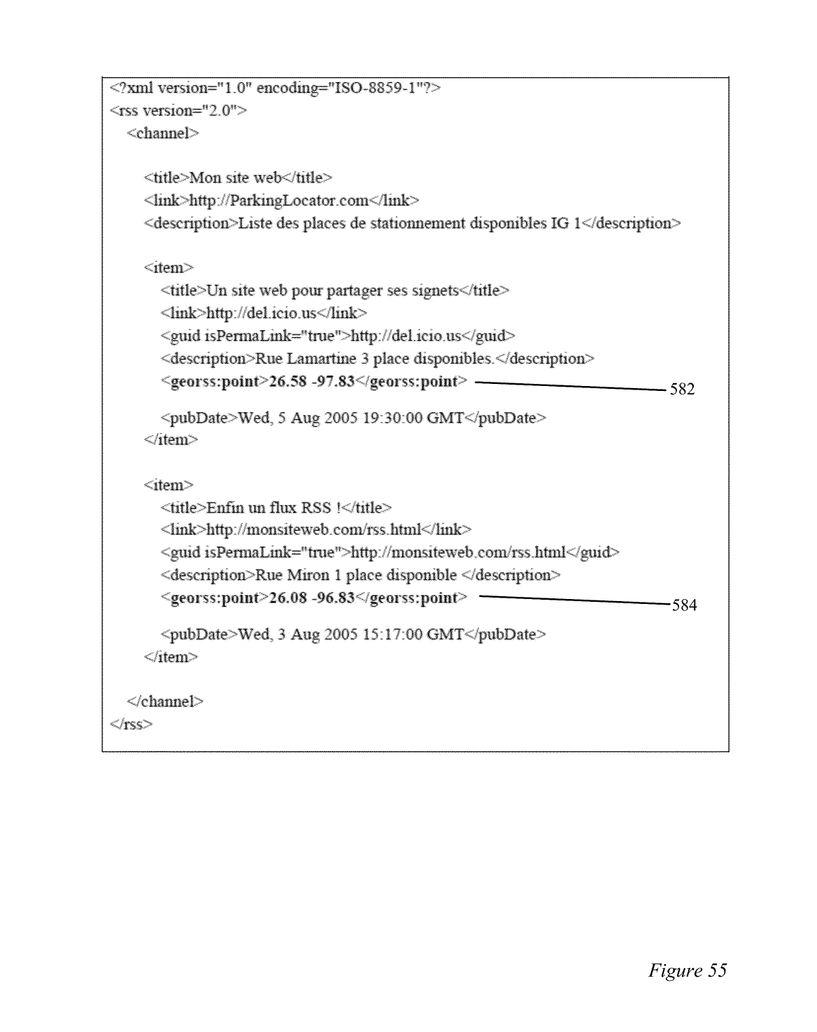

In one embodiment, GeoRSS-simple can be used. FIG. 55 shows an example of two detailed items in an XML file in GeoRSS-Simple which can be used for marking a location on a map in a GeoRSS feed. Elements 582 and 584 show where map coordinates are specified in the file.

GeoRSS implementation can be similar as for RSS, except that the reading is not made by a RSS reader but through Google API Maps or equivalent (Yahoo! maps, Microsoft maps, etc.). The Google Maps API supports the KML and GeoRSS data formats for displaying geographic information. These data formats can be added to a map using the GGeoXml object, whose constructor takes the URL of a publicly accessible XML file. GGeoXml placemarks can be rendered as GMarkers, while GGeoXml polylines and polygons can be rendered as Google Maps API polylines and polygons. <GroundOverlay> elements within KML files can be rendered as GGroundOverlay elements on the map.

Keyhole Markup Language (KML) is an XML notation for expressing geographic annotation and visualization within Internet-based, two-dimensional maps and three-dimensional Earth browsers. KML was developed for use with Google Earth, which was originally named Keyhole Earth Viewer. It was created by Keyhole, Inc., which was acquired by Google in 2004. KML became an international standard of the Open Geospatial Consortium in 2008.

GGeoXml objects can be added to a map using the addOverlay( ) method. (You can remove them from the map using removeOverlay( ). ) Both KML and GeoRSS XML files are supported. Note that GGeoXml is a modularized object within the Google Maps API and is not fully loaded until it is first used. As a result, it only calls its constructor after the page has fully loaded. This is usually accomplished by calling the GGeoXml constructor within the <body>'s onload handler.

As described above with respect to the mobile application, markers on a map can be used in many different ways. For example, markers can be used to identify parking spots, bus stops or taxi stations. Further, a marker can be used to identify a current location of a user.

Next, a VoiceXML service is described. VoiceXML is a programming language designed to create interactive vocal services. Standardized at the world level by the W3C (i.e. http://www.w3.org/TR/2007//REC-voicexml21-20070619/), the language uses principles and Web technologies, such as Internet network, XML, Web server, application server, etc.).

VoiceXML can be used to manage the human-machine vocal interactions. The various features offered by the language can provide one or more of a) outputting to a caller of audio content (e.g., files .wav), b) outputting to a caller a text translated by speech synthesis, c) recognition of the keys of the phone keyboard (DTMF), d) responding to voice commands using speech recognition, e) recording audio messages (voice mailboxes), f) sending the information input by the caller to a distant applications (http requests), g) enriching the vocal dialogue with information received from distant applications (http requests), h) transferring calls, i) sending vocal messages, SMS, faxes and e-mails and j) combinations thereof.

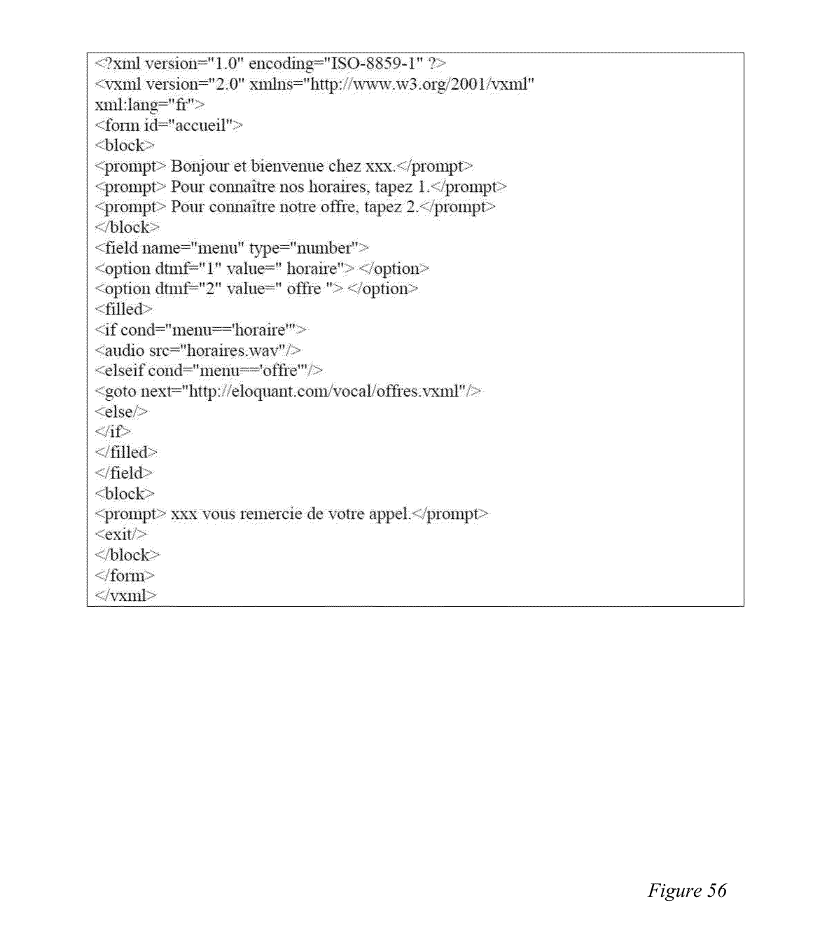

FIG. 56 shows an example of a Voice XML page. The code on the page describes a vocal service where the caller can choose between listening to an audio message which gives opening hours and another Voice XML page which describes the offer. At the end of call, the caller is thanked and the service hangs up.

In one embodiment, the deployment of a vocal service in VoiceXML can utilize Web architecture. A vocal service can be provided by VoiceXML pages hosted on a Web server. The pages describe the various stages of the interactive vocal service (rendering audio messages, texts rendering using speech synthesis, calls transfers, voice recognition . . . ).

The initial connection between the service and the caller can be realized through a VoiceXML bridge. The bridge can be connected to the telephone network and allows making a phone number correspond with the homepage of the service. The pages are then interpreted by the bridge which manages the interactions between the caller via his handset and the source code of the service. This bridge can be named VoiceXML browser, by analogy with html browsers used to interpret web pages.

As an example, the company Eloquant (www.eloquant.com) provides an infrastructure allowing running vocal services within VoiceXML environments.

For each of these environments, Eloquant supplies: a) a phone number allowing the callers to get in touch with the VoiceXML code of the service, b) an instance of its VoiceXML browser and c) a secured extranet for the administration of the account and the consultation of the calls statistics. The browser can be compatible with the VoiceXML standard 2.1 and it may integrate speech synthesis and voice recognition technologies.

To implement the vocal service, the customer of Eloquant develops his VoiceXML pages of which he accommodates on his Web server (APACHE, IIS). These pages are developed by means of the standard Web technologies (PHP, ASP) and become integrated into any type of architecture (J2EE.NET). The customer configures his environment via the secure extranet so that it points towards his pages. The service is then at once operational and reachable by callers in the phone number attached to its environment.

### Universal Event Monitor (UEM)

The Universal Event Monitor (UEM) is a monitoring tool capable of notifying users of events published in the DDS user domain. The tool uses DDS capabilities in order to offer a generic mechanism that facilitates the integration of news events (topics) without code change to the various applications used in the system. This can be configured to notify users from events published in DDS Domain and to notify users of the events via email or SMS.

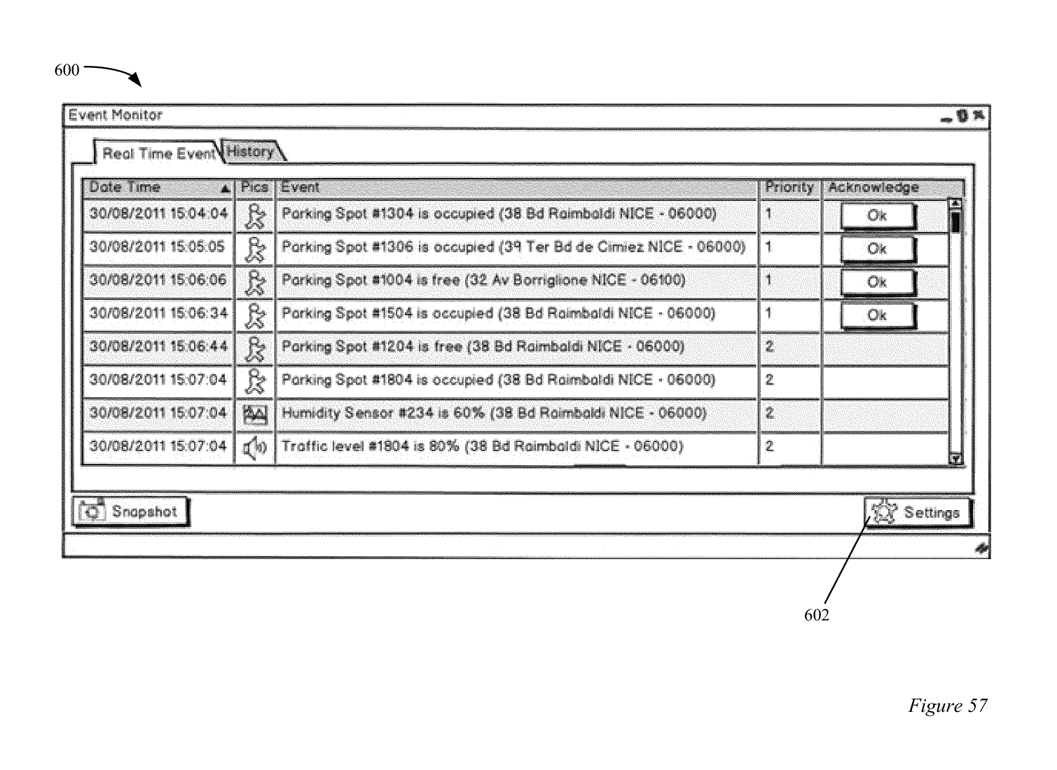

FIG. 57 shows a main screen 600 of a universal event monitor (UEM). In one embodiment, the UEM main screen 600 can give access to two tabs, real time event and history displaying real time/history events published on DDS domain. The application can be launched by subscribing to the list of events (topics) to receive according to the configuration defined on “UEM settings”. A selection of the setting button 602 allows access to the setting menu.

The list of message can fill out automatically according to instances received from the DDS domain (message bus) and partition. According to defined triggers, the color and the associated actions can be applied. In one embodiment, the list of messages can display per date/hour in descending order. Thus, the last message received can be displayed on the top of the data grid. However in the case of messages requiring acknowledgement, these message may remain at the top of the list until it is validated.

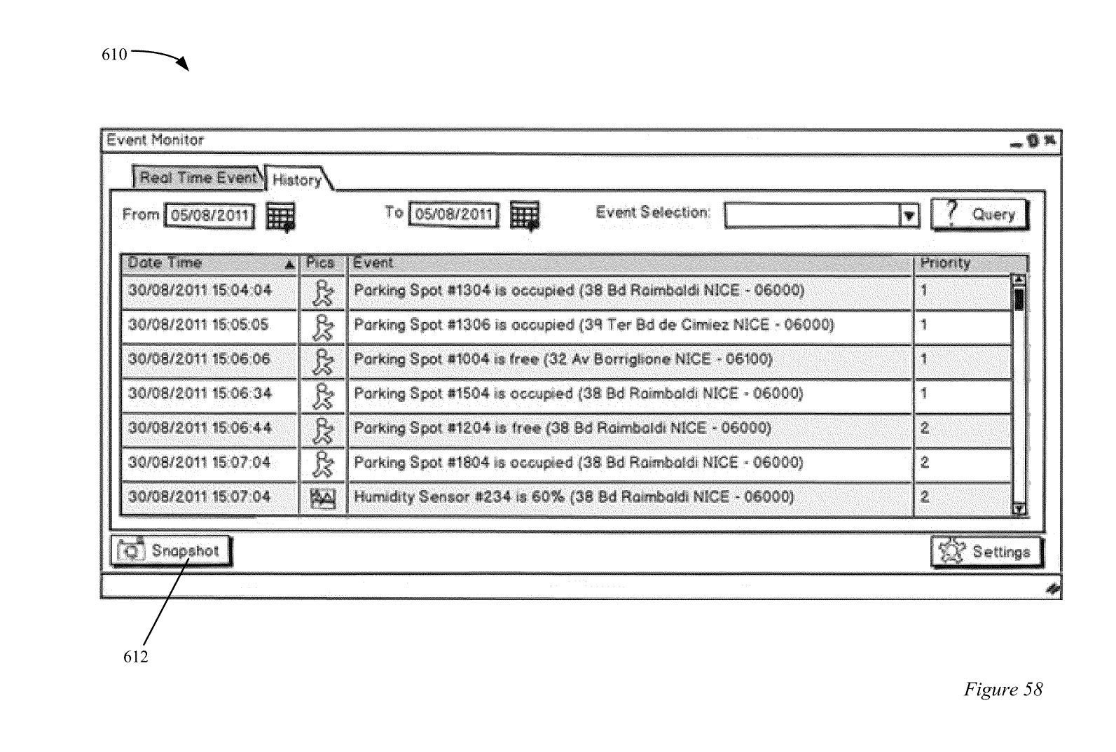

FIG. 58 shows a history tab screen 610 of a universal event monitor. The system can be configured to display the history of messages for information research purposes. A number of filters are available in order to facilitate the research, such as but not limited to: a) start date, end date which can be a date & time period for filtering events and/or b) event selection where only selected topics displayed.

The snapshot button 612 can be selected to create a snapshot of the current real time event or history tab data grid depending on which one is selected. When the user clicks on button, a new tab can be created with the following text on its caption: <<Snap shot-Date Time>> in order to distinguish it. A user can create multiple snapshots as desired. A user can export the snapshot in different formats (e.g., MS Excel, PDF, XML, CSV Text File, and Text File). To do it, a user can select the type of export and then clicks on an export button.

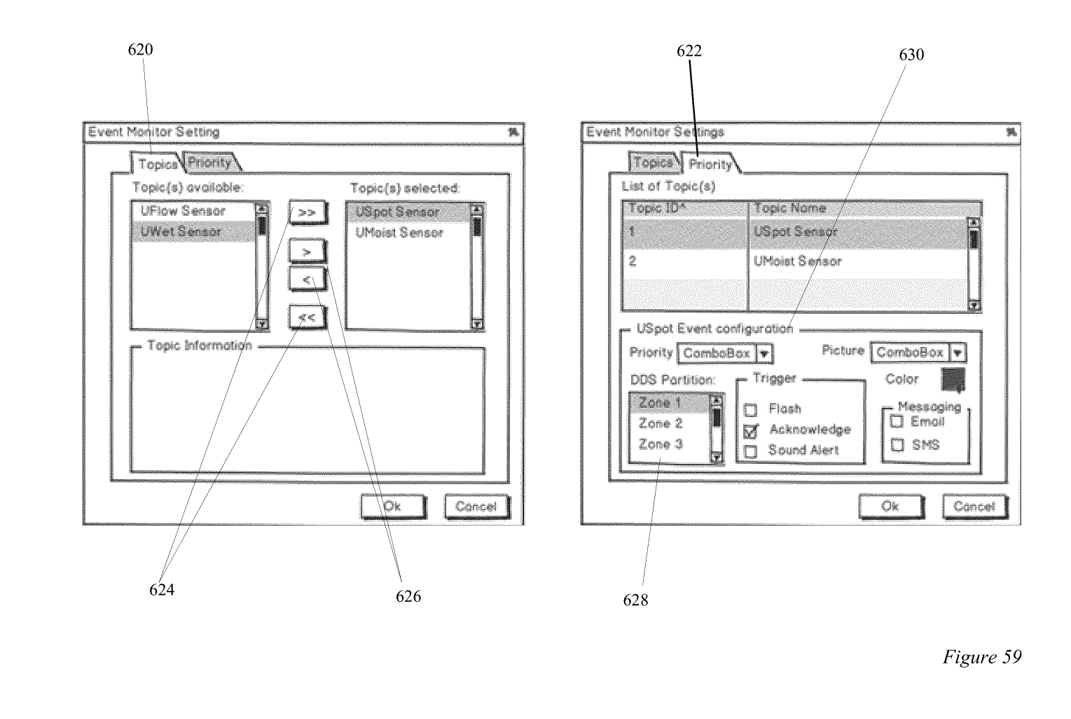

FIG. 59 shows setting screens 620 and 622 for a universal event monitor. Event Monitor settings allow each user to configure a specific list of topics to monitor as well as to configure desired alert notification(s) per event (topic). In one embodiment, two different tabs described below are available. The tab “Topics” 620 allows a user to select the topics the users want to monitor. Topic(s) displays the available the lists of topics filtered by user group (see, DDS Topic Registry & Discovery specifications below). Different topics can be made available to different groups, such as municipal agents which maintain the system as opposes to users which use the system to purchase services.

Topic 620 displays the selected list of one or more topics selected by each user. Buttons 624 allows to select and un-select all topics. Buttons 626 allow a user to select/un-select one particular topic.

The tab “Priority” 622 allows configuring notification alerts by topic. The list of topics displays the topic(s) selected by the user. The configuration group box 630 allows the way alert notifications are made to be configured. The “Priority” combo box defines the level of priority of the event. This information is displayed on the events data grid as shown in FIG. 58. The “Picture” combo box allows selecting a small icon to be displayed on the event data grid.

The DDS partition 628 allows selecting from which partition the user wants notification. Partitions in DDS are related to topics and allow for defining the reach of distribution of the topic. In the example, the partitions are associated with zones. The zones can correspond to geographic regions within a city. A user might select to receive events associated with all the parking sensors (USpot) in zone 1 or all the moisture sensors (Umoist) in zone 2.

“Color” allows a selection of a specific color for the font. A number of triggers can be defined. Some examples of triggers which may be available are flash, acknowledge and sound alert. A selection of “Flash” can cause event in the real time event viewer to flash or flicker. A selection of “Acknowledge” can cause events to remain displayed at the top of the scrolling list of the data grid in real time viewer until acknowledged (see FIG. 57). A selection of “Sound Alert” causes a generation of sound alert(s) in the real time event viewer when this event occurs. In one embodiment, only one of these options can be selected. In another embodiment, multiple options can be selected.

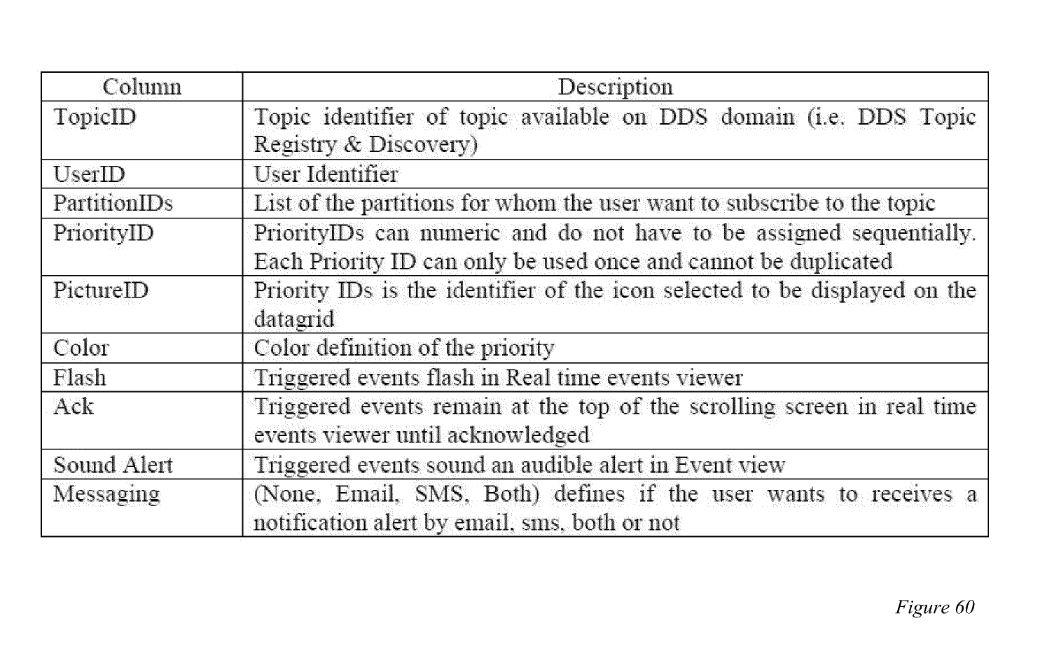

A selection of “Messaging” allows users to be notified for this event by email or SMS. Other communication mechanisms are possible and these are provided for the purposes of illustration only. For example, a user can be notified via a GeoRSS feed which shows the event on a map as a marker. A selected configuration can be made by user, saved and automatically loaded when the users logon into the application the next time. An example for storing configuration setting is shown in FIG. 60.

As described above, a user can configure the “UEM Settings” to be notified by Email or SMS. This feature is configured on the UEM but this mechanism can be made to be independent from the application currently running since it needs to be active all the time in order to send Email and SMS. In one embodiment, the mechanism can be embedded on publication services. In publication services, as described above, a job can be created in order to create DIC Objects. The DIC objects can include a list of topics need to be subscribed (including list of partition) and a mailing list of users requesting an Email and/or a SMS associated with the list of topics.

### DDS Topic Registry & Discovery Management Service

The objective of DDS Topic Registry & Discovery Management service can be to inventory all topics available by discovering all new topics defined on the DDS domain. This service can be configured to a) inventory of all the available topics, b) create a dictionary of DDS Topic, c) publish this dictionary for all applications using the DDS to subscribe process and archive the dictionary and d) archive all events/topics instances published on DDS and stored it a historical database. The historical database can be subsequently mined.

The Data Distribution Service for Real-Time Systems (DDS) is an Object Management Group (OMG) Publish/Subscribe (P/S) standard that aims to enable scalable, real-time, dependable, high performance and interoperable data exchanges between publishers and subscribers. DDS is designed to address the needs of mission- and business-critical applications like financial trading, air traffic control, smart grid management, and other big data applications.

DDS can be used to provide networking middleware that simplifies complex network programming. It implements a publish/subscribe model for sending and receiving data, events, and commands among the nodes (e.g., sensors). Nodes that are producing information (publishers) create “topics” (e.g., temperature, location, and pressure) and publish “samples.” DDS takes care of delivering the sample to all subscribers that declare an interest in that topic.

DDS can handle the transfer chores, such as message addressing, data marshaling and remarshaling (so subscribers can be on different platforms than the publisher), delivery, flow control, retries, etc. Any node can be a publisher, subscriber, or both simultaneously. The DDS publish-subscribe model can eliminate complex network programming for distributed applications.

DDS supports mechanisms that go beyond the basic publish-subscribe model. The key benefit is that applications that use DDS for their communications are entirely decoupled. Very little design time has to be spent on how to handle their mutual interactions. In particular, the applications never need information about the other participating applications, including their existence or locations. DDS can be configured to automatically handle many aspects of message delivery, without requiring any intervention from the user applications, including 1) determining who should receive the messages, 2) where recipients are located, 3) what happens if messages cannot be delivered.

These features are made possible by the fact that DDS allows the user to specify Quality of Service (QoS) parameters as a way to configure automatic-discovery mechanisms and specify the behavior used when sending and receiving messages. The mechanisms can be configured up-front and require no further effort on the user's part. By exchanging messages in a completely anonymous manner, DDS greatly simplifies distributed application design and encourages modular, well-structured programs.

DDS can also automatically handle hot-swapping redundant publishers if the primary fails. Subscribers always get the sample with the highest priority whose data is still valid (that is, whose publisher-specified validity period has not expired). It automatically switches back to the primary when it recovers, too.

A few DDS parameters are described as follows. DomainParticipantFactory can be a singleton factory that is the main entry point to DDS. DomainParticipant can be an entry point for the communication in a specific domain. It can represent the participation of an application in one DDS Domain. Furthermore, it can acts as a factory for the creation of DDS Publishers, Subscribers, Topics, MultiTopics and ContentFilteredTopics. TopicDescription can an abstract base class for Topic, ContentFilteredTopic and MultiTopic. In DDS, a database row is called a Topic Instance, while the stream of update to a specific Topic Instance is called Topic Sample.

Topic can be a specialization of TopicDescription that is the most basic description of the data to be published and subscribed. ContentFilteredTopic can be a specialized TopicDescription like the Topic that additionally allows content-based subscriptions. MultiTopic: A specialization of TopicDescription like the Topic that additionally allows subscriptions to combine/filter/rearrange data coming from several topics.

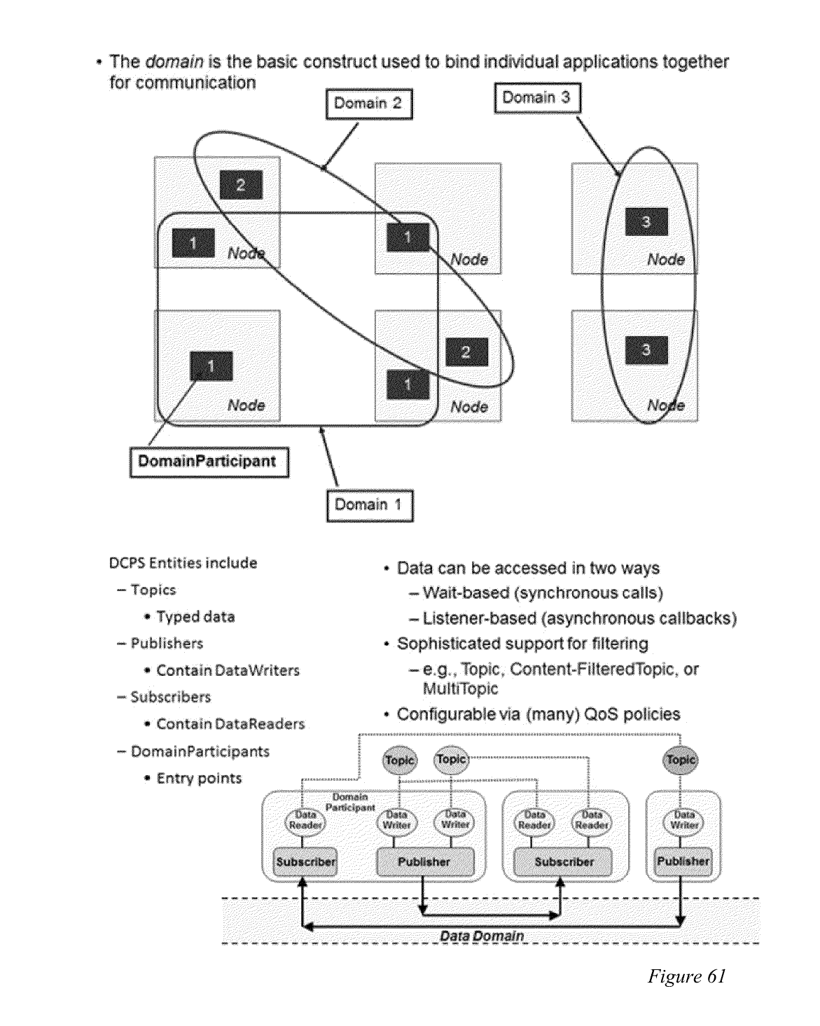

A publisher can be the object responsible for the actual dissemination of publications, such as the publication service. A Data Writer can allow the application to set the value of the data to be published under a given Topic. A subscriber can be the object responsible for the actual reception of the data resulting from its subscriptions. A Data Reader can allow the application to declare the data it wishes to receive (by making a subscription using a Topic, ContentFilteredTopic or MultiTopic) and to access the data received by the attached subscriber (e.g., see the Universal Event Monitor). FIG. 61 shows relationships associated with DDS domains and relationships between topics, publishers, subscribers, data readers and data writers.

As described above, DDS may allow a number of QoS policies to be defined. A few examples of these policies, which can be used in the system described herein, are discussed as follows. In real-time delivery, “deadline” can require the publisher to always send at least one value within the period. Using a RELIABLE setting may result in resends of data. A RELIABLE setting can potentially block while trying to send. The max blocking time can important to minimize the time that the send can maintain as block.

A LIFESPAN setting can specify an expiration time for the samples to ensure that the receiving application will not receive any values that are too old. RESOURCE_LIMITS can be associated with too few available samples and delays will occur acquiring samples to send. PRESENTATION can be set to not allow grouping and re-ordering of values that can delay delivery to the application. A TIME_BASED_FILTER can be set to provide a higher minimum separation which will result in less samples being sent.

In regards, to bandwidth, none of the QoS policies may be for directly controlling bandwidth. Several have some effect on bandwidth. For LIVELINESS, a low liveliness lease_duration can result in extra liveliness messages for publishers that are not publishing values frequently. Thus, lower lease_duration raises bandwidth. For DEADLINE, setting a lower deadline can result in more traffic (i.e., lower deadline raises bandwidth). For RELIABILITY, using a RELIABLE setting may result in resends of data. (RELIABLE possibly raises bandwidth).

Setting to EXCLUSIVE allows multiple publishers to be publishing for the same instance but only one may be recognized as the owner (authoritative source). A failure/death of the current owner allows the subscribers to continue receiving values from the new owner. OWNERSHIP_STRENGTH can establish the order of ownership when OWNERSHIP is set to EXCLUSIVE. For LIVELINESS, the lease_duration is important for determining that an entity has died. A lower value means that a death will be detected sooner.

For DESTINATION_ORDER, BY RECEPTION_TIMESTAMP can result in two subscribers having data in different orders. BY_SOURCE_TIMESTAMP forces all subscribers to have the data in the same order. For HISTORY, the policy sets a buffer between the changing values and the delivery to the subscriptions. Set to KEEP_LAST and a small depth, could potentially cause blocking depending on other QoS policies.

PERSISTENCE can be related to a persistence of data that has been published. DURABILITY can control how the data will be stored. Values of TRANSIENT and PERSISTENT can result in data outliving the Data Writer. DURABILITY_SERVICE

This policy configures how much data is stored after it is published. The RESOURCE_LIMITS policy can define how much data is stored in OpenDDS.

HISTORY can control the storing of values before they are delivered. RESOURCE_LIMITS can specify the available number of samples that can be handled. WRITER_DATA_LIFECYCLE can specify whether samples will be automatically disposed. READER_DATA_LIFECYCLE can specify whether samples will be automatically removed.

### DDS Topic Registry and Discovery Setting

This service a setting to notify system administrator of new topic discoveries. Every time a new topic is discovered (an instance of the topics is received by the service), the service checks if it exists in the TopicDictionnary topic and inserts it if this is not the case. In one embodiment, the dictionary topic can provide the following information: a) topic description, b) topic name, c) link to an assembly containing mandatory classes to access the topic, d) QoS configuration of the topic, e) message format to display the topic using string format including text and variable defined on the structure, f) (Yes, No) determine if instance of this topic are store on an event database and g) (Yes, No) determine if this topic definition is available from the dictionary.

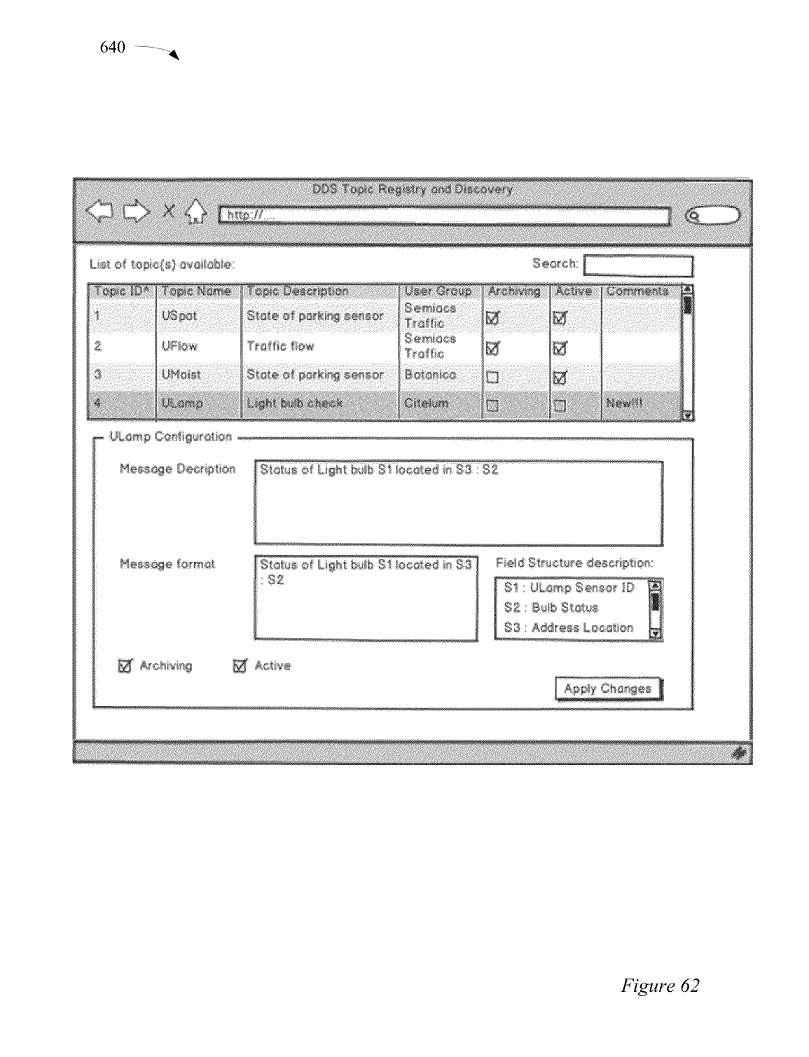

When the service inserts the topic, it can notify system administrator by email or some other method of the discovery of new topic(s) and can populates the following information: Topic Name, Topic assembly, Topic QoS, Archiving=No and Active=No. Via a user interface, the system administrator can acknowledge the new topic by filling out a Topic Description, Message Format and Archiving option and activate it to make it available for application using DDS Topic dictionary. FIG. 62 shows a screen 640 which can be used to register new tops in the system.

The TM_TRS_GetTopicsList method can be available on this service to get the list of all topics available for a specified group of users. If the user is unregistered in the system, it may not return anything. It can use a WebServices URL, such as http://xxxxxx. In one embodiment, three parameters can be passed to the method: user_uid (string), pwd (string, encrypted on SHA1) and user_group(int). The return format can be in XML. The result set can be included within the tags <rows></rows>. The tag <validation></validation> can be set to “ok” if the user validation is successful. The tag <sql_numrows></sql_numrows> can returns the number of rows of the query. From there, it can return each row between the tags <row id=[row id]></row>. Each field in the row has the corresponding tag. This function may return all the row of the DDS Topic dictionary table filtered by the selected group of user.

### Topics Database Archiving Service

Topics Database Archiving service can be used to archive all topics instances published on DDS Domain configured to be archived. This service can create a data subscriber of all topics having the parameter “archiving” settled to true. This service can be deployed on a server in order to keep it running continuously.

Each time Data Reader receives a new instance of a topic, the following data can be stored in the archiving database: an EventID which is auto-incremental unique identifier of the topic instance published on the DDS domain, a Date/Time of the publication of the topic instance, a topic description, a topic name, a message which is a message string of the topic instance as described in the MessageFormat parameter, a topic data structure which is the data structure of the stored topic in XML, a message format which is the message format to display the topic using string format including text and variable defined on the structure.

Embodiments of the present invention further relate to computer readable media that include executable program instructions. The media and program instructions may be those specially designed and constructed for the purposes of the present invention, or any kind well known and available to those having skill in the computer software arts. When executed by a processor, these program instructions are suitable to implement any of the methods and techniques, and components thereof, described above. Examples of computer-readable media include, but are not limited to, magnetic media such as hard disks, semiconductor memory, optical media such as CD-ROM disks; magneto-optical media such as optical disks; and hardware devices that are specially configured to store program instructions, such as read-only memory devices (ROM), flash memory devices, EEPROMs, EPROMs, etc. and random access memory (RAM). Examples of program instructions include both machine code, such as produced by a compiler, and files containing higher-level code that may be executed by the computer using an interpreter.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. It will be apparent to one of ordinary skill in the art that many modifications and variations are possible in view of the above teachings.

While the embodiments have been described in terms of several particular embodiments, there are alterations, permutations, and equivalents, which fall within the scope of these general concepts. It should also be noted that there are many alternative ways of implementing the methods and apparatuses of the present embodiments. It is therefore intended that the following appended claims be interpreted as including all such alterations, permutations, and equivalents as fall within the true spirit and scope of the described embodiments.

What is claimed is:

1. A system comprising:
a plurality of sensor nodes, each including one or more sensors and a first communication interface used to output sensor data from the one or more sensors, wherein a portion of the plurality sensor nodes are parking sensor nodes configured to generate the sensor data used to detect a presence of a vehicle at a parking spot;
a plurality of outdoor kiosks each kiosk including a weather-proofed housing, display, one or more payment devices, a second communication interface configured to receive the sensor data from a portion of the plurality of sensor nodes, a third communication interface configured to communicate with a management platform and a CPU board, disposed within the weather-proofed housing and coupled to the display, the one or more payment devices, the second communication interface, the third communication interface, said CPU board configured to control operation of the each kiosk, wherein each kiosk is configured to:
publish the sensor data from each sensor node in the portion of plurality of sensor nodes as a topic on a data distributed service (DDS) message bus generated by the management platform; and
generate a plurality of services including a parking service which enables a user to purchase parking; and
the management platform configured to:
generate the city DDS message bus;
discover new topics available for subscription on the city DDS message bus including the topics associated with the sensor data from each of the plurality of sensor nodes;
generate a dictionary of topics available for subscription including updating the dictionary with the new topics which are discovered;
receive subscriptions to each of the topics in the dictionary of topics; and
route topic instances associated with each topic in the dictionary of topics to subscribers of the each topic.

2. The system of claim 1, wherein a unique topic is generated for each of the plurality of sensor nodes.

3. The system of claim 1, wherein the management platform is further configured to instantiate a new topic each time a new sensor node is installed wherein the new topic is used to publish the sensor data from the new sensor node.

4. The system of claim 1, wherein the management platform is further configured to receive an indication that a first sensor node from among the plurality of sensor nodes is uninstalled and in response, remove the topic associated with the first sensor node from the dictionary of topics.

5. The system of claim 1, wherein the management platform is further configured to generate a user interface which allows a user to select a particular topic from among the dictionary of topics and to subscribe or to unsubscribe to the particular topic.

6. The system of claim 1, wherein geographic data is associated with topic instances from a particular topic.

7. The system of claim 6, wherein the management platform is configured to filter topic instances according to whether the topics instances occurred in a particular geographic area using the geographic data.

8. The system of claim 7, wherein the management platform is configured to receive a request to subscribe to a particular topic including a specification of the particular geographic area, instantiate a new subscription and only route topic instances occurring within the particular geographic area to a subscriber associated with the new subscription.

9. The system of claim 1, wherein the management platform is configured to manage a plurality of information distribution channels selected from the group consisting of VoiceXML, e-mail, instant messaging, text messaging, RSS and GeoRSS.

10. The system of claim 9, wherein the management platform is configured to receive a selection of one or more of the plurality of information distribution channels associated with a particular topic, receive topic instances associated with the particular topic, format data contained in the received topics instances in accordance with the selected one or more plurality of information distribution channels and deliver the formatted topic instances to a particular subscriber which selected the one or more of the plurality of information distribution channels.

11. The system of claim 9, wherein the management platform is configured to format topic instances of each of the topics in the dictionary topics in accordance with format requirements associated with each of the plurality of information distribution channels.

12. The system of claim 1, further comprising a sensor data interpretation module wherein the sensor data interpretation module is configured to receive a first topic instance including raw sensor data from the first topic associated with a first sensor node, based upon the raw sensor data, determine an event has occurred and publish the event as a second topic instance associated with the first topic to the city DDS message bus.

13. The system of claim 12, wherein the sensor data interpretation module is further configured to determine calibration settings of the first sensor node.

14. The system of claim 1, wherein a first kiosk is further configured to receive the sensor data from a charge station sensor node associated with an electric charge station used by electric vehicles.

15. The system of claim 14, wherein a first kiosk is further configured to use to the sensor data associated with the charge station sensor node to generate an electric charge service which allows a user to purchase charge time at the electric charge station.

16. The system of claim 1, wherein a first kiosk is further configured to receive the sensor data from a bike sharing sensor node associated with a bike sharing station.

17. The system of claim 16, wherein the first kiosk is further configured to use the sensor data associated with the bike sharing sensor node to generate a bike sharing service which allows a user to obtain access to a bike from the bike sharing station.

18. The system of claim 1, wherein the first kiosk is further configured to receive the sensor data from a moisture sensor node wherein the moisture sensor node is configured to measure moisture levels used to determine a watering schedule associated with a green area.

19. The system of claim 1, wherein a first kiosk is further configured to receive the sensor data from a waste level sensor coupled to a waste receptacle wherein the waste level sensor is used manage emptying of the waste receptacle.

20. The system of claim 1, wherein a first kiosk is further configured to receive the sensor data from a lighting sensor node coupled to a street light wherein the lighting sensor node is used to determine maintenance needs and lighting levels for the street light.

21. The system of claim 1, wherein the first kiosk is further configured to receive the sensor data from a traffic sensor node wherein the traffic sensor node is used to alert users of traffic conditions.
